(19) United States
(12) Patent Application Publication
(10) Pub. No.: US 2005/0138867 A1
(43) Pub. Date: Jun. 30, 2005

(54) Multifunctional tridimensional combined green building

(76) Inventor: Bing Zhao, Daliushu Beicum (CN)

Correspondence Address: BANNER & WITCOFF, 1001 G STREET N W, SUITE 1100, WASHINGTON, DC, 20001, US

(21) Appl. No.: 10/500,357

(22) PCT Filed: Dec. 31, 2002
(86) PCT No.: PCT/CN02/00948

(30) Foreign Application Priority Data
Dec. 31, 2001 (CN) 01145340.0

(51) Int. Cl. E04H 1/00

(52) U.S. Cl. 52/79.1

(57) ABSTRACT

The present invention is related to a tridimensional combined green building which is constituted with plant, biologic ecosystem, physical environment ecosystem, habitation environment and the combination thereof. Said tridimensional combined green-building may comprises green villages, green areas and green scientific town, such as tridimensional wall, tridimensional river and tridimensional bridge etc., and they can be divided into variety of green building.

### TECHNICAL FIELD

The present invention relates to a multifunctional tridimensional combined ecological architecture that combines habitants, plants, organisms and other natural environments inside or outside the combined ecological buildings, which may be closed, opened, opened and closed, combined, and other architectural forms. The ecological architecture may expand spaces upward and downward, including solar power generation systems, wind power generation systems, water power generation systems, mechanical power generation systems, water purifying and storage systems, oxygen suppliers, air conditioning systems, ultraviolet sanitation systems, water flow systems for cultivation of organisms, and other modern multifunctional tridimensional combined ecological architectures.

### BACKGROUND OF THE INVENTION

Currently, there exist many different forms of buildings that basically pursue the integration of buildings and arts for beauty, with the common deficiency of single residential function for habitants. These buildings can't keep up with the fast development of science, techniques and buildings, and even more can't meet habitants' new requirements for buildings and the requirements for continuous development. Ecological architectures have already been researched with methods that more sun light can be transmitted to the inside of the buildings, and that green building materials without pollution are used. Those methods used only relate to the aspects of ecological architectures, while ignoring the aspect of continuous and sustainable development. What people really need are new types of ecological architectures and ecological environments that can sustain continuous development. Since ecological environments have been severely damaged by people for their living and development, with the result of many natural disasters that threaten the living of people, as well as less and less lands are available for people, the balance of shared ecological environments have been collapsed, it will be the main problem to be solved for dependent living and continuous development.

### DISCLOSURE OF THE INVENTION

In general, People have been threatened by droughts, floods, earthquakes, air pollutions, lack of foods, pandemics and wars. Even more, natural ecological environments have been polluted by people, with the result that many plants and organisms have been extinguished, lands available for people becomes fewer and fewer, people will have to suffer from the lack of resources, and have to transfer from the wrong type of lives to scientific ones. Thus, the objects of this invention is to create a new type of environments for people's continuous development, which comprise multifunctional tridimensional combined ecological architectures and various series of functional buildings with cooperating devices and cooperating equipments, and these environments may be not only in the form of multifunctional tridimensional combined ecological architectures, but also in the form of more or less scientific results. Several types of systems are included, such as energy-saving systems that save energy, water and electric power, oxygen chambers and oxygen transmitting systems, air transmitting and recycling systems, purifying systems for air and water, rains and snows collecting, water storing, purifying and supplying systems, clear water supply systems, back water purifying systems for used water, methane storing systems, cultivation systems for aquatics, cultivation and irrigating systems for plants, illumination systems, artificial intelligent automatic control systems, movable ecological spaces and device orbit systems, ecological systems for habitants and plants, ecological space buildings structures, tridimensional forms of ecological buildings, sunlight refractive and transmitting systems, new functional type constructing materials and equipments supplying systems, heating/cooling air devices (passages) systems for filtering water, water transmitting, storing, supplying systems, combined ecological buildings network systems, organisms systems for sightseeing, organisms production, processing and storage systems, mechanical frame transmitting systems for cultivation of organisms. Those cooperating devices and equipment systems generally combine with the ecological buildings to form large-scale or luxury ecological buildings for habitants' continuous development, or to form middle or small scale ecological buildings with fewer configurations or separate configuration. Multifunctional tridimensional combined ecological architectures may be in different forms, including tridimensional ecological buildings mainly for habitants and secondly for ecological organisms environments, such as offices, residential houses, business buildings, factories, stations, stadiums and other public utilities, tridimensional ecological buildings mainly for ecological organisms environments and secondly for habitants, tridimensional ecological buildings for habitants and ecological organisms environments together, tridimensional ecological buildings for sightseeing, tridimensional ecological buildings for cultivation of plants, tridimensional ecological buildings for cultivation of animals, tridimensional ecological buildings for cultivation of plants and organisms together, multifunctional tridimensional combined ecological architectures for habitants, for cultivation of plants and organisms, and for natural ecological environments, multifunctional tridimensional ecological architectures, mechanical frame type ecological buildings for cultivation of organisms, ecological buildings that can be opened and closed.

The multifunctional tridimensional combined ecological architectures comprise several tridimensional ecological buildings, which combine tridimensional ecological environments and structures together, which can be provided inside the buildings, outside the buildings, complement, opened and closed, mechanically transmitted, overlapped, consistent to Yixue, underground, aboveground and semi-underground. They can be super-high, middle, or low tridimensional ecological buildings or single-storey buildings, and they can also be awnings for cultivations, movable long corridors, tridimensional lands, ecological bridges, tridimensional ecological walls, tridimensional combined frames, tridimensional ecological rivers, ecological residential houses in rural areas, ecological villas, ecological factories, public utilities, ecological researches and other forms. Most of all, they can partly form tridimensional ecological villages and tridimensional ecological towns for habitants.

The power generation and energy-saving systems generates electric power from solar power, wind power, mechanical power, waters power and other resources. The oxygen chambers and oxygen generating and transmitting systems comprise oxygen chambers for organisms, oxygen generating equipments, oxygen transmitting devices, sanitation devices, etc. The air adjusting and transmitting recycling systems are the devices that purify, sanitize, heat and cool the air, and that entirely or partly transmit clean air to the inside of buildings, residential houses, public areas, and that recycle polluted air back to the systems to purify (or discharge the polluted air away). The air water sanitation and purifying systems are the purifying and sanitation systems that are located inside pipes, passages, buildings where air pass through water passages, which may be provided inside the air and water passages, and which may be provided entirely or partly. The rains and snows collecting, water storing, purifying and supplying systems comprise rains and snows collecting and purifying ditches, grounds, building rains transmitting passages (pipes), water reservoirs (underground, semi-underground, or aboveground water reservoirs, lakes, rivers, etc), water supply devices (water pumps, passages, pipes). Rains storing systems may also be added with polluted water purifying and recycling systems, such as filtering, organisms purifying and other water purifying devices. The devices may effectively differentiate the various types of polluted water, such as life water and the water for cultivation of plants, and purify and store water for use. With various types of water resources, as well as clean water supplying systems, polluted water purifying systems, feces storing and purifying systems, methane gases storing systems, it will effectively solve the problems of lack of water resources and part of energy. The cultivation devices systems for aquatics comprise building structures, water reservoirs, water passages, ecological spaces for cultivation of aquatics productions, rivers, lakes, segmented rivers and sub branches for cultivation of aquatics productions, water purifying devices, ecological purifying systems for cultivation of polluted water, insolation pools, sanitation devices that are connected with one another and recycled. The rivers may be exposed rivers, hidden rivers, awning type rivers, building structures, drops, waterfalls, water flows and mechanics, automatic water flow devices, forming the water systems that purify and flow continuously with good results. The cultivation systems for aquatics may be tridimensional ecological rivers, may be integrated with other ecological buildings, forming ecological water systems networks, the functions, numbers, and scales of which may be large, middle, small, and which can be independently used in the rivers, or combined with building structures. The cultivation and irrigation systems for plants are inside or outside of the ecological building structures, which may be connected with water reservoirs and other water supply systems, and which may use water pumps, drops, spraying and other methods to supply water, and which may be irrigation systems comprising water pipes, and which may be partly or entirely used. The artificial intelligent automatic control systems are the systems that supervise the functions of illumination systems, organisms cultivation systems, temperature regulating systems, habitants environments, image transmitting systems, fire prevention and fighting systems and antitheft systems that are inside or outside of the building structures, which may be controlled manually or automatically. The movable ecological spaces and device orbit systems are the ecological spaces (awning frame structures) that can be conveniently disengaged, or the ecological space structures that are mounted with movable wheels at the bottoms, making them the ecological space structures that are movable on the grounds or the orbits. Big tracks, tracks on the top, in the middle and at the bottom, water flows and transmitting devices may be mounted inside or outside of the passage type ecological spaces that can be used for organism frame structures to transmit and to move. The ecological systems for habitants, plants and organisms comprise the environments for habitants, for plants, for organisms and for ecological environments, which are the abbreviations of habitants in the natural environments. The systems establish small tridimensional ecological buildings. The ecological space building structure systems divide the ecological spaces (organisms spaces) into inside building structures, outside building structures, opened and closed structures, complement structures, tridimensional garden structures, modified building structures. The ecological structures inside and outside the building structures are the ecological structure environments (plants, natural hills and waters) that are provided inside and outside the buildings. These structures may be embodied in the different space structures of the building forms, and may be combined with tridimensional garden structures. The inside and outside opened and closed structures are added to the ecological space (awnings) structures, which may be roof type opened and closed structures, inclined type opened and closed structures, side surface opened and closed structures, with more or less occupied areas, and which may be entirely or partly opened and closed, with large areas opened and closed on roofs, sides or walls and which may be combined with movable doors and windows. The method for opening and closing may be pivot folded, wheel sliding, axle folded, parallel sliding on flat surfaces, inclined surfaces, or side surfaces, movable bottom wheels of ecological spaces, and other forms. They can be opened and closed manually, automatically controlled, or the combinations. The automatic controllers are the rotating device structures, such as electric mechanical wheels and linear systems, which may be provided partly or globally with intelligent control devices. The opened and closed ecological space structures may be opened and closed with single layers, double layers, or combined with other networks, frame structures. One of the usages is to provide the horizontal or vertical frame structures of the buildings on the top or roof of the buildings, and to combine with opened and closed ecological space structures. The opened and closed ecological space structures can afford habitants with both warm houses and natural environments to meet the different requirements, thus adding more functions to the ecological buildings. The opened and closed ecological spaces may also be combined with opened ecological environment structures. The ecological building structures systems are space structures, building materials and functions of the ecological buildings, comprising special building structures, steel concrete building structures, large steel frame structures, light awning structures, combined and disengaged structures, combined houses, steel concrete awning frame structures, various types of large, middle, small regular or irregular glasses and mounting frame awning type structures, as well as various types of new materials and new functionality structure devices, all of which may be separately used, or combined with one another for use. The tridimensional forms of the ecological buildings are the forms of the tridimensional ecological buildings, as well as the relations among the devices and other buildings. The forms may be unlimited, which may be the numerous building forms and tridimensional ecological buildings that are formed by tridimensional structure theories, such as the super-high turret buildings, middle-high, low tridimensional ecological buildings with one or more layers, or single-layer houses, and underground tridimensional ecological buildings with one or more layers. The ecological buildings may be used with multiple building forms and the combinational forms, such as the unlimited numbers of ecological buildings that are formed by right angles, arcs, curves, combined lines and lines, including tridimensional ecological roads, tridimensional ecological bridges, tridimensional ecological stations, tridimensional ecological rivers, tridimensional ecological nests for birds, tridimensional ecological lands, tridimensional ecological forests, and other unlimited ecological building structures, which are the outstanding signs of the tridimensional ecological buildings. Ecological space structures for cultivation of plants and organisms may be partly or entirely added in the form of buildings on the top layers, bottom layers, and other layers, as well as with other cooperating devices and equipments. The solar power refractive and transmitting structure systems refract and transmit sun light via refractive, reflecting and transmitting materials and devices to the inside of the building structures, which may be used for habitants and organisms. The system devices use refractive plates, walls, paper paints layers, tube structures, curve structures, refractive structures, rotating refractive structures, combined structures and other warm houses structures. The transmitting devices are made of solid and hollow transmitting materials, which comprise light collector devices, light focusing devices, fiber cables, other light transmitting materials, astigmatic inlets, and movable sunlight pursuing control systems, which may be large, middle or small, and which may be used on tridimensional ecological roads, tridimensional ecological bridges, tridimensional ecological rivers, tridimensional ecological buildings, and other building structures. The new types of functional building materials, devices, configuration systems comprise building structures that can transmit and refract lights, fixed devices, movable devices, various type of solar power generation devices and structures that can be entirely or partly used, such as door window type, wall type, and roof type solar power generation structures and sunlight transmitting and refractive structures, double-layer glass door windows and double-layer walls, doors, windows and other transparent building layers and building floors, underground sunlight transmitting structures, organisms cultivation structures.

The air cooling/heating filtering devices (passages) systems extract water from air according to the temperature difference between cooling air and heating air. The large, middle, small electric air water filtering devices and the cooling/heating air water filtering passage devices can be assemblies together, which can be mounted in different spaces in the ecological buildings, and can also be mounted in oxygen transmitting, air passages, air purifying and recycling systems, and can also be made products for sale, with much water saved. The water transmitting, storing and supplying systems comprise the internal water transmitting, storing, and supplying systems inside the ecological buildings and structures, as well as the external water transmitting, storing, and supplying systems from outside. The external water transmitting, storing, and supplying systems from outside comprise water transmitting passages (rivers, underground rivers, passages, water pipes) and water reservoirs (including water transmitting passages, one or more sub branch water reservoirs, reservoirs type water passages, water reservoirs for cultivation of aquatics, air cooling/heating water filtering passage devices, water purifying and sanitation systems, purifying systems for polluted water, various types of ecological organisms and plants gardens, passage type ecological warm house network and other ecological buildings that form the ecological network systems). The internal and external water transmitting, storing, supplying systems can be integrated together or separated. The combined type ecological buildings network systems comprise various types of tridimensional ecological buildings (including the buildings for habitants, for organisms, for transportations, for agricultures, other agriculture buildings for habitants, and awnings) that combine with natural environments, which connect with one another to form network systems. The network systems may be large or small, with more or less number of ecological buildings. The organisms processing and storage systems refer to the storage (including the cool reservoirs) of the organism productions and the deep processing of the organism productions, comprising in detail the network systems from the storage of the seeds, cultivations, research, production, processing and sales. Mechanical frame transmitting systems for cultivation of organisms refer to the structures for cultivation of organisms using transmitting methods, comprising various types of transmitting devices and various types of flow lines, as well as the formed ecological building structures and complement structures characterized in the structures with frames, steel frames, concrete frames or combined frames. The transmitting devices can be operated manually or automatically. The concrete frames and the combined frames may be provided on the top, middle part or the bottom of the building structures, which may be fixed or combined, and which may be provided inside or outside of the building structures and other portions, and which may be warm houses that may be opened and closed, may be awnings, and may be plants frames, and which may be combined with structures for cultivation of organisms. The organisms systems for sightseeing are inside or outside the ecological buildings for habitants to contact natural environments, which may be provided partly in the yards of the ecological buildings with different occupied areas, and which may be provided in one or more layers of the tridimensional spaces, and which may be provided in porches, corridors, parlors, public areas, which may be combined with production type ecological environments or may be separate. The solar power, wind power, water power, mechanical power generation systems are mounted on the building structures. The solar power generation systems comprise solar power receiving sheets, power storages, electric transmitters, which can be separate, fixed, movable, door window, lying, and which can be aboveground, inside or outside the buildings, and which can be entirely or partly provided. The wind power generation systems comprise wind power generation devices (wind leafs, inside buildings, wind power channels) that can be connected with the storage and transmitter of the solar power generation devices and that can be separately provided. Those above mentioned are part of the techniques of the tridimensional combined ecological buildings, which can be entirely, partly or separately used, with functions and structures variable.

### SUMMARY OF THE INVENTION

A multifunctional tridimensional combined ecological architecture that combines one or more tridimensional ecological buildings and complement structures and cooperating device systems has the following main characteristics. The multifunctional tridimensional combined ecological architectures comprise several tridimensional ecological buildings, which combine tridimensional ecological environments and structures together, which can be provided inside the buildings, outside the buildings, complement, opened and closed, mechanically transmitted, overlapped, consistent to Yixue, underground, aboveground and semi-underground. They can be super-high, middle, or low tridimensional ecological buildings or single-storey buildings, and they can also be awnings for cultivations, movable long corridors, tridimensional lands, tridimensional ecological bridges, tridimensional ecological walls, ecological spaces, space rotating cultivation frames for organisms, tridimensional combined ecological frames for cultivation of organisms, tridimensional ecological rivers, ecological residential houses in rural areas, ecological villas, ecological factories, public utilities, ecological researches, ecological houses and other forms. Most of all, they can form or partly form tridimensional ecological villages and tridimensional towns for habitants, which can be independently provided or with production type ecological environment structures. The space rotating cultivation frames for organisms comprise building structures, electric rotating devices, rotating pivot points, cultivation plates (boxes) for plants and organisms. Frame type tridimensional cultivation devices for organisms comprise frame structures, rotating controllers, rotating transmitters, organisms cultivation ecological boxes, underground pool for storing and purifying water, methane tanks and others, which may be provided separately, or combined, in all the portions of the aboveground and underground buildings. The solar power, wind power, water power, mechanical power generation systems are mounted on the buildings. The solar power generation systems comprise solar power receiving sheets, power storages, electric transmitters, which can be separate, fixed, movable, door window folded, lying, and which can be aboveground, inside or outside the buildings, and which can be entirely or partly provided. The wind power generation systems comprise wind power generation devices (wind leafs, inside buildings, wind power channels) that can be connected with the storage and transmitter of the solar power generation devices and that can be separately provided. The wind power generation systems comprise energy-saving systems that save energy, water and electric power, oxygen chambers and oxygen transmitting systems, air transmitting and recycling systems, purifying systems for air and water, rains and snows collecting, water storing, purifying and supplying systems, clear water supply systems, back water purifying systems for used water, methane storing systems, cultivation systems for aquatics, cultivation and irrigating systems for plants, illumination systems, artificial intelligent automatic control systems, movable ecological spaces and device orbit systems, ecological systems for habitants and plants, ecological space buildings structures, tridimensional forms of ecological buildings, sunlight refractive and transmitting systems, new functional type constructing materials and equipments supplying systems, heating/cooling air devices (passages) systems for filtering water, water transmitting, storing, supplying systems, combined ecological buildings network systems, organisms systems for sightseeing, organisms production, processing and storage systems, mechanical frame transmitting systems for cultivation of organisms. Those cooperating devices and equipment systems generally combine with the ecological buildings to form large-scale or luxury ecological buildings for habitants' continuous development, or to form middle or small scale ecological buildings with fewer configurations or separate configuration.

Multifunctional tridimensional combined ecological architectures may be in different forms, including tridimensional ecological buildings mainly for habitants and secondly for ecological organisms environments, such as offices, residential houses or business buildings, tridimensional ecological buildings mainly for ecological organisms environments and secondly for habitants, tridimensional ecological buildings for habitants and ecological organisms environments together, tridimensional ecological buildings for sightseeing, tridimensional ecological buildings for cultivation of plants, tridimensional ecological buildings for cultivation of animals, tridimensional ecological buildings for cultivation of plants and organisms together, multifunctional tridimensional combined ecological architectures for habitants, for cultivation of plants and organisms, and for natural ecological environments, multifunctional tridimensional ecological buildings, mechanical frame type ecological buildings for cultivation of organisms, ecological buildings that can be opened and closed. The building systems comprise a type of air water recycling system that includes ecological buildings, inlets and outlets devices for air, air passages, air water filtering, purifying and storing devices. The system filters the water from ecological buildings and other humid airs via temperature differences, and stores the filtered water for organisms. The air cooling/heating filtering devices (passages) systems extract water from air according to the temperature difference between cooling air and heating air. The large, middle, small electric air water filtering devices and the cooling/heating air water filtering passage devices can be assemblies together, which can be mounted in different spaces in the ecological buildings, and can also be mounted in oxygen transmitting, air passages, air purifying and recycling systems, and can also be made products for sale, with much water saved. The water transmitting, storing and supplying systems comprise the internal water transmitting, storing, and supplying systems inside the ecological buildings and structures, as well as the external water transmitting, storing, and supplying systems from outside. The external water transmitting, storing, and supplying systems from outside comprise water transmitting passages (rivers, underground rivers, passages, water pipes) and water reservoirs (including water transmitting passages, one or more sub branch water reservoirs, reservoirs type water passages, water reservoirs for cultivation of aquatics, air cooling/heating water filtering passage devices, water purifying and sanitation systems, purifying systems for polluted water, various types of ecological organisms and plants gardens, passage type ecological warm house network and other ecological buildings that form the ecological network systems). The internal and external water transmitting, storing, supplying systems can be integrated together or separated. The combined type ecological buildings network systems comprise various types of tridimensional ecological buildings (including the buildings for habitants, for organisms, for transportations, for agricultures, other agriculture buildings for habitants, and awnings) that combine with natural environments, which connect with one another to form network systems. The network systems may be large or small, with more or less number of ecological buildings. The organisms processing and storage systems refer to the storage (including the cool reservoirs) of the organism productions and the deep processing of the organism productions, comprising in detail the network systems from the storage of the seeds, cultivations, research, production, processing and sales. Mechanical frame transmitting systems for cultivation of organisms refer to the structures for cultivation of organisms using transmitting methods, comprising various transmitting devices and various types of flow lines, as well as the formed ecological building structures and complement structures characterized in the structures with frames, steel frames, concrete frames or combined frames. The transmitting devices can be operated manually or automatically. The concrete frames and the combined frames may be provided on the top, middle part or the bottom of the building structures, which may be fixed or combined, and which may be provided inside or outside of the building structures and other portions, and which may be warm houses that may be opened and closed, may be awnings, and may be plants frames, and which may be combined with structures for cultivation of organisms. The organisms systems for sightseeing are inside or outside the ecological buildings for habitants to contact natural environments, which may be provided partly in the yards of the ecological buildings with different occupied areas, and which may be provided in one or more layers of the tridimensional spaces, and which may be provided in porches, corridors, parlors, public areas, stadiums, which may be combined with production type ecological environments or may be separate. The solar power, wind power, water power, mechanical power generation systems are mounted on the building structures. The solar power generation systems comprise solar power receiving sheets, power storages, electric transmitters, which can be separate, fixed, movable, door window, lying, and which can be aboveground, inside or outside the buildings, and which can be entirely or partly provided. The wind power generation systems comprise wind power generation devices (wind leafs, inside buildings, wind power channels) that can be connected with the storage and transmitter of the solar power generation devices and that can be separately provided. Those above mentioned are part of the techniques of the tridimensional combined ecological buildings, which can be entirely, partly or separately used, with functions and structures variable. The unit of the combined ecological environments (structures) may be arranged horizontally, vertically, inclined, in various regular and irregular arrangements, or in the combinations. The structures may be opened, closed, movable, opened and closed and the combinations. The structures may be opened and closed horizontally, vertically, inclined or the combinations. The ecological buildings may be high or low with one or more layers. The ecological (plants) spaces can be mounted in the buildings once or more times, the unit structures of which corresponds with the layer structures of the buildings with one or more layers and awning types spaces. The unit ecological spaces can be divided into several layers of ecological environments, in which cultivation environments for plants and natural ecological environments are provided, such as rockeries, walls, pools, flowers and grasses, tropic forests, fish and birds, organisms in flow water, the occupied areas of which can be small or large in one of the spaces or in most of the spaces with large occupied areas. They can be combined with environments for habitants, such as tea houses, meeting rooms, recreation areas, business rooms, to form new type of building environments and cultures. The ecological environment spaces can be internally divided into several parts, setting seasonal cooling/heating climate adjusting systems, automatic monitoring systems, alarming systems, background music systems, fire prevention and fighting systems, air purifying water filtering systems, oxygen output systems, illumination systems, water supplying and recycling systems with cooperating devices, ultraviolet protection and sanitation systems, all of which may be independently provided or integrated with the ecological buildings, with unlimited numbers. The air water saving recycling systems comprises air water filtering devices. Air is transmitted to the purifiers through the inlets by wind blowers, in which there are heating devices to vaporize the water in the air, and the vaporized water is filtered out by the cooling filtering suspending devices in the cooling devices and discharged out of the water filtering purifiers from the outlets, which can be used for ecological buildings, or can be stored in the water reservoirs. The air water filtering purifiers may be upright, caged, suspended, air-conditioned, which can be used inside ecological buildings for cultivation of organisms, and which can be used in other sites as multifunctional air water filtering purifiers with series of small and large types. The buildings are provided with intelligent control systems that can be controlled entirely, partly, or separately. The ecological buildings can be provided with theft and fire prevention and fighting alarming systems, image transportations, dialogue system for security in buildings, closed-circuit monitoring systems, and also natural energy resource power generation network systems. The systems comprise wind power generation devices, solar power generation devices, water wheel power generation devices, elevator type power generation devices, door type, ladder type and other type mechanical power generation devices, and energy saving and distributing systems that include storage batteries, voltage transformers, power distribution plates, bolts and connecting wires. The power generation devices and energy saving systems are combined together with integrated power saving and distribution, which can be partly, entirely or separately provided. The ecological buildings are provided with water supply and drainage pipes systems and wind passages systems, the two systems can be integrated or separately provided. The water supply and drainage pipes systems can be provided with pumps, water reservoirs, water purifying devices and methane tanks. The wind passages systems can be provided with fans, internal wind power generation devices, air water purifying and filtering devices and oxygen suppliers and transmitters system. The ecological buildings have roof type sunlight spaces and sunlight passages, which can be provided on the building structures, on the single-storey buildings, on the semi-underground buildings and on the underground buildings, and which can be houses, garden square areas, road type structures, and which may form networks. They can be integrated with other buildings and cooperating devices, or can be independent. The ecological buildings may be village-houses, villages, and integrated or separated buildings, with the functions provided entirely or partly in the ecological buildings. There are systems for storing rains and snows and for recycling, which comprise water reservoirs, air water filtering passages, water filtering and purifying devices, water purifying and storing devices for cultivation of organisms, clean water filtering devices, clean water storage devices, water recycling systems and water supplier and water saving devices. The devices and cooperating devices can be with more or less numbers, which may be used together, separately, or combined with other devices. The ecological buildings can be provided with transmitting devices for cultivation of organisms, which may be upper moving orbits, succeeding flow transmission belts, horizontally arranged transmitting orbits, vertically arranged ground orbits and other transmitting devices. The devices may be the boxes for cultivation of organisms, which may be suspended, laid, piled, tridimensional, etc. The cultivation boxes for organisms may be with soils, waters, other artificial soils, or volcanic ashes that are substitutes for soils. Heating devices and irrigation devices may also be provided in the cultivation boxes for organisms, such as solar power heating and discharging devices, water spraying devices. The buildings are provided with solar power generation and saving systems that comprise solar power receiving plates, electric storage devices, transformer devices, current meters, power distributing devices, electric supplier networks and other cooperating devices. The solar power systems may be integrated ones or separated ones. In the integrated solar power systems, the electric suppliers devices in the ecological buildings or the ecological building structures are integrated together for use in the entire buildings, while in the separated solar power systems, they are mounted in part areas of the buildings for use. The solar power generation and saving systems, as well as the various types of integrated or separated solar powers may be used for all or part of the appliances inside the buildings. The solar power systems may be laid, upright, fixed, folded, rotating, in the form of sleeping porches, door windows, curtains and walls, which can not only be applied to ecological buildings, but also be applied to other building structures. One or more same or different building roof awnings and building transparent walls may be used to enclose the buildings and the separated outside spaces, or the entire buildings. The inside spaces may be ground type natural environments or tridimensional layer type ecological environments for cultivation of plants that may be layered, fixed, and movable. The newly added building roof awnings and the building transparent walls may be fixed, disengaged, opened and closed, and other structures with unlimited forms. The ecological buildings can be provided with underground spaces for organisms, for habitants, the top roof of which comprising single-layer or double-layer enclosed devices that are parallel, or not, to the ground. On the enclosed devices are fixed transparent glasses or other devices that can be opened and closed. The opened and closed devices may be windows occupying small areas, may be other large devices that can be opened and closed. The underground ecological buildings may be combined with the ecological buildings, or may be separate, inside which there are spaces for plants, for organisms, for habitants, for both organisms and habitants, and which may be with one or more layers. Passages type ecological buildings are provided in the buildings, which comprise walls, awnings made of glasses and other combinational materials. The frames may be disengaged, combined, with one layer or more tridimensional layers, and set to spaces and underground passage type warm house, inside which there are organisms incubated for sightseeing, passages devices and habitants environments, underground ecological spaces for cultivation of organisms, and additional cooperating devices, such as water suppliers, water storages, and water purifying devices. The various types of ecological buildings may be combined entirely, partly or separately, which may be combined with other building structures. The buildings comprise main buildings, secondary buildings, cooperating buildings, cooperating devices, upper water devices, cooling/heating devices, solar power generation devices, wind power generation devices, building roof garden structure environments, building roof transparent sunlight warm houses, roof frame rain-proof type ecological spaces. The present buildings can be added with ecological warm houses, awning type ecological buildings, forming combined ecological buildings and roof gardens, with lifting devices, passages, ladders and other functional structures, and with building functions and shocking-proof functions. Solar power warm houses awning spaces and other agriculture productions can also be provided, which may be on the top roofs, on the grounds or underground. The solar power generation devices may be provided inside or outside the buildings, on the awnings, on the grounds, which may be connected with lines to supply electric power for warm houses, illuminations for awnings and other appliances. The solar power generation devices may be combined with other complement functional devices. The ecological buildings may be in the form of upright studs, turrets, triangles and other forms. Ecological environmental spaces composed of plants and waters can be provided inside the buildings and on the surfaces of the buildings. The plants may be provided internally, externally, or internally and externally. The internally provided spaces can be provided opened and closed, as well as with ventilation devices. The ecological spaces in the building structures for plants may be provided in different layers, which may be with one or more layers, and which may be arranged in high layers, or arranged as desired. Plants can be provided with unlimited numbers, which may be integrated together with hills and waters, grasses, gardens and habitant environments. The plant environments may be also for habitants, recreations, works, sightseeing, productions and the combinations, and may also be designed large-scale ecological buildings with other non-ecological plants buildings. Oxygen passage systems, water purifying systems, water reservoirs, water recycling systems, ventilation systems, ecological systems for cultivation of organisms, cultivation systems for aquatic productions and other systems may all be provided with ultraviolet light sanitation devices that may be houses, boxes, pipes and lamps that can be with different numbers and different structures. Solar power generation devices, wind power generation devices and solar power refractive and transmitting devices are provided. The solar power generation devices may be laid or upright, may be rotating or fixed, may be provided on the grounds, or the inside/outside spaces on the buildings. The wind power generation devices may be separated ones or combined ones, which may be on the grounds or buildings. The wind power generation devices may be driven by external natural winds or internal passage winds. The solar power refractive and transmitting devices may be divided into reflecting plate (walls) type refractive devices and transmitting devices. Refractive devices may be fixed or movable with lights that may be moved automatically or manually. The solar power generation devices, wind power generation devices, solar power refractive and transmitting device may be combined with their separate functions or entire functions, with different forms and structures. The several types of devices may be combined together or separately. The ecological buildings comprise passage type ecological warm houses in the form of long passages that are connected with one or more building structures, forming networks. Houses and other habitant environments can be provided inside the passages, where ecological environments for plants and organisms can be provided. The habitant environments may be for roads, for meetings, for recreations, for offices and residential houses, may be provided with single-passage or double-passage transportation roads, may be with one or more layers, may be underground, aboveground, underground and aboveground. On the above spaces of the buildings are provided with cooling/eating temperature control devices, ventilation devices, rains and polluted water discharging devices, polluted water purifying devices, solar power refractive and transmitting devices, inside cooling devices and other devices. The functions of ecological passage devices can be combined with the functions of the cooperating devices. The cooperating devices may be aboveground, underground with unlimited numbers and different structures. The ecological buildings are provided with oxygen supplier systems and ventilation systems, water supplier systems, water purifying and recycling systems, and sanitation devices are equipped inside the systems, which inside the sanitation spaces, pipes, hollow walls, passages kill the deleterious materials in oxygen, ventilation winds and water flows, converting them to in-noxious gases and water flows. Other sanitation methods may also be used, such as heating (insolation and dry). In a type of tridimensional roads type ecological buildings, roads and ecological buildings are provided underground or aboveground with different layers. The roads and ecological buildings may be arranged in different methods with different forms. The tridimensional road type ecological buildings may be connected with normal roads, or may be separate, with unlimited lengths, any forms and structures. They may be combined with large-scale buildings, and provided with ecological spaces, water reservoirs, solar powers, water purifiers, and cooling/heating devices. A type of combined ecological towns comprise various types of aboveground, underground ecological buildings, tridimensional ecological roads, tridimensional ecological bridges, ecological passages, tridimensional plants, land type ecological buildings, water collectors, water reservoirs, water purifying systems, cultivation systems for aquatics, obvious and hidden rivers network ecological environments for aquatics, tridimensional ecological walls and buildings, ecological town water systems. The ecological towns may be combined with normal buildings, with various types of irregular ecological garden environments that can be opened and closed, and various types of ecological cultural places for habitants. The ecological towns can be provided with various numbers of cooperating buildings and cooperating devices, complement structures. The structures may be variable with small or large occupied areas. The ecological buildings may be in the form of single house, single villa, which may be agriculture ecological villages, or the combined ecological structures both for habitants and for organisms. The ecological towns and the ecological buildings are equipped with various types of solar power generation devices, various types of wind power generation devices, methane tanks, dealing systems for polluted water, used water and feces, water reservoir ditches and rain storages, water purifying systems. All those cooperating devices may be with various numbers, functions, structures and positions. A type of tridimensional ecological land type buildings comprise plants, grasses, underground and aboveground ecological buildings. A type of awning type agriculture ecological warm houses for production comprises aboveground warm houses, underground warm houses, and the combined warm houses that are partly aboveground and partly underground. The aboveground warm houses (awnings) may be with one or more layers. The underground warm houses may be with one or more layers. Both the aboveground warm houses and the underground warm houses can be used for cultivation of organisms. Water reservoirs for rains and methane devices can be provided inside/outside the ecological building layers. The buildings may be aboveground or underground, may be open to the air or enclosed, may be opened, fixed or movable. The water reservoirs may have passages for rains and snows, through which the rains and snows around the buildings may be stored for future use. Water filtering and purifying devices may also be provided. The water pipes may also be used for external water resources, such as the water from wells and the used water. The buildings may be provided with building cultural places for habitants, for rest, for processing, for recreations, for reservoirs and for sanitations. Solar power generation devices and wind power generation devices may also be provided for the buildings, which may be arranged vertically or laid with variable structures, and which may be integrated entirely, partly or separately for use. Water suppliers systems may also be provided. The buildings may be used by layers for cultivation of plants and various types of organisms that plants are used to breed animals, and animals are used to culture plants, and the feces from animals may be used for plants and for methane tanks that afford heat to the buildings. The buildings may be with various occupied areas, structures, numbers, which may be combined with town buildings, complement area buildings for agricultures, forests, fisheries and other industries, and may also be combined with village buildings, villas and other cooperating buildings. Sanitation devices systems may be provided inside the ecological buildings that mainly use ultraviolet light, and secondly use medicines, temperatures, and the two methods may be combined or separated. The sanitation functions may be provided in the sanitation spaces, the outlets of the ecological cultural places for habitants flow, materials flow, water flow, devices flow and air flow, air flow systems, oxygen flow transmitting systems, water purifying and sanitation systems, upper and lower water systems, areas for cultivation of organisms and areas for habitants. A type of ecological buildings with Chinese traditional cultures eight Gua and Yixue principles, characterize with Gua and Taiji graphics. The yin and yang graphics denote the cultivation of organisms, indicating that the organisms inside the ecological buildings may live permanently. The eight Gua in the graphics may be graphics, and may also be the ecological functions of the ecological buildings, such as the sunlight transmitting devices, air ventilation systems and water recycling systems, small building systems for cultivation of organisms (for examples, rooms and awnings). The yin and yang fish may be rotating or fixed. Other ecological buildings besides those in the graphics may also be added. The graphic combinations may be flat or rugged. The single or combinational parts of the eight Gua may be arcs or straight lines, which may form rectangles and circles with sixty-four Gua. The Gua may be with various numbers, which may be single Gua or combinational Gua, forming various forms of ecological buildings, such as of high layers turrets type, of pyramids cones types, of ladders types, of huge, circle or combinational ecological buildings type. Environments spaces for cultivation of plants and for habitants may also be provided inside/outside the ecological buildings. Standard Taiji graphics as well as deformed Taiji graphics may be used. The forms and functions of Taiji graphics, the graphics and functions of eight Gua Taiji graphics, as well as the derived numbers of eight Gua may bi-dimensionally or tri-dimensionally combine to form large scale Taiji and eight Gua type huge ecological buildings structures matrix, with various numbers of eight Gua and Taiji ecological buildings, which may be ecological buildings for habitants, for cultivation of organisms, for cultivation and production of Chinese medical plants and organisms. It is one of the important features of the combined ecological buildings to have combined ecological buildings. Common ecological buildings may be used to replace the Taiji graphics on the eight Gua type ecological buildings, making them to be common ecological buildings, which may be for cultivation of organisms, for cultivation and production of organisms, for sightseeing, for research, for habitants and for the combinations. A type of movable ecological buildings may be with one or more layers, under which are provided with wheels that comprise multiple sets of wheels. The wheels may be mounted directly under the buildings, which may be disengaged, and which may move on the laid orbits or in other forms. The type of ecological buildings may be applied to passage type ecological buildings, small warm house buildings, and may be aboveground, underground and inside the buildings with different structures, which may be frame transparent, may be mounted and disengaged, and in other forms. The buildings may also be provided with various types of ecological mechanical devices that can move, rotate, slide and roll. A type of village-house type ecological buildings comprise tridimensional ecological rivers (lakes), tridimensional ecological walls, underground and aboveground tridimensional ecological roads, underground ecological building structures, aboveground ecological building structures, water recycling, purifying, and storing systems, sunlight refractive and transmitting device systems, cultivation systems for organisms, air ventilating, purifying and exsiccating systems, temperature adjusting systems, air water sanitation systems with ultraviolet light, solar power, wind power and mechanical power generation devices systems, computer aided monitoring systems, artificial intelligence automation control systems, automatic alarming systems, ecology systems for habitants, factory processing systems, storing systems, light transmitting and refractive systems, electric supplier and water supplier systems. The tridimensional ecological rivers comprise rains, snows, and used water collecting, purifying and storing systems (water pools, reservoirs, lakes), where the external water receiving systems receive rains and transmit them directly to water reservoirs, artificial rivers (and natural rivers, lakes), segmented rivers by cover plates (nets), main recycling rivers, sub branch ecological river (lake) water suppliers pipes, water purifying systems, ecological water reservoirs, recycling and purifying devices systems, heating and cooling devices systems, purified water storing devices systems, ultraviolet light sanitation spaces (passages) systems and other systems. The tridimensional ecological walls comprise wall systems, for examples walls, barriers, wall bridges, ecological building internal walls, warm houses, ecological spaces for plants and animals, turrets buildings, etc. The tridimensional ecological buildings systems comprise various layers ecological buildings, underground ecological environments, common buildings, special functional buildings, etc. Solar power, wind power generation devices can be provided entirely or partly in the buildings systems, which may be on the ground, and used for the entire buildings or part of the buildings. A type of tridimensional combined ecological towns comprise aboveground ecological buildings, underground ecological buildings, combined ecological buildings that are partly underground and partly aboveground, aboveground and underground tridimensional road type ecological buildings, aboveground and underground tridimensional land type ecological buildings, aboveground and underground public ecological devices, tridimensional ecological walls, tridimensional ecological rivers, and ecological buildings for habitants. The ecological buildings comprising many, few or single ecological buildings have discharge ditches or other water collecting, discharging, purifying and storing systems, which may purify and store rains, snows and used water. The buildings may have solar power, wind power generation devices, air exsiccating and filtering devices, cooling, heating, temperature controlling, water storing and sanitation devices and other cooperating devices. The tridimensional ecological roads have light transmitting and refractive devices. Ecological spaces for organisms and habitants can be provided above, on, or under the tridimensional ecological road type, land type ecological buildings. The ecological towns have tridimensional ecological walls, tridimensional ecological rivers (lakes), which may be entirely or partly surrounding the ecological towns. Ecological walls may be flood-preventing type or secure type. Walls can be provided with aboveground and underground plants environments, ecological spaces, warm house, watch towers, gardens, tropic forests, hills and water, wall bridges, closed doors with various forms and structures, which may be integrated with simple barriers, buildings structures with high, middle and low qualities. Tridimensional ecological river systems may be the water systems comprising rivers, lakes, water reservoirs, ecological cultivation buildings, water purifying devices, polluted water dealing devices, various river sections for cultivation of organisms (aquatics), which may be aboveground, underground, opened to the air, closed, opened and closed, closed by nets, or awnings, and which may be connected with external water systems. Tridimensional ecological walls, tridimensional ecological rivers, cooperating building structures and cooperating devices may be with different structures and different numbers, which may be connected or combined with one another, and which may be combined with tridimensional ecological towns, single house, or combined houses, or may be separate for use. Tridimensional ecological towns may be provided with none, either, or both tridimensional ecological walls and ecological towns, or only use common barriers, rivers, roads and buildings to divide the ecological towns to different areas. A type of air water exsiccating, purifying and filtering devices from air according to cooling/heating principles, comprise air inlets, air heating structures, air cooling and water filtering structures, water outlets, air outlets and other cooperating devices, in which air can be heated by heating winds, electrics, heating gases, heating water, methane, and cooled by electrics, cooling winds, cryogens, ice, cold grounds. They can be applied to ecological buildings, warm houses as cooperating devices, or applied to others as independent water generation devices, with a series of products that have different forms, structures, occupied volumes. They can be provided with sanitation devices using electric or ultraviolet lights, which may be boxes, pipes, passages and other forms. Cooling/heating pipes, suspended plates, suspended pipe networks can be used for heating and cooling, which can be integrated with exsiccating devices and other functional devices. They can be applied to humid areas as civil products, such as ecological buildings, warm house cooperating devices for plants and organisms. A type of tridimensional ecological land type ecological building are the building structures with one or more layers that are under the grounds, or under the grounds of ecological plant covers. The ecological plant covers lands may be flat, may be in the form of tridimensional garden buildings, hills and water, lakes, building patios, or may be the combinations of multiple ecological plant covers and the building gardens. The tridimensional land type ecological buildings may also be added one or more layer of frame type ecological building structures above the ecological plant covers lands. A type of top roof frame type transparent ecological building structures, comprise aboveground or underground tridimensional ecological buildings and top roof frame type structures. The top roof frame type transparent structures comprise frames and transparent glasses. The frames may be metallic frames, concrete frames, or the combined frames, with their forms and structures being bi-dimensional or tridimensional, which may be opened to the air, or opened and closed. The frames can be provided with sunlight refractive and transmitting devices, solar power generation devices. Sand-proof cover devices that can prevent sands, maintain temperature and protect air spaces may also be provided on the frames, which may be made from one or more layers of materials, and which may be opened and closed automatically or manually, which can be applied not only to top roof frame type transparent structures, but also to passage type ecological awning buildings, tridimensional agriculture awnings, transparent warm houses and other ecological buildings and devices. Various types of tridimensional ecological buildings comprise multifunctional tridimensional combined ecological architectures, tridimensional ecological building structures for cultivation of plants and organisms, hood type ecological buildings, aboveground and underground ecological buildings, tridimensional land type ecological buildings, tree type tridimensional ecological buildings for organisms, turret type ecological buildings, aboveground and underground combined passage type ecological buildings, multifunctional ecological buildings, Taiji graphics (Yixue) type ecological buildings for organisms and other ecological buildings with cooperating devices and systems. The combined village-house type ecological buildings may exist independently in various types of natural environments, may have solar power generation devices and other power generation systems, may have waters recycling systems, and aboveground and underground ecological devices, tridimensional ecological lands, tridimensional ecological roads, tridimensional ecological bridges, tridimensional ecological walls, tridimensional ecological rivers, aboveground and underground water reservoirs, and cultivation systems for plants and organisms (including aquatics) that are complement to the various types of systems. The functions of combined village-house type ecological buildings may be entirely, partly or separately combined with the functions of several tridimensional ecological buildings, the functions of multifunctional tridimensional combined ecological architectures, and the functions of tridimensional ecological buildings structures for cultivation of plants and organisms. The tridimensional ecological lands, tridimensional ecological roads, tridimensional ecological bridges, tridimensional ecological walls, tridimensional ecological rivers, functional building structures, aboveground and underground water reservoirs, and cultivation systems for plants and organisms (including aquatics) that are complement to the various types of systems can be combined entirely, partly or separately, forming various types of tridimensional ecological building structures with different forms.

### BENEFITS OF THE INVENTION

Modern sciences and techniques are mostly used for tridimensional ecological buildings that are mainly for habitants, and that save energies and lands, and that balance habitants and natural environments, with the results that natural environments are inside buildings, buildings are inside natural environments, and habitants are inside buildings, thus buildings, habitants and natural environments are integrated together into scientific space environments. These habitants environments will effectively supply habitants with environments that can be used for habitants and that can eternally support continuous development. These environments comprise not only tridimensional combined ecological buildings, but also new type high-tech results.

### DESCRIPTION OF THE DRAWINGS AND THE EMBODIMENTS

FIG. 1 is a schematic view showing the functions of a multifunctional combined ecological building.

FIG. 2 is a schematic view showing a hood type ecological building with energy, water, gas, pollution engineering.

FIG. 3 is a schematic view showing the ecological structures, oxygen rooms, and water resources and recycling accessories of a ecological building.

FIG. 4 is a schematic view showing the underground and semi-underground ecological buildings with complemented ecological buildings.

FIG. 5 is a schematic view showing the functions of the tridimensional land type ecological buildings (frames) for cultivation of organisms.

FIG. 6 is a schematic view showing a tree type tridimensional ecological building for organisms.

FIG. 7 is a schematic view showing a turret ecological building and the accessory photoelectric devices and energy devices.

FIG. 8 is a schematic view showing combined passage type ecological buildings with air, water purifiers and supplier network systems.

FIG. 9 is a schematic view showing combined functional ecological buildings and Taiji type ecological buildings.

FIG. 10 is a schematic view showing combined village-house type functional ecological buildings.

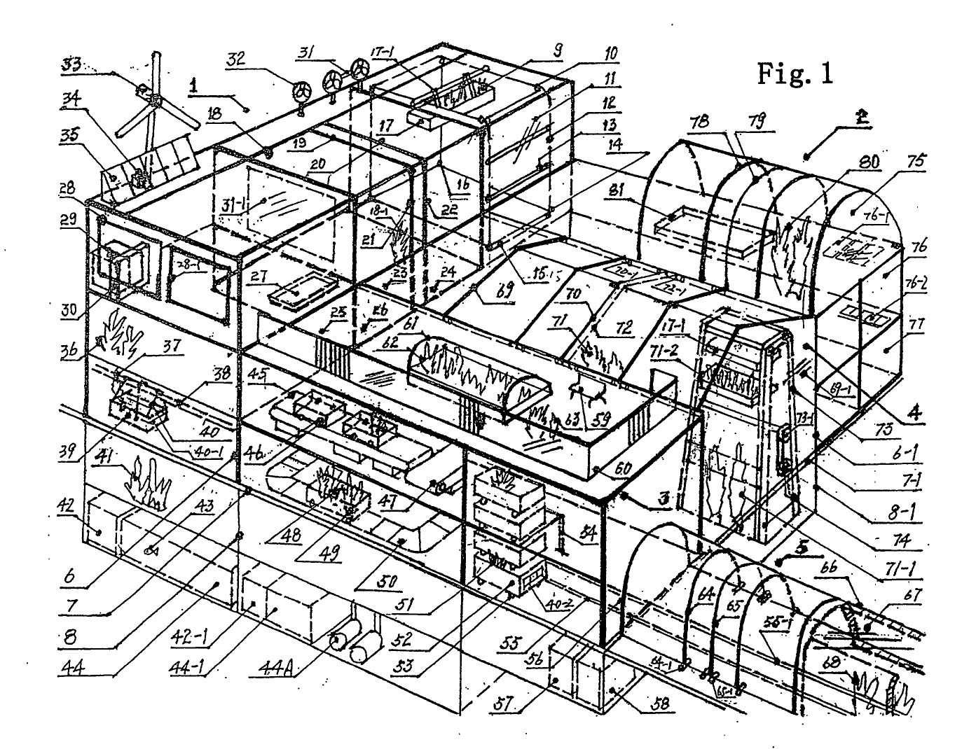

FIG. 1 is a schematic view showing a multifunctional combined ecological building. The numerals 1, 2, 3, 4, and 5 denote a main body of the ecological building, a cooperating awning ecological building (right), a cooperating garden ecological building, a transparent ecological building, a frame awning passage ecological building, respectively. The multifunctional combined ecological building comprises the main body 1 and the cooperating ecological buildings 2, 3, 4, 5, etc, which may be in different forms with more or less cooperating ecological buildings and different structures. 6, 7 and 8 denote the aboveground, ground and underground buildings of the main body 1, respectively. The main body may be an aboveground building 6, an underground building 8, the combinations thereof, or a semi-underground building, and may be with one or several layers, and the combinations thereof, and may be steel frames, concrete frames, and the combinations thereof, and may contain several spaces for different numbers and types of plants. The numeral 9 denotes a suspended box for organisms, which is another combination of ecological systems inside the main body. The numeral 10 denotes the pivot point for the box 9, The numeral 11 denotes a closed (or open) glass, The numeral 12 denotes a transmission belt (or a chain); The numeral 13 denotes a suspending chain rod; The numeral 14 denotes a lower pivot point; The numeral 15 denotes a lower suspending chain rod; The numeral 16 denotes a back pivot point. The numeral 17 denotes an organism cultivation box, which can be suspended on the suspending chain rod electrically, automatically or manually by a movable suspending rod 17-1. The box can be installed in the lower or higher layers, without using the middle layers, so that best illumination and biggest room are available. The box can have different structures and number of parts with other additional parts installed. The numeral 18 denotes a ecological space in the building; The numeral 18-1 denotes the physical environment inside the space 18, which may comprise natural landscapes, tropical rain forests, plants, hills, waters, waterfalls, habitations and biologic environments, the numbers and structures of which are not limited. The space 18 can be one, two or more layers, and can be together with apartments, office buildings, business buildings and houses, and can be constructed with several layers vertically, horizontally or the irregular combinations thereof. The number, size and structures of the ecological space are not limited (tridimensional space can be added for every spaces). The numerals 19 and 20 denote left and right movable top covers, respectively, which are used to open or close the ecological space 18. The numerals 21, 22 denote left and right vertical closing devices, respectively. 19, 20, 21 and 22 may be metallic or plastic-steel frames with transparent glass layers, and movable pulley, actuating device (automatically or manually). The closing devices and the movable top covers can be separately used or combined together according to the structures of the ecological space, so that the ecological space has physical environment and ecological-house environment, which are beneficial to improve the quality of the space for habitants and organisms, thus to meet the diversity of requirements. The ecological space can be in the forms of habitant environment, organism cultivation environment and ecological systems. The numeral 23 denotes a parallel structure (not shown in the fig.), The numeral 24 denotes a concavo-concave structure, the numeral 25 denotes a hill and water (waters, rivers and waterfalls) structure, the numeral 26 denotes a trapezoid structure. 23, 24, 25 and 26 of the ecological space 18 can be separately used or combined together with various structures and numbers, which can be integrated with physical environment 18-1 to form thousands of ecological building natural landscapes. The numeral 27 denotes a pool and water recycle ecological system, which comprises pools, rivers, water pipes and devices, water cleaning, sterilizing and organism cultivation recycle ecological system. Water can be recycled used inside the ecological space and the ecological building, which is one of the features of the water recycle ecological system. 28 and 28-1 is another structure of the main body ecological building 1, which can be a structure mainly for habitants, such as living rooms, offices, commerce, sports, cultures, factories, schools, researches, storages, etc, which can also be combined with ecological space environment. Its occupied spaces, numbers are not limited and the structures can be varied. The numerals 28 and 28-1 may also denote windows. The numeral 29 denotes a power storage device. The numeral 30 denotes a power distribution device. The numeral 31 denotes a small one-piece wind power generation device, which can be inside, outside or both inside and outside the buildings. The numeral 31-1 denotes a mirror surface, which can be on the ground, wall and awning of the ecological space, and which is beneficial to passing of sunlight. The numeral 32 denotes a small separated wind power generation device. The numeral 33 denotes a middle-big separated wind power generation device, which can be inside, outside or both inside and outside the buildings. The generated power can be stored and used separately or together with the storage device for solar energy. The wind power generation and storage system is an energy-saving apparatus comprising 31, 32, 33 and other equipments, which is used to supply power (partly or completely) for the buildings. Solar power generation, storage and distribution system is an energy-saving apparatus comprising 29, 30, 34 and 35, which is used to supply power for the buildings. The numeral 34 denotes a power storage device. The numeral 35 denotes a solar energy collecting plate, which can be inside, outside or both inside and outside the buildings. Solar power generation system can be separately equipped or together with wind power generation system, which can be on the (agriculture) ecological buildings and other ecological buildings or in any sites under the ground, the structures, forms and numbers can be varied. The numeral 36 denotes a ecological plant that can be placed in some layers, passages and any other sites of the building, whose scale is not limited. The numeral 37 denotes a ecological building that can be used for sightseeing and cultivation. The numeral 38 denotes movable top tracks. The numeral 39 denotes organism cultivation boxes that are suspended in the tracks 38. The length of the tracks and the number of the boxed are not limited. The numeral 40 denotes a transparent cover or an electrical transparent device for heat preservation. The numeral 40-1 denotes a pipe on the box for supplying water, which is connected to a water supplier device. The volume of the organism box can be varied, in which there may be solar power generation devices, heating devices, ventilation devices, temperature regulation devices, timing devices and other automatic devices. The numeral 41 denotes a space for organism cultivation, which may be one or more layers under the ground, or partly above the ground and partly under the ground, or separately underground or semi-underground, and which can be used as a ecological system room, device storage room, or office rooms. The numeral 42 denotes an underground water purifier and cleaner, which purifies and cleans water with the internal purifier and cleaner, so that water can be used for irrigation of organisms, washing rooms and vehicles, as sanitary water, and other daily usage. The underground water purifier and cleaner can be placed under the ground, or above the ground, which is a part of the water system of the ecological building. The numeral 45 denotes an aboveground transmission device, on which a movable organism cultivation box 46 with wheels is placed. The box 46 can be transmitted to a transmission belt line 47 by the transmission device, thus a successive pipeline transmission is formed. An organism cultivation box 48 with wheels may be placed on a transmission device with horizontal axle tracks on the horizontal ground tracks. The height and the structures of the organism box 49 can be varied. Several organism boxes may be piled one on the other in a storage room (or in an ecological room), and one or more piled organism boxes can be placed on the tracks. The numeral 52 denotes a piled organism box. The numeral 51 denotes the plants or other organisms inside the box. The numeral 53 denotes the wheels of the box. The numeral 54 denotes the platforms or rooms with multiple layers to store the organisms. 40-2 denotes the solar water heater and the solar power generator to be used for the box. The numeral 55 denotes the tracks for the movable box, which may be straight or annular and which extend from inside to outside. The outside part of the tracks 55 can be uncovered or inside the ecological building 5, thus the organism boxes transmitted in the track can be exposed to sunlight, which is good to the organisms. The numeral 56 denotes a frame building with passages for sunlight. It can be an awning type building, or other types of buildings (or a metallic buildings). The numeral 57 denotes the refrigeration facilities inside the ecological buildings, which may refrigerate for cooling buildings and warehouse via water, wind, ground, ice or others. The numeral 58 denotes the warming facilities inside the ecological buildings, which may generate heat for the ecological buildings via power energy, water, wind, ground, ice or others. The refrigeration facilities and the warming facilities can be used for a part of or the complete ecological buildings. They can be aboveground or underground with unlimited numbers and volumes. They can be made by one-piece air conditioners. The numeral 59 denotes the garden chairs on the top layers. The numeral 60 denotes the protective gratings made from nettings or other materials to prevent plants and others from falling by wind. The numeral 61 denotes the awning type warm house in the top layer garden. The numeral 62 denotes plants and organisms. The numeral 63 denotes plants, lawns and gardens with unlimited occupied areas on the top layers for cultivation of plants and organisms, which may be flat or bumpy with some other buildings, and which may be inside a warm house or other habitant environment. The numeral 64 denotes a warm house with sunlight passage that can be opened and closed. In the lower device of the warm house are the movable transmission wheels for it to be opened and closed. The numeral 65 denotes another house that can be opened and closed, in the lower device of which are the rotating wheels 65-1. The structures 64 and 65 that can be opened and closed are special structures of new awning type of ecological buildings with passages, and these structures can be combined together with door type structures that can be opened and closed. The numeral 66 denotes a wall type ecological building with passages. It is a truncated wall (the height is not limited) with transparent covers, which may be novel. The wall can be made from bricks, steel concretes, metal frame, glass walls, or the combinations thereof. The ecological building with passages may be one or more layers aboveground or underground, in which are there water storage, cleaner and purifier facilities. It may be separately used or combined with other ecological buildings or usual buildings, with different structures. Several branch passages can be made for the ecological buildings so that they are connected with usual ecological buildings to form a net of ecological buildings. It may extend for several miles, which can be suitably used in strict environment (especially in deserts). The numeral 68 denotes plant spaces of the passage type ecological building, which can be provided in the space beside the passage and the space connected to the passage. The organism box 52 can be pushed farther away via the track 55-1, thus forms a new organism cultivation manner. The numeral 69 denotes a transparent roof, which is provided in the combinations of the spaces of building 1, 2 and 3, thus a new ecological building is formed. This type of glass roof can be added to the current buildings and the combinations thereof, in which habitant houses, natural landscapes, plants in tropical rain forest plants and organisms, hills and waters, waterfalls, etc. are added, thus the environment is more beautiful with additional ecological system functions, and habitants can also enjoy the fruits from the incubated organisms. This type of glass roof may be suspended, flat or vertical or the combinations thereof, and may be in any place of the building. It may be planar, curved, prismatic, cone or the combinations thereof. The transparent glass may be framed with regular or irregular glass, or with other transparent materials. The glass roof may be transparent, translucent, or the combinations thereof, and it may be bumpy. The numeral 70 denotes the left open device of the glass roof for passage of air and sunlight. The numeral 72 denotes the right open device of the glass roof. The numeral 70-1 denotes the right movable wheel installed on the 72. The open devices 70 and 72 of the 69 can move left and right through the movable wheel 70-1 and 70-2 to open and close the ecological house 4. The ecological house 4 may be opened for long time for habitants to be with the nature when the weather is fine. The open devices 70 and 72 may be with different structures, such as movably opened and closed, ratably opened and closed, and other types. The transparent ecological building 4 comprises a glass roof 69, one or more transparent walls 69-1 with different structures, etc. The numeral 71 denotes organisms in the ecological buildings. The numeral 73 denotes a rotating cultivation shelf placed in the ecological building 4. The numeral 73-1 denotes an electrically rotating device. The numeral 74 denotes the pivot point of the rotating shelf. The numeral 71-1 denotes the organisms in the shelf space that may be with different structures. 17-1 denotes a plate for organisms. The numeral 71-2 denotes a plate for cultivation of plants, which functions similarly as the organism box does. 6-1 denotes that the ecological building can be aboveground. The numeral 8-1 denotes that the ecological building can also be underground or partly aboveground and partly underground. The numeral 7-1 denotes the ground. Various types of habitant facilities can be added inside the transparent ecological building that can be in different forms, such as a transparent roof with big areas, and with passages and corridors. The cooperating ecological building 2 is with an awning (cement plate, frame or metallic frame and the combinations thereof can also be used) at the roof. The numerals 78 and 79 denote the open devices (they may or may not be mounted, which may be in different form.). The numeral 81 denotes a water reservoir on the top layer (it may be used as a fish pond or a swimming pool). The water reservoir may also be located anywhere in or out of the buildings, may be underground or aboveground, with the occupied space unlimited. The numeral 80 denotes the plants and organisms that are incubated. Complemented solar power generation devices can be mounted inside the awning frame type transparent room 75, may be mounted in or out of the awning, may be mounted flat, tilt or against the device beside the wall. The numeral 76-1 denotes a transparent glass that is mounted on the layers inside the awning. Sunlight inside awning can pass through the transparent glass 76-1 to the rooms below, which leads to more sunlight in the building. Transparent glass may be broadly used on the layers and frame structures, trapezoids structures, wall structures of the building with unlimited areas. The numeral 76-2 denotes solar power generation devices inside the building which may be mounted in the room, on the layers, and which is used locally for home appliances, illumination, broadcast, etc. The solar power generation devices may be mounted together with the building, or may be mounted by users themselves. They can be mounted inside the rooms, in the sleeping porches, on the walls, etc. Their structures, forms and the materials for power generation and storage may be with different types. The numeral 77 denotes the bottom layer of the ecological building. The numeral 76 denotes the second layer. The numeral 75 denotes the third layer. The number of layers can be decreased. There may be unlimited number of underground layers below the bottom layer, in which there may be water reservoir and organism cultivation place. The cooperating awning type ecological building 2 can be complemented with other buildings as habitant ecological buildings, and can be used as tri-dimension shed for agriculture, which may be aboveground or underground, or with several layers for cultivation of organisms. Methane generating pits, solar power generation devices and other facilities may be mounted there. The structures of the ecological buildings 76 and 77 may be with metallic frames or steel concrete frames and transparent glasses or others.

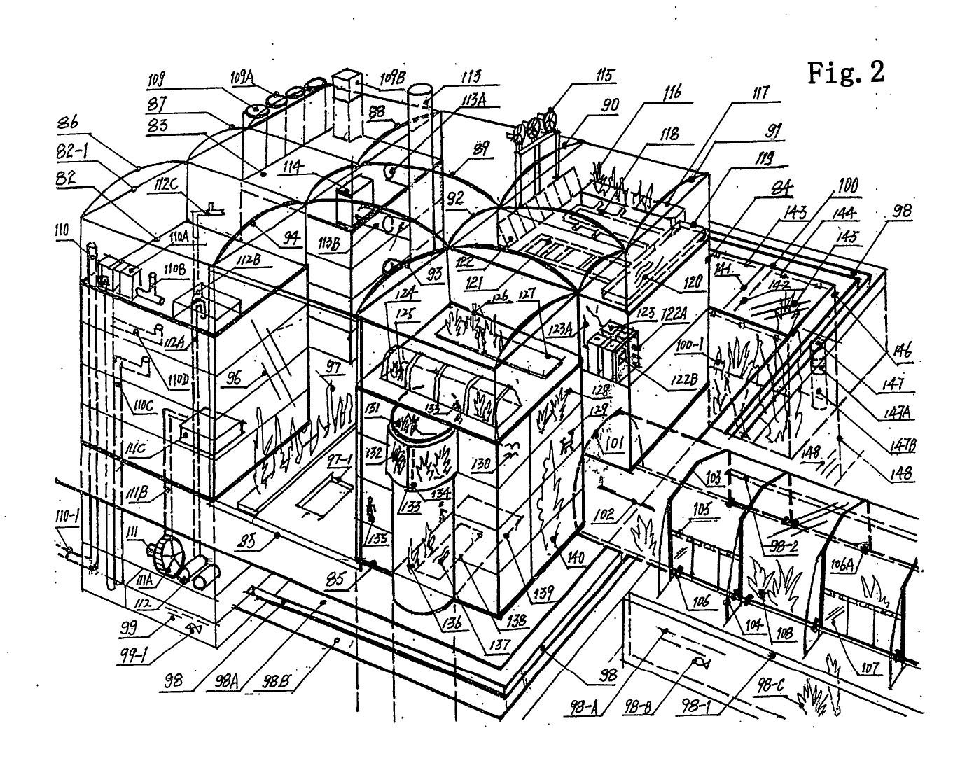

FIG. 2 is a schematic view showing a hood type ecological building with energy, water, gas, pollution engineering. The numeral 82 denotes a tri-dimensional ecological building. The numeral 83 denotes ecological building that is parallel to the building 82. The numeral 84 denotes a diagonal ecological building. The numeral 85 denotes a longitudinal ecological building. The numeral 86 denotes a ecological cover (glass roof) on the ecological building 82. The numeral 82-1 denotes a flat rectangular frame The numeral 86 denotes a bow type ecological cover. The numeral 88 denotes a ecological cover on the ecological building 83. The numeral 90 denotes an additional ecological cover on the diagonal ecological building 84. The numeral 93 denotes a ecological cover on the longitudinal ecological building 85. The parallel ecological building 83, the combined diagonal ecological covers 94 and 89, the combined bow type ecological cover 90, the single ecological cover 91, the coupled ecological cover 92, the single ecological roof 93, the coupled ecological roof 94, and the coupled ecological wall are integrated together, with the result that the buildings 82, 83, 84 and 85 have the space of a new ecological building with glass roofs, and the natural space of a ecological square. The glass (may also be other materials) roof of the buildings may be with different forms and structures, and may be one or two layers, with any profiles and occupied space. Solar and wind power generation devices can also be widely used. The ecological buildings and the ecological covers can be combined together via different method with different structures, and the number and the forms of the buildings may be different. The numeral 96 denotes a transparent glass frame wall, inside which natural plant ecological system environments 97, swimming pool (or organism culture pond) 97-1, and other many habitant environments can be located. The numeral 98 denotes a water channel. The numerals 98A and 98B denote the anti-penetration layers that prevent rain and snow from penetrating underground, which may be made of cements, bricks and with unlimited occupied space. The rain and snow falling at and near the ecological buildings flow into the underground water reservoir 98-A through the water channel 98, thus saving water resources. The water reservoir 98-A has organisms 98-B and plants 98-C for cultivation of fishes. The organisms can purify water better and have biologic productions. They form a biologic chain. The numerals 99 denotes a underground water reservoir of the building, which, as a distinct feature of the ecological building, may be used to contain not only rain and snow, but also contain the polluted water (including the polluted water that has been purified. The figure is not shown) from the building. The water in the reservoir can be used for the building and the nearside plants. The numerals 99-1 denotes organisms in the water reservoir, the water reservoir can be located underground or aboveground, and can be constructed together with the building or as a standalone engineering. The water reservoir may be one or more connected in series or in parallel, in which purifiers can be added. The purified water can be used to irrigate plant and to wash the buildings and vehicles, or to be recycled back to the building for further use. The numeral 100 denotes an underground warm house. The numeral 101 denotes the frame of the warm house. The numeral 104 denotes the support of the frame. This is a very simple structure, while the frame 103 and 104 can be with many different structures. The numeral 105 denotes a folded point for a window. The numeral 106 denotes the bottom wheels mounted below the warm house frames, which make the ecological warm house able to move away. The bottom wheels can move on tracks, ferrous or wooden materials, and planes. The bottom wheels can move all together, or move partly. The numeral 98-2 denotes a water channel. The numeral 108 denotes the organisms in the channel warm house. The numeral 107 denotes glass wall windows. The numeral 106 denotes the bottom wheels for the warm house. The movable ecological warm house can be used I strict environments, such as desert, and with distinct functions, the structures of which should be able to prevent itself from rains and winds. The moveable warm house can be disassembled conveniently. It can combine other buildings to form a small warm house or other ecological buildings. The numeral 109 denotes an air channel on the parallel ecological building 83. The numeral 109A denotes a unitary air channel. The waste air inside the ecological buildings may exchange with the clean air outside through 109. Separated air channels 109A can also be provided to some layers of the ecological building to form several organism spaces, anyone of which will independently exchange air inside with the clean air outside, thus much more sanitary than the unitary air channel system, and much more immune to bacteria. Air cleaners, purifiers can also be added to form a distinct air recycling system. The numeral 113 denotes an air pipe. The numeral 113A denotes an upper connected pipe. The numeral 113B denotes a lower connected pipe. The numeral 114 denotes an air filtering purifier that purifies the air passed through. The numeral 109B denotes a rectangular air channel provided with building structures, which can be in the form of “chimney” in the ecological building. The number, structure, and the profile of the air channel may be different, resulting in a series. The numeral 110 denotes one or more polluted water pipes to drain used water (after washing urinals) out to the bottom of the building, then through the water pipe 110-1 to the polluted water system. The rectangular ecological building 82 may be mainly for habitants, or mainly for cultivation of organisms. For the building mainly for habitants, plants and natural ecological system environment and space are provided in or out of the ecological building for habitants. For the building mainly for cultivation of organisms, organisms (i.e. plants and animals) cultivation environments, such as breeding rooms, plantations, aquatic product rooms, are provided in or out of the ecological building, and the organisms may be incubated by rooms, layers, or the combinations thereof, such as one layer for plants while another layer for animals (ox, sheep and pigs). With this, a positive cycle is established that plants help to incubate the animals, and the animals help to incubate the plants. The layer of the plants greatly purifies the air in the area. Since thermal energy is needed for organism cultivation, polluted water pipe and methane tank (including the devices for ordure dissolution) are combined to form a methane energy system with devices for methane and ordure collector, dissolution, storages. The thermal energy afforded can be used for hot-water heating for the building, for heating water, cooking, power generation and others. It is one of the features that organisms ordure can e used to generate methane for itself. Methane energy system can be applied to the ecological building for cultivation of organisms, such as the ecological buildings mainly for agricultures, farmers, ecological villages, and ecological towns. It can also be applied to all the ecological buildings. The numeral 110A denotes a water purifier. The numeral 110B denotes a polluted water port. The numeral 110C denotes a water pipe. The numeral 110D denotes a parallel water pipe. The new type of polluted water purifier system comprising 110A, 110B, 110C and 110D is used to receive the daily used water for washing (ordure water excluded) or recycled water via the polluted water port 110B to the water purifier 110A where sundries are prevented. And the purified water flows to the underground storage after being purified more, which can be used once more. If enough water purifiers (not shown) are provided in the water path, the daily used water can be purified, stored and recycled back as clean water for further use. The numeral 111 denotes a water wheel power generation device. The numeral 112 denotes a water pump (water supply device). The numeral 111A denotes a water wheel. The numeral 111B denotes a down flow water pipe (pipe type or inclination type). The numeral 111C denotes a water reservoir. The numeral 112A denotes an up flow water pipe. The numeral 112B denotes a water reservoir. The numeral 112C denotes a water supplier that can be used to wash glass roof. Water pump 112 supply water from water reservoirs (or water pipes) to water reservoir 111C, 112B for the building and for cultivation of the organisms. The water supplier system can recycle water through the water path. Water in the reservoir 111C and other backwater pours down to the water wheel 111A through the down flow water pipe 111B or water fall, resulting power generation from the power generation device 111. And the power generated can be used for the building. The system saves energy and generates power from water, which can be applied to natural landscapes and anywhere in the ecological building, thus really good for the habitants to the natures. The numeral 115 denotes a combined small type wind power generation device, which can be applied on the building, underground, inside, outside or anywhere. The numeral 116 denotes the plants on the top layer of the building. The numeral 117 denotes cultivation of plants and organisms, which may be in different forms, such as lying, standing, ladder, inclining, or the combinations thereof. The numeral 118 denotes a flat irrigation device. The numeral 119 denotes a water reservoir. The numeral 120 denotes water. The numeral 121 denotes a flat heating device. Artificial soils, volcanic ashes and other medias for cultivation of organisms can be placed on 118 and 121, where they can be irrigated (irrigation by trickling) automatically. The flat heating device 121 can lie on the ground, or mounted inside the ecological building. The numeral 122 denotes solar power generation devices, the number of which can be varied. These solar power generation devices can be assembled all together or separately from each other. The power generation plates may be coated with a layer, with double layers or with other new type materials. These solar power generation devices can be with different structures, and can be mounted in different sites, such as inside or outside of the building, or inside the underground buildings. The numeral 123 denotes the batteries for the solar power generation devices. The numeral 123A denotes the wires. The numeral 122A denotes the power distribution unit. The numeral 122B denotes the watt-hour meter. 123, 123A, 122A, 122B, 122 and 115, as well as other accessories, form a solar power generation and storage distribution system that can be configured together or separately. The power generation and storage distribution system used for the solar power generation system can be the same as that for the wind power generation system, or can be a separate one from that for the wind power generation system, And the different power generation and storage distribution system can be exchanged between the two systems. It is one of the key features for the ecological buildings, especially for those organism cultivation ecological buildings and those tridimensional agriculture awning type ecological buildings, to have wind power generation systems or solar power generation systems. The numeral 124 denotes a low flower shed, which may be opened or closed, as a solution, to protect plants, organisms with stable temperature and stable humidity. The numeral 125 denotes the plants and organisms inside the flower shed. The numeral 126 denotes the plants and organisms without any shed, which may be flowers, grasses, trees, teas, fruit trees, and other organisms. The numeral 127 denotes plants cultivation structures. The numeral 128 denotes a plant ecological system room inside the ecological building. The numeral 129 denotes an animal cultivation room inside the ecological building. The two ecological system rooms 128 and 129 cab be expanded for times, which can be broadly used in organisms ecological buildings to establish good organisms chain cultivation solutions with fresh air. The chain cultivation solutions, as well as with the air channel purifier system and polluted water purifier and sterilizer that combine a organism epidemic prevention and quarantine system, form a scientific organisms environment. Organism cultivation ecological building can also be integrated with habitant environment and inside ecological building environment. The numeral 130 denotes a ecological space for birds and fowls. The numeral 131 denotes an annular ecological space that can be opened and closed. The numeral 132 denotes a ecological space that can be both inside and outside of the room, which comprises a glass wall that can be opened and closed, a right door 133 that can be opened and closed, a left door window 134 that can be opened and closed. The annular ecological space can be switched from the warm house to the open air when 133 and 134 are opened left and right. The structure can be flat, arranged up and down, left and right, or with other forms. The numeral 135 denotes a room for habitants with different forms, such as an office room, an apartment, a residential house, villages, a villa, a factory, a stadium, and other habitant rooms. The numeral 136 denotes a hall type ecological building. The numeral 138 denotes a pool (swimming pools, water reservoirs, fishponds included). The numeral 137 denotes water. The numeral 139 denotes the hall type room for habitants. The numeral 140 denotes a big plants ecological system, which may also be specially used to produce oxygen that can be transmitted to the habitant environment to make it healthier. The numeral 100 denotes an underground ecological warm house, which may be under a front yard, a backyard, or the peripheries of the ecological building. The numeral 141 denotes a left-opening dormer of the warm house. The numeral 142 denotes a right-opening dormer. The numeral 143 denotes a left movable wheel. The numeral 144 denotes a right movable wheel. The numeral 145 denotes a transparent glass. The numeral 146 denotes an underground building. The numeral 147 denotes a water pipe. Water flows, such as rains, flow into the water storage pipe 98, then flows to the underground water reservoir 148 after being purified via the water pipe 147, thus be ready to be used for the plants and organisms 100-1 inside the underground ecological building. The underground ecological building may be with one or more layers, and may also be semi-underground, with different structures and unlimited size. The underground ecological building can be constructed with habitant environments without occupying space, which is a good solution to utilize space and land best for cultivation of plants and organisms. The number, location, structure and relative forms of the ecological buildings mentioned in this drawing can vary differently in a series. The accessories can be used totally, separately, or in combinations.

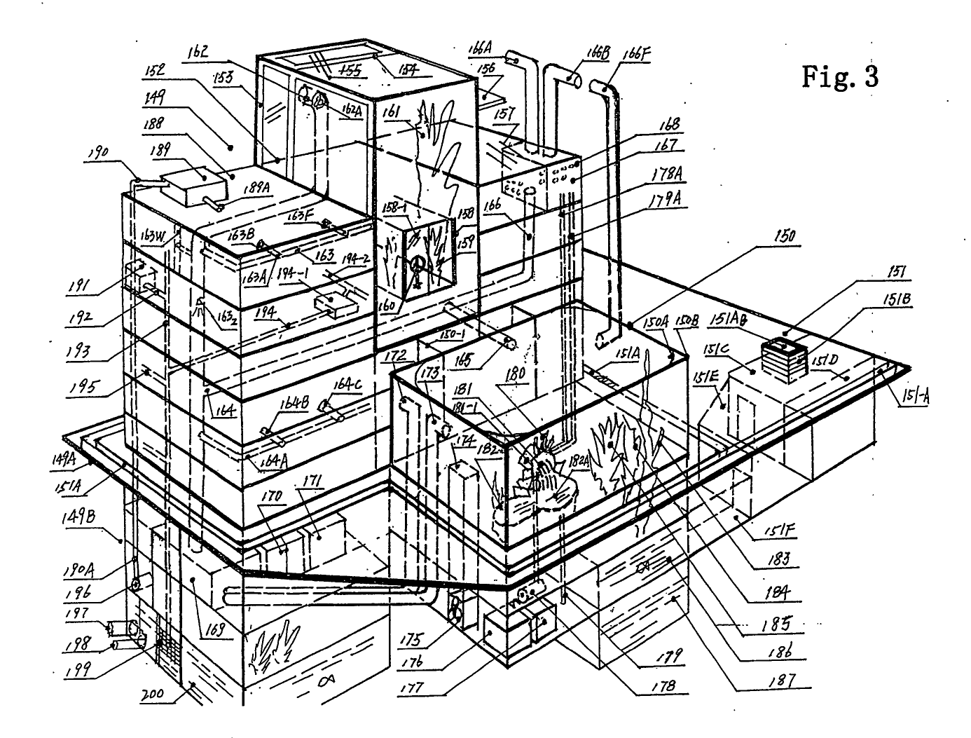

FIG. 3 is a schematic view showing the ecological system environment, oxygen room, and water resource and recycling accessories of a ecological building. The numeral 149 denotes several separate ecological buildings that are combined together. The accessory 150 denotes a tridimensional ecological war house with sunlight, which can be located everywhere inside or outside the buildings and combined with habitant environment, with unlimited size and structures. The numeral 151 denotes devices for water leakages. The numeral 152 denotes a spatial structure of the buildings. The numeral 153 denotes an upright frame structure. The numeral 154 denotes a horizontal structure. The numeral 155 denotes a horizontal structure with additional glasses. The numeral 156 denotes a penthouse structure. The numeral 157 denotes a transparent roof. The numeral 158 denotes a spatial structure with channels in both sides. The numeral 158-1 denotes a glass that can be opened and closed. The numeral 159 denotes a plant ecological system environment. The numeral 160 denotes a built-in wind power generation device. The numeral 161 denotes a bog ecological system environment. The numeral 162 denotes a passage for oxygen transmission, which can be established totally or partly in the buildings. The passage may be a pipe, and may also be connected to the passages located in wall, windows, grounds and roofs. The numeral 162A denotes an air blower located inside the passage. The numeral 163 denotes an oxygen transmission system that is connected with 162. 163A denotes the inlet of the room for oxygen. The numerals 163B and 163F denote a closing device that can be closed automatically when unqualified oxygen is detected. The numeral 164 denotes a passage for transmission of oxygen. The numeral 164A denotes the oxygen network. The numeral 164B denotes the inlet of the room for oxygen. The numeral 164C denotes a closing device. 164B and 164C can be located in all the oxygen rooms in the buildings, with different numbers and structures. The numeral 165 denotes a sub-branch of the passage that connects oxygen and the tridimensional ecological warm house 150 with sunlight. The numeral 166 denotes the inlet and outlet recycling pipes, which is connected with 167. The numeral 167 denotes an air purifier that purifies air in the recycling pipes. The numeral 168 denotes several waterspouts located inside the box, where water is spouted in the form of mists, drips and vapors for purifying, cooling and heating. The numeral 166A denotes an outlet (inlet). The numeral 166B denotes a gas recycle pipe, which may be exposed outside the buildings, or hidden inside the buildings. The numeral 166F denotes a recycle pipe that can be connected with recycle pipe 166B to let oxygen flows transmitted to the tridimensional ecological warm house 150 with sunlight. The oxygen recycling system includes oxygen generation, transmission, recycling and purifying, then transmission again. In the several separate ecological buildings are located various ecological buildings that need oxygen greatly, such as the classroom with oxygen inputs, oxygen room for medical care, residential houses, meeting rooms, thus affords better medical care, improves the environmental quality of the buildings. It is another key feature for the tridimensional ecological buildings to have oxygen rooms and oxygen transmission systems, which can be used totally or partially. The numeral 169 denotes a purifying and detecting device (box) for oxygen, inside which is located oxygen purifier and oxygen detector to assure the quality of oxygen. The numeral 170 denotes a device that can cool oxygen via water, wind, ice and other methods, or heat oxygen via power electrics, water, earth heat and other methods. The numeral 171 denotes a moisture separator that filters humidity from the air into water according to temperature difference principle, and then stores the generated water to the water reservoir. The numeral 172 denotes an oxygen input/output device. The numeral 173 denotes an oxygen transmission network. The numeral 174 denotes a ventilation system that exchange the inside air with the outside air to adjust humidity. The numeral 150-1 denotes a structure that connects the body of the building with 150. The numeral 175 denotes an air blower. The numeral 176 denotes a heating device for the warm house, which may be a boiler, an air conditioner, etc. The numeral 177 denotes a cooling device for the warm house. The heating device 176 and the cooling device 177 can be specially used to control temperatures for tropical rain forest ecological spaces, for frigid zone ecological spaces, for temperate zone ecological spaces. It is another key feature for the ecological spaces of the ecological buildings to have heating devices and cooling devices. The numeral 178 denotes a water supply device (water pump). The numeral 179 denotes back water pipes. This water supply and backwater recycling system can be applied totally, partly, or unitary to the ecological building. The numeral 180 denotes a natural ecological system plant environment. The numeral 181 denotes water flow. The numeral 181-1 denotes a structure for cultivation of plants and organisms, which can be several platforms with different heights, rockery patios, hills and water, walls, multiple systems, mixtures, rooms, fixations, and movements. As a water flow recycling system, it can be applied to water flows, waterfalls and other natural ecological environments. The numeral 182 denotes a water reservoir that can be in different forms, such as a swimming pool, a fishpond, sightseeing or a river. The numeral 182A denotes a water ecological system environment that can be used for cultivation of organisms (including marine animals and plants), which can be located on the top layer, the bottom layer and everywhere in the ecological building, with size and number unlimited. Light fittings, acoustics, fountains, water purifiers can also be added to these water ecological system environments. The numeral 183 denotes the plants incubated semi-underground. The numeral 184 denotes the plants with different heights and different levels. The numeral 185 denotes the plants incubated semi-underground. The numeral 186 denotes the organisms in water. The numeral 187 denotes water reservoir. 186 and 187 can be in one or more unlimited layers. The tridimensional ecological warm house 150 with sunlight can be provided independently, or combined with other ecological buildings, containing different number of devices, with different structures. The numeral 151A denotes moats in the network for water leakages, on which are located leakage water covers. The numeral 150A denotes an annular ecological space, the form of which can be annular, arc and others. The numeral 150B denotes a rectangular form. The numeral 151 denotes a ground device for water leakages. The numeral 151AB denotes the inlet of the network. The numeral 151B denotes filters to purify water. The numeral 151C denotes the second level filters to purify water. The numeral 151D denotes the purifiers located beside. The numeral 151E denotes the output room for purified water. The numeral 151F denotes underground water channels to transmit the purified water to the underground water reservoir. The numeral 151-A denotes the water collecting channels. The numeral 188 denotes the flat top of the stepladder ecological building, which can be with several stepladders. The numeral 189 denotes a water reservoir. The numeral 189A denotes water drain pipes that can be connected everywhere. The numeral 190 denotes the upper water pipe. The numeral 191 denotes the lower water purifier pool (device). The numeral 192 denotes water drainpipes. The numeral 193 denotes water drainpipes. The numeral 163W denotes oxygen channel wall. The numeral 193 denotes drain water network pipes. The numeral 194-1 denotes water spray pool or recycling pool. The numeral 194-2 denotes drain water pipes. The numeral 195 denotes backwater drainpipes system. (The numeral 163Z denotes the ultraviolet sterilizers that are located inside the oxygen channel, which can be used to sterilize the air). The numeral 196 denotes the water supply pump. The numeral 197 denotes the water supplies from outside (including city water, water diversion from pipes, underground rivers, well water), which is necessary for the ecological buildings. The numeral 198 denotes the polluted water drain system, via which the polluted water flows into the water purifier system, where the polluted water is purified to be used for the ecological buildings once more. The numeral 199 denotes the backwater purifier devices, which are used to purify the backwater from the water recycling system. The purified water is stored in the water purifying pool where aquatic plants and organism are incubated to purify water further and to afford aquatic products. Separately combined ecological buildings 149, as well as the water suppliers, and backwater recycling system in the complemented buildings are part of the water resource management and recycling system, which can be exposed outside the buildings, or hidden inside the buildings. The water resource management and recycling system also includes underground water reservoir system, rain and snow storage, sterilization, purifier and second use of the polluted water, etc, with the number and structure of devices unlimited. New type complemented purifying devices can also be added. The ecological buildings in FIG. 3 and the combined ecological buildings can be combined to form a series of ecological buildings with different structures, such as the ecological buildings mainly for habitants, the organisms ecological buildings mainly for plants and organisms, the combinational ecological buildings for habitants, organisms, organisms and ecological system environments.

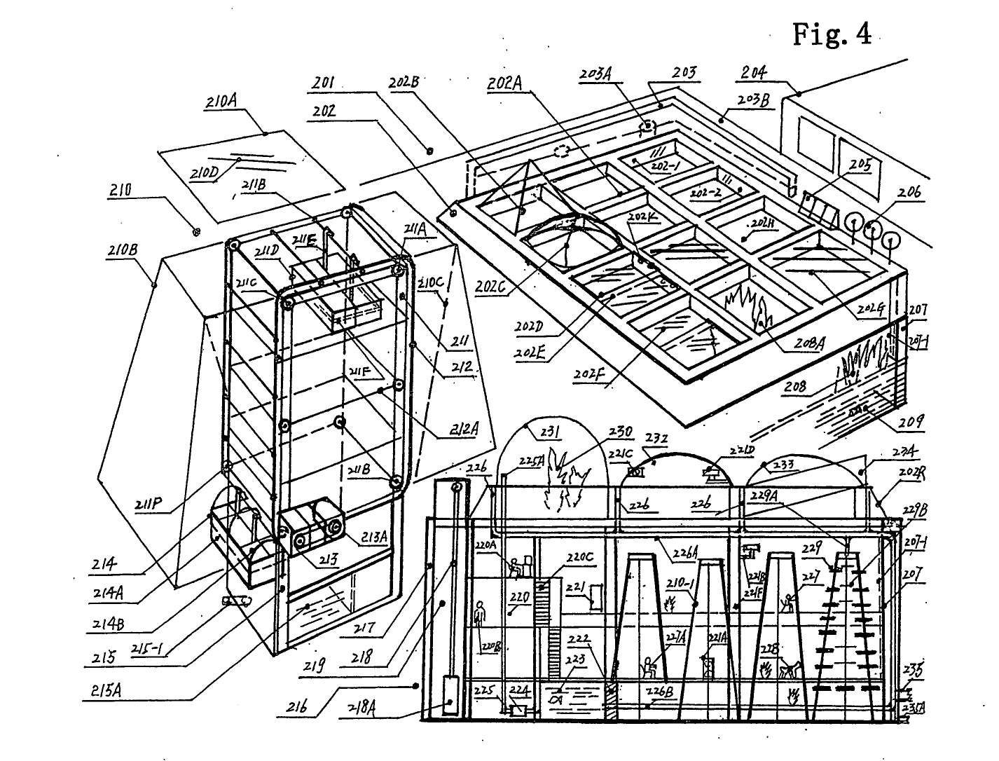

FIG. 4 is a schematic view showing the underground and semi-underground ecological buildings with complemented ecological buildings. The numeral 201 denotes the underground ecological buildings with complemented ecological buildings. The numeral 202 denotes the top cover of the underground warm house, the height of which is unlimited. The top cover can be with different forms, on which platforms, concave convex structures, plants and organism environments, natural landscapes, buildings for habitant, and other structures can be provided. The numeral 202A denotes a frame cover, which may be with steels, steel concretes, timbers, and which can be combined with the ecological system cover 86 in FIG. 2 to form a new type ecological system cover with refraction plates. The numeral 202B denotes a steeple structure. The numeral 202C denotes an arc structure. Other types of structures can also be included. These structures can be combinational type, independent type or the combination thereof with unlimited size. They can be used to transmit light to the underground rooms, to maintain a stable temperature, and others. The numerals 202D and 202E denote left and right movable double layer door window that keep the temperature very stable, which can be applied in frigid zone. The numeral 202F denotes a movable single layer door window, which may be a glass frame that can be opened and closed, in the form of folding, pivots, slides and others. The numeral 202K denotes a rotating wheel. The numeral 202-1 denotes a left mirror device. The numeral 202-2 denotes a right mirror device that reflects light. The numeral 202H denotes a transparent layer (ground glasses, transparent materials and others can be used.). The numeral 202G denotes a double layer glass (or middle-hollow glasses). One, two or more pieces of solar power refraction plates 202-1, 202-2, etc can be located in all the sides of the frame of the frame cover 202A, with the refraction plates fixed or movable (including automatic control), thus to collect direct or reflected sunlight with different orientations, different heights, different angles to the underground buildings for use. It is another key feature of the ecological building to have solar power refraction plate that may be made of glass plates, and other materials with strong refraction abilities, such as paints, refaced papers, metallic plates, plastics, and that may be fixed or movable even by automatic control. The numeral 203 denotes drain water channels to drain rains, snows on the buildings to the water reservoir for cultivation of organisms. The numeral 203A denotes the bell mouths of the moats for purifying. The numeral 203B denotes platforms of the building with different size, which can be used as play grounds, roads and the associated water collecting devices, thus to collect rains from those other buildings to the underground reservoir for cultivation of plants and organisms. It is another key feature to collect rains, snows with water collecting moats and purify water with reservoirs for cultivation of plants and other utilities, which may save a lot of water and keep the balance of the ecological system waters and natural waters. The water reservoirs may be underground or aboveground, which may be integrated with the structure of the ecological building or separated from it. It can connect with other waters, such as rivers and lakes. It can be located on the ecological buildings or on normal buildings for combination use or separate use. The water reservoir can also be used to incubate fish and other aquatic products. The numeral 204 denotes the complemented building. The numeral 205 denotes the complemented solar power generation device. The numeral 206 denotes the wind power generation device. 205 and 206 can be mounted together or separately in the underground ecological building. It is another key feature to mount solar and wind power generation device for the ecological buildings, which save a lot of energy, with the most outstanding feature that everything goes fine when power is turn off. The numeral 207 denotes underground wall. The numeral 207-1 denotes the mirror refraction device of the wall, which can be mounted in the big size wall, and which can amplify illumination effects and expand space effects. The underground ecological building 201 can be in the form of one or more layers, in which several organisms' cultivation structures can be located. The numeral 208 denotes the underground plants structure. The numeral 208A denotes plants. The numeral 209 denotes underground water reservoir or organism pool, the water of which can be used to incubate fishes, irrigate plants. The numeral 210 denotes the frame type tridimensional ecological building accessories. The numerals 210A, 210B, 210C denote that 210 can be expanded vertically. 210 can be with different forms and structures. The numeral 210D denotes that the top cover and the walls that can be made of transparent materials and plastics, glasses. The frame type tridimensional ecological building accessories 210 can be in the form of a structure with walls that can be closed or opened and closed, and can also be in the form of open air structures with few or no closing structure. These structures can be applied in south and tropic areas. The numeral 211 denotes a tridimensional frame (may be steels, cements or the combinations thereof). The numerals 211A, 211C, 211B and 211P denote the pivot points. The numeral 212 denotes the rotating transmission device, which can be in the form of chains, steel frames, and other types of transmission structures. The numeral 212A denotes tridimensional frame layers with less or more layers. Inside the frame 212A, spaces for cultivation of organisms and cultural places for habitants can be located. The numeral 211D denotes the ecological box for cultivation of plants and organisms. The numeral 211E denotes the suspended rod for the box. The ecological box can rotate with the transmission device 212 upward and downward the tridimensional frame 211 when the pivot point 211A and others rotate. The numeral 211F denotes the drain water pipes of the ecological box, which can be connected with other water suppliers, and which can be used to irrigate the plants and organisms inside the ecological box via the drip holes of the pipes 211F. The numeral 213 denotes the rotation controller. The numeral 213A denotes the electric device to drive 213. 213 can bring the rotation transmission device 212 to move, and control the move speed via the speed controller inside 213. The number of the ecological boxes 211D can be less or more, with different forms and structures. The numeral 214 denotes a ecological cultivation box, which is another type of ecological box. The numeral 214A denotes the media for cultivation of plants, which may be soil, sands, volcanic ashes, organism soils, artificial soil particles, etc, which may also be water without soil for cultivation. The numeral 214 denotes the cover of the ecological box, which may be made of transparent materials, such as plastic boards, plastic films, glasses. The numeral 215 denotes the underground frame, which mounts the upright frame and expands spaces for cultivation of underground organisms. The numeral 215-1 denotes water accessories. Water suppliers (rains, snows, river water, city water and recycled water) flow through the device 215-1 into the water reservoir 215A for irrigation of plants and organisms. Water reservoir 215A can be used to incubate fish and other aquatic productions. Water purifiers, upper and lower water devices, methane tanks, solar or wind power generation devices, lifting devices and ladders can also be added. It is a good method to incubate plants and organisms for an upright frame ecological building to have water reservoirs, and the method can be broadly applied to rural areas, patios, factories, schools, institutions, barracks, national defenses, affording habitants with more life and more products. It can be used separately, or combined with others, which may be aboveground, semi-underground or inside the underground ecological building 201. The numeral 216 is a schematic view showing the main functions of the underground ecological building warm house. The numeral 217 denotes the underground warm house wall. The numeral 218 denotes the ropes for the lifting devices. The numeral 218A denotes the electric lifting devices (elevators). The numeral 219 denotes the tridimensional passages (may be inclined passages, or with ladders for habitants). The numeral 220 denotes underground rooms, which may be a big room, partition wall layers, or combinations thereof. The numeral 220A denotes the artificial intelligent automatic detecting and controlling system, which can be used to control the structures of underground ecological buildings and above ground buildings, and also the operating of the automatic securing devices. The numeral 220B denotes the space for habitants, that may be big or small with different occupied spaces, and in which various types of habitant's structures can be located. The numeral 220C denotes the ladders inside it. The numeral 221 denotes air purifiers and dehumidifiers, which removes the moistures in the air to the water reservoir 223 according to the principle of “cooling air”, thus not only the moistures in the air can be removed, but also the vaporized water can be withdrawn, which saves a lot of water resources. The numeral 222 denotes the backwater purifier, which may use sand soils, organism layers to purify water. The numeral 223 denotes a water reservoir, which is only one reservoir while not several pools that connect other waters and form a recycling water purifier network system. The numeral 224 denotes water pumps (water supply devices). The numeral 225 denotes upper water pipes, with which the underground water supply can be transmitted via 225A to every layers of the building. The numeral 226 denotes the backwater channel (groove) that collects rains and polluted waters. The numeral 226A denotes the backwater network. The numeral 210-1 denotes the tridimensional frame type ecological building. The numeral 227 denotes the high level working areas for habitants. The numeral 227A denotes the middle level working areas. The numeral 228 denotes the structure for cultivation of animals and plants. Habitants can work there in a fixed place, and animals 228 can also eat the plants in the ecological box in the cultivation house. This is a new type cultivation method. This cultivation method for animals and plants with products can be widely used in the ecological buildings mainly for cultivation of organisms. The frame type ecological buildings can be upright, horizontal, inclined, and the combinations thereof. The numeral 229 denotes the ecological cultivation box for plants. The numeral 229A denotes the water supply pipes of the upright frame ecological buildings. The numeral 229B denotes water supply distributor. The numeral 230 denotes the aboveground plants. The numeral 231 denotes the aboveground warm house (awning type structure), which may be with one or more layers, and which may be mounted or not mounted. The water from the pipe 225A can be used to wash the warm house awning, and to irrigate the plats. The numeral 232 denotes the semi-underground awning type warm house. The numeral 221C denotes the alerting devices. The numeral 221D denotes the supervisory system. The numeral 221B denotes the displaying devices. The numeral 221A denotes the controlling devices of the frame. All those devices form an intelligent automatic controlling system and network for the ecological building. All those secure controlling networks can be mounted partly or separately with unlimited numbers. The numeral 233 denotes a combined warm house (a big awning). The numeral 234 denotes inclined aboveground devices. The numeral 202R denotes an alternative of 202, which can be with any structures. The numeral 207-1 denotes a wall mirror device with big or small size, which can be mounted separately, and which may be fixed, folded or rotated. The numeral 207 denotes underground walls. The numeral 235 denotes inlet water pipes, which transmit external water supply (including rains, recycled water and river water) to the pipes of the device. The numeral 221F denotes the supporting frame for the underground ecological building, which may be in the form of supports, triangular frames, upright walls, and which may be made of steel frames, upright pillars or steel concretes. The numeral 226 denotes the polluted backwater channel (groove). In the underground ecological buildings, tropic plants and fruits can be incubated, various types of ecological system environments can be located, and plants productions all over the world can be incubated together.

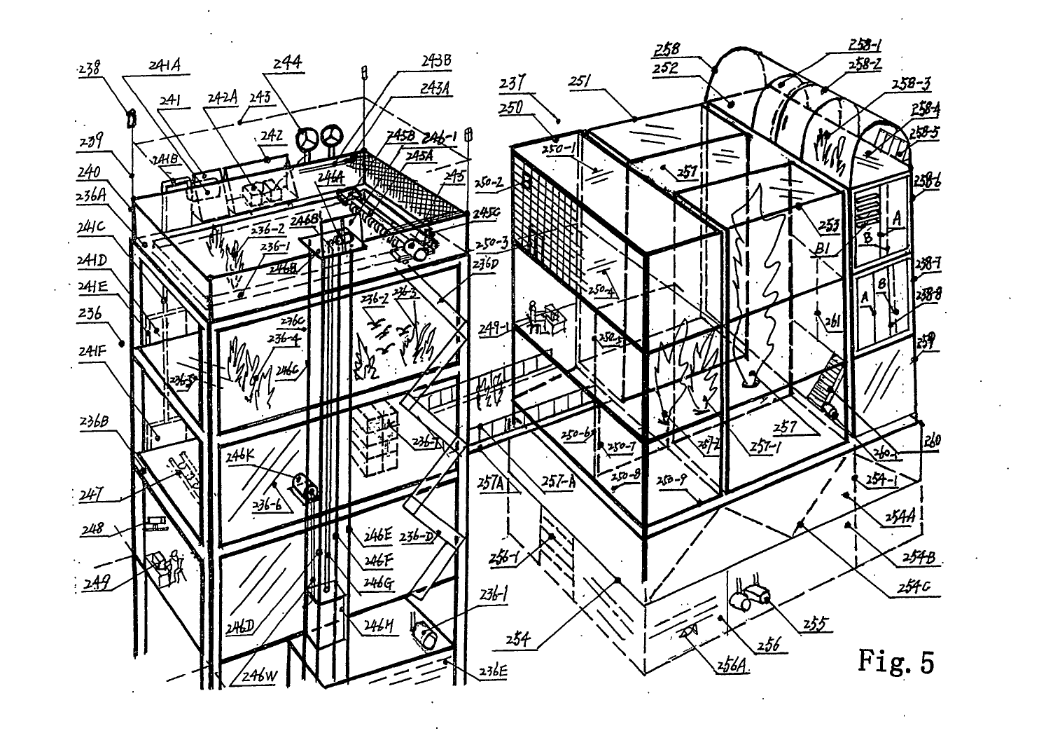

FIG. 5 is a schematic view showing the functions of the tridimensional ecological buildings (frames) for cultivation of organisms. The numeral 236 denotes a frame type tridimensional ecological building, which is an additional tridimensional ecological building under or above the current land. It uses upright pillars to expand the space vertically, which does not affect the usage and cultivation of the current plow land by adding new plow lands and other plants. This type of ecological buildings can be applied to south areas and rural areas where plow lands are scarce. In such cases, more types of plants (such as precious medicinal crops and organisms) can be incubated, which will increase the income for peasants and decrease unemployment ratios, thus to be a new richness resource for peasants. Agricultures need to be transferred to this new type of cultivations for plants, only with this can the problem many-peasants-few-plow-lands be solved, can the sustainable development be maintained. The numeral 237 denotes a combined frame type ecological building, which combines several structures (may be the same structures) of tridimensional ecological system environments together, forms a new type of tridimensional combined ecological building. The numeral 234 denotes marking illumination lights. The numeral 239 denotes the supports (rods) of the illumination lights. The numeral 240 denotes guard bars that protect habitants and organisms on the top layer with security, which may be protective bars, protective networks and others. It is one of the key features that guard bars are mounted on the borders of the area for cultivation of plants and the top areas of the ecological building. The numeral 236 denotes the top flat platform. The numeral 241 denotes solar water heating devices (for heating). The numeral 241A denotes a water tank. Winding water pipes are located inside the solar board layer of the solar water heating devices 241. Solar energy heats the solar board layer and the water in the winding pipes, and the heated water flows between the water tank 241A and the winding pipes to heat the water in the water tank. The heated water is transmitted via drain water pipes 241B and 241C to heating radiators 241D and 241F to supply heat to the ecological building. This type of heating devices may, or may not, be applied to this ecological building and other ecological buildings. The numeral 242 denotes a solar photoelectric board power generation system. The numeral 242A denotes a transformer station. The numeral 244 denotes a wind power generation device. 242A, 244 and 242 can be used together or separately. The numeral 243 denotes guard bar nets. The numeral 243B denotes sliding bars. The numeral 243A denotes window-protecting wire net that can be moved. The numeral 243A is slide mounted on the sliding bars 243B. 243A can be moved in the direction of 243B in rainy and windy days to protect the objects in top layers from being blown away. High yield paddy rice, wheat and other plants 236-2 can be incubated in the soil of the top layer 243A. The numeral 236-1 denotes soil and cultivation structure of organisms, which can be integrated with the structure of top layer 236A, and which can also be an additionally mounted cultivation structure. The tridimensional soil type ecological building may be with one or more layers. Various new types of agriculture devices can be provided in the ground to improve the high production of the tridimensional soils. The numeral 245 denotes a multifunctional electric (oily) agriculture machine. The numeral 245A denotes a multifunctional agriculture device. The numeral 245B denotes a walking control device. 245A can be mounted with agriculture accessories, such as reapers, irrigators, for usage in model agriculture. 245B can work within the top layer soils 236-1 and 236-2 with various agriculture accessories, and can fulfill mechanical cultivation that decreases labor intensity greatly. The numeral 236-3 denotes the plant ecological system layer under the top layer soil 263A, which may originally be soils. The top layer 236A can be fulfilled without affecting the original soil plant ecological system 236-3. Other additional underground layers can also be fulfilled under the soil layer 236-3 which is under the top layer 236A of the unused soils or other spaces, such as roads, houses, rivers, play grounds. The number and the structures of the additional underground layers are not limited, which is the actual results of the multiple-layer tridimensional soils. The tridimensional soil layers can be combined with other cultivation of plants and habitant environments to form an integrate one or integrated ones. The numeral 236-2 denotes the space for birds, which may be closed (or opened and closed) cage spaces environment. The space environment can be used to incubate many birds, especially those scarce and rare birds that need to be protected, and those birds that are needed to maintain the balance of ecological system environment. The birds are freed in necessary to eat the insects (such as grasshoppers) to prevent damages caused by insects. This method is of great help when used for forest plantation and sand control. The numeral 236-4 denotes plants cultivation structures. The numeral 236-5 denotes transparent glass layer, which can be mostly or partly used for the layers of ecological buildings to improve transparence and modern. It can be combined with building structures or cultivation structures such as small separate ecological spaces. Tridimensional soil type ecological building may be with frame structures and glass wall structures (not glass). The numeral 236B denotes another ecological layer. The numeral 247 denotes illumination lights, which may be everywhere in any layers. Ultraviolet lights with sterilizer function and hygiene and disease control systems can also be added in the organism ecological layers. The numeral 248 denotes security and supervisory system, which can be used to supervise all the layers. The numeral 249 denotes computer artificial intelligent automatic control system, which can be used to supervise and control the tridimensional soils in general. The numeral 236-7 denotes artificial nests for birds with different structures, which may be integrated or several separated ones. Tridimensional soil type ecological buildings can also be tridimensional bird type ecological buildings, which may be with simple or complex structures, and which may be made of steel pipes, trees, and which may be with steel frames, steel concretes. The tridimensional cultivation of organisms can be with several structures. Ladders 236D and lifting devices 236C can be afforded for habitants in tridimensional soil type and bird type cultivation of organisms, the heights, structures and locations can be provided different. The numeral 246-1 denotes the solar photoelectric power generation device for this equipment. The numeral 246A denotes the electric devices (electromotor and devices) to move the lifting platform 246H up and down. The numeral 246B denotes the lifting ropes (or chains, steel wire ropes) for the lifting platform 246H. The numeral 246B denotes the top platform for the lifting devices. The numerals 246C, 246D, 246E and 246F denote the tridimensional frames of the lifting devices. The numeral 246K denotes the mechanical kinetic energy generating device that is mounted in the lifting devices 236C. When the lifting devices move up and down, power generation transmission devices accessories 246W move up and down, which make the mechanical kinetic energy generating device 246K generate power. The power generation devices can be applied to electric elevators, manpower electric scaling ladders and subway scaling ladders of the ecological buildings. Power generation devices may also be mounted in elevators and scaling ladders, where the power generation devices are working by elevator and scaling ladders' mechanical energy, and this other type of power generation and power saving device of the ecological buildings. This type of elevators and scaling ladders that mechanically generate powers can be used in ecological buildings, and they can also be widely used as an independent product in subways, business buildings, stations, airport, high buildings, stadiums and others. The elevators and transporting lifting devices that operate on self-generated energy and powers are new types of ecological elevators that generate power themselves. The elevators can be operated normally with the external power suppliers cut off, and the generated power can be combined and connected together with that of solar, wind, water power generating and saving systems, and can also be separately saved and used. The power generating devices that generate power with the operating of elevators, scaling ladders and aerial cableways can be mounted anywhere in the elevators, scaling ladders and other devices with different structures and transmission devices. The power saving devices can be combined together with elevators and scaling ladders, and can also be located in other sites with cables connected to the elevators and other devices that need powers. The numeral 236-1 denotes the water supply device system (pipes are omitted). The numeral 236E denotes the water reservoir, which may be aboveground or underground. The numeral 237 denotes the combined frame ecological devices, which is formed by several similar tridimensional soil type ecological buildings. The numeral 250 denotes a tridimensional single ecological building. The numeral 251 denotes another single ecological building. The numeral 252 denotes a third single tridimensional single ecological building. The numeral 253 denotes a fourth single tridimensional single ecological building. The numeral 254 denotes an underground ecological building. The numeral 255 denotes the underground accessories (water pumps, blower fans, wind blowers, etc.). The numeral 256 denotes underground pools. The numeral 256A denotes water reservoir for organisms. The numeral 256-1 denotes purifiers for polluted water. The numeral 257 denotes high-layer ecological plants spaces. The numerals 257-1 and 257-2 denote the ecological spaces for lower plants. Ecological building frames 250, 251, 252 and 253 form a tridimensional space type ecological building. Plants 257, 257-1 and 257-2 are in a space that is exposed to the open air, and the space can be applied for cultivation of large ecological plants. The space can also be made to be a tridimensional space structure with multiple layers. The numeral 250-1 denotes transparent glass roof of 250, which may be with different structures. The numeral 250-4 denotes the middle layer glass board, which can be with small or big size, and which can be used together with other layer boards that are made of other materials and structures. The numeral 250-2 denotes net type sidewalls, in which birds and other organisms can be incubated. The numeral 250-3 denotes a net door that can be opened and closed. The numerals 250-5 and 250-6 denote the small or big space structures that can be horizontal or vertical inside 150. The numeral 250-7 denotes the partition walls in the space. The numerals 250-8 and 250-9 denote small space structures. The partition walls 250-7 can be with transparent glass structures. The numeral 249-1 denotes supervisory environment for habitants. Residential environments for habitants can also be added. The numeral 257-A denotes hand banisters that are passages for a bridge type ecological building on which plants can be incubated. The numeral 258 denotes the top layer ecological warm house of the single tridimensional ecological building 252. The numerals 258-1 and 258-2 denote the opened and closed structure of the warm house. The numeral 258-3 denotes the plants inside the house. The numeral 258-4 denotes the transparent glass layer. The numeral 258-5 denotes the solar power generating devices mounted inside (outside) the warm house 258, which affords electric power for warm house illumination and electric appliances. It is one of the main features of the ecological buildings to have solar power generation devices inside the warm house awning type ecological buildings. A and B of 259-6 denote a ecological building structure that can be opened and closed. 258-8 of 258-7 and A, B denote a moveable-structured transparent wall with three layers, which can be opened and closed. The numeral 259 denotes an entirely closed glass wall. The numeral 260 denotes an elevator device. The numeral 260-1 denotes a power generation device, which is another mechanical elevator that generates power with dynamic force of elevator 260, which is of the same type of elevator with power generation devices as that of 246K. The numeral 261 denotes that 252 can be divided into various types of rooms. The numeral 254A denotes the first underground layer. The numeral 254B denotes the second underground layer. The numeral 254C denotes that A-frame structures can be used to improve the endurance and strength of the buildings. A combinational frame ecological building denotes a frame ecological building or with tridimensional ground ecological buildings combined to form a tridimensional ecological building, which may be with one or more ecological buildings (or common buildings with ecological buildings) combined with unlimited numbers, forming 237 and other structures. This combinational ecological building may comprise underground devices layers, water reservoir and other ecological devices, or comprise no underground devices. Various types of complemented devices can be mounted in the aboveground devices.

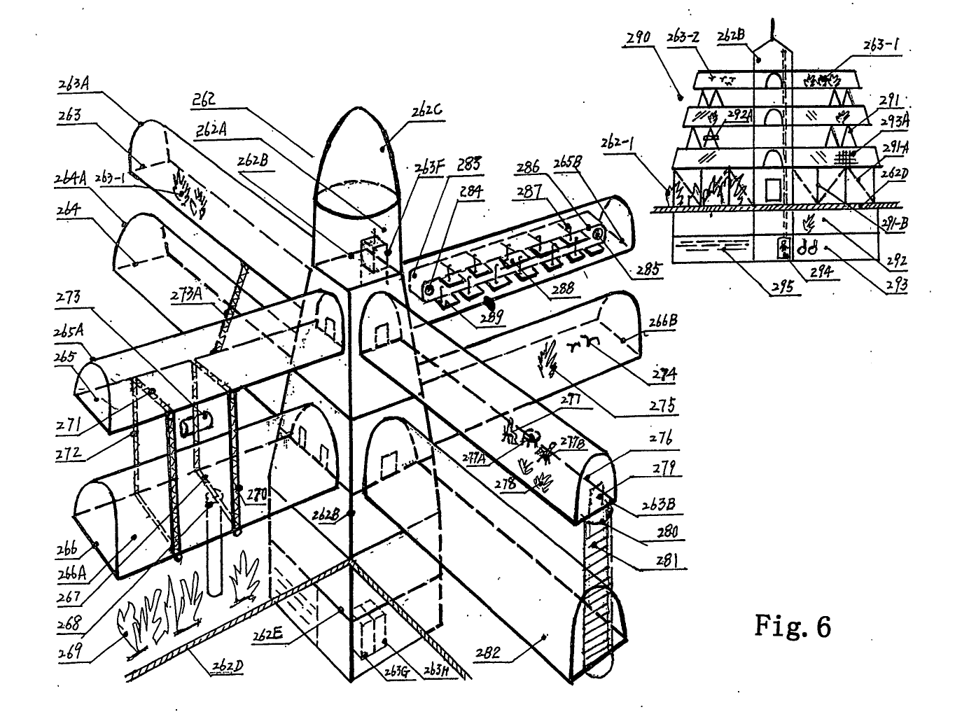

FIG. 6 is a schematic view showing a tree type tridimensional ecological building for organisms. A tree type tridimensional ecological building for organisms occupy least ground areas while expand aerially most to be tridimensional ecological buildings, which comprises one or more tree type tridimensional ecological buildings and tree type ecological warm house. It can be an aerial ecological building network system combined by one or more similar ecological buildings. The aerial ecological system is great helpful to protect natural environment, to expand natural resources for habitants, and to increase the survival space for habitants, which is a new type of survival for habitants to protect themselves from shocks and floods. The numeral 262A of the tree type ecological building 262 denotes a cylinder building. The numeral 262B denotes a rectangular building. The peak 262C denotes an acute bullet building. 262B, 262A and 262 are the tridimensional main buildings of the tree type ecological building, which may be a cylinder, a rectangular, a turret or the combinations thereof with various forms and structures. The numeral 263 denotes the aerial long arm type “layer” ecological building of the connecting structures of main building 262A and 262B, which may be with different structures, the plants inside which generate a lot of oxygen. The numeral 263A denotes an awning type warm house. The numeral 263-1 denotes the plants environment incubated in the long arm ecological building. The numeral 264 denotes a long arm ecological building in the lower layer. The numeral 264A denotes the structure of the awning type warm house that may be in the form of different structures. The numeral 265 denotes an adjacent long arm awning type ecological building. The numeral 265A denotes the awnings. The numeral 266 denotes an adjacent long arm ecological building in the bottom layer. The numeral 266A denotes the structure of the ecological building. The bottom long arm structures 265B, 266B, 263B, 282 are all the aerial long arm ecological structures of the tree type aerial tridimensional ecological buildings, which may be opened and closed, opened, closed or the combinations. It connects with the main body 262B of the tree type ecological building, forming the forms of the tree body and tree branches, occupying least ground space while expanding ecological space aerially, which is a tridimensional ecological science structure, and the ecological environment in the ground can be maintained. The tree type ecological building 262 can also be modified with the ground layer to a big warm house, and may also expand to have several similar ecological buildings connected and an underground ecological building. The numeral 271 denotes the supporting structures of the long arm ecological building. The numeral 272 denotes the supporting post that goes to the ground and goes aerially, which may be a triangular, arcs and other structures. The numeral 267 denotes another supporting structure. The numeral 268 denotes the ground supporting post. The numeral 270 denotes the long arm support. The numeral 273 denotes the outside organism cultivation structure. The numeral 273A denotes the fixed horizontally connecting support of the long arm ecological building 263 and 265, which may be with different forms to increase the horizontal fixing force for the long arm aerial warm house. The structures 268, 267, 270, 272 and 271 are all frame supports that increase fixing force. Various types of frame supports can be added to the long arm warm house supporting systems according to requirements to protect the house from shocks and winds. Thus more protection from shocks can be added to the ecological buildings, and the structures can be more beautiful, thus the beauty and strength of the ecological buildings can be improved. The numeral 273E denotes an underground building with water reservoir and heating device 263G cooling device 263H, aeration and blow devices, and water purifiers, etc. The numeral 263F denotes an elevator device that can move upward and downward in the ecological building, which may be mounted in the main building, or in or out of the long arm ecological building, for habitants and goods. The numeral 283 denotes a long arm organisms streamline mounted inside the long arm warm house, which comprises an axle turn point 283, a symmetric axle turn point 284, a transmission belt device 286, a suspended pawn 287, upward movable organisms plate box 288, downward movable organisms plate box 289, and other components. The transmission belt device 286 is driven by dynamic force (not shown) to turn on the two axle turn points 284 and 285, thus causes the organisms boxes 288, 289 to turn round. Plants and organisms are incubated inside the organism boxes, which need sunshine. Habitants can use the transmission streamline at a fixed place to move the organisms boxes, which greatly reduces labor work, reduces the spaces occupied by the habitants when working, and increases the cultivation of grasses, medical materials and other organisms productions. The devices can also be applied to the passage type ecological buildings and other ecological buildings mentioned above. The numeral 274 denotes the birds incubated in the long arm ecological warm house. The numeral 275 denotes the plants, which means that plants and birds (or other organisms) can be incubated together in the ecological buildings to form the natural ecological system environments for plants and animals. The numeral 277 denotes a habitant environment. The numeral 277A denotes a table. The numeral 277B denotes a seated man. The numeral 278 denotes plants. Thus the aerial long arm building can be in the form of a habitant structure, such as a dining room, a meeting room, a game room, a room for research and development and other habitant rooms, in which plants and other natural environment 278 can be added to be with more life. These plants can also generate a lot of oxygen for habitants. The ecological buildings can be with different structures, and can be used in special environments with air purifiers and solar energy devices, even in spaceports and the Moon, Mars for habitants. The numeral 279 denotes a passage door, through which habitants can go in or out of the ecological building 263B and 282. The ladders 281 can be vertical, inclined, rotating, and automatic inside door, automatic outside door and other building ladder's structures. Besides the several ecological functions mentioned above, the long arm ecological building 282 and other ecological buildings can also be in the form of air passages and others, and can be connected totally or partly with other ecological buildings. The numeral 290 denotes the structure of a tree type tridimensional ecological building. The numeral 263-2 denotes the nests for cultivation of birds that can also fly outside. The numeral 262-1 denotes the ground plants, which can be open to the air naturally, and which can also be a one layer warm house aboveground. The numeral 292A denotes the cultivation boxes on the frame of the building, which may be natural nests for birds. The numeral 295 denotes the underground water reservoir, which is used to store and purify rainwater and snow water. The water reservoir can be mounted underground, aboveground and on any parts of the building, which can be small or big and on the building or out of the building while connected there via water transmission devices. The numeral 294 denotes the device the numeral 263F that is on the bottom of the main body of the building. The numeral 263-1 denotes the plants. The numeral 291 denotes the supporting structure of the building. The numeral 293A denotes a network ecological house that is formed by steel network or other similar materials, which can also be partly network, while the rest is a closed structure or an opened and closed structure. The numeral 291-A denotes the inclined bottom support. The numeral 291-B denotes the upright bottom support. The numeral 262D denotes the ground layer. The numeral 292 denotes the first layer organisms house underground. The numeral 293 denotes the second layer underground space for devices. The tree type tridimensional ecological buildings 262 and 290 can be with less or more structures and functions, with less or more layers, and can be combined with other buildings to form any forms of ecological buildings. It is one of the main features of the present ecological buildings to have the ecological warm house expanded to the air.

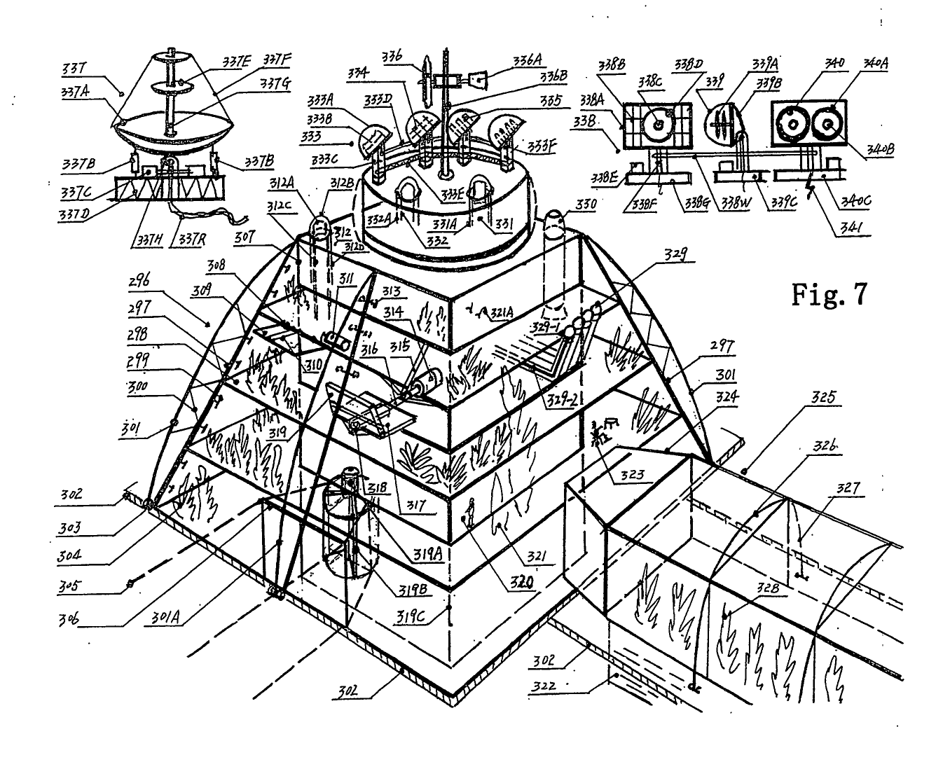

FIG. 7 is a schematic view showing a turret ecological building and the accessory photoelectric devices and energy devices. The numeral 296 denotes a turret frame type combined ecological buildings, comprising the interior upright ecological building 307 and the exterior arc glass frame bracket ecological building 301. The interior and exterior ecological building can be with different forms and structures. The numeral 297 denotes an inclined frame type ecological building of the turret frame type combined ecological buildings, which is like pyramids in structures. The numeral 298 denotes a trapezoid plane ecological building, which may be used to construct a series of ecological buildings in structures. The numeral 299 denotes a glass-assemblies structure that uses regular ad irregular glasses. The numeral 300 denotes an enforced rib. The numerals 301 and 301A denote arc wall frame type arc brackets, enforcing the glass wall frame ecological building. The numeral 302 denotes the ground layer. The numeral 303 denotes the movable assembly structures. The numeral 304 denotes the ground plants. Plants and organisms can also be incubated in other space layers. The dashed line 305 denotes the channel awning type ecological building on the ecological building. The numeral 306 denotes the door of the ecological building. The numeral 307 denotes the interior upright combined ecological building.

Many refractive/reflective devices and solar energy devices are mounted on the ecological buildings, which are the energy-saving devices to convert solar power to electric power for the ecological buildings. The numeral 308 denotes the joints of the refractive plates. The numeral 309 denotes the refractive devices. The numeral 310 denotes the interface surfaces of the refractive plate or the cragged surfaces and the window blinds. The refractive plate that moves with the joints can be in the form of a floor or other structures, which can be made of glass plates, mirror plates, electroplate plates, plastic plates, solar power photoelectric cell plates, or other combinations of materials, and which can be made a refractive plate in the form of blind windows. It has the functions of refracting sunlight and solar power generating, which refracts sunlight as a functional appliance, and which functions as a refractive solar power generating device. The movable joint 308 can be used to mount the functional appliance on the balcony, doors, windows, and other sites of the building. The functional plate that refracts sunlight and generates solar power can be in the form of a refractive or fixed door or window mounted on the building. The numeral 311 denotes a complemented electro-dynamic (or manual) device of the refractive functional plate, which may be a solar power storage device. The solar power generating plate and the solar power storage device compose the solar power generation system, which can be used for a single house, a single layer, or be connected with the global solar power storage system of the building. The numeral 312 denotes a light transmitting and refractive device. The numeral 312A denotes a self-controlled refractive device that moves in the direction of sun light, which refracts sun light to the inner part of the light transmitting device. The numeral 312B denotes the transparent cover of the refractive device. The numeral 312C denotes the inner transmitting layer of the refractive device, which may be made of materials that transmit sunlight effectively, such as mirror materials, electroplate materials, or coating layer materials. The numeral 312D denotes the cover of the refractive. Sunlight travels through the transparent cover on the self-controlled refractive plate, where it is transmitted through the transmitting layer and refracted by the refractive plate to the inner part of the building, thus saving a lot of power sources. The numeral 313 denotes a glass assembly device. The combined upright ecological building may be a frame structure without glass walls, partly or totally with glass walls covers. The numeral 314 denotes an electrically self-controlled refractive solar power device, which comprises solar power storage device. The numeral 315 denotes a mounting support structure (device). The numeral 316 denotes a refractive pipe structure used to mount solar power generation devices. The numeral 317 denotes the solar power generation plate or reflective device on the refractive pipe structure. The numeral 318 denotes the pivot structure devices for rotating 317. The numeral 319 denotes the foldable reflective plate and solar power generation device that can be folded with 317. 319 may be made of glass mirrors, solar power photoelectric plates, or other materials with different refractive ability, which may be both refractive and power generating. The refractive plates of 317 and 319 may be flat or bumpy, may be in the form of window blinds that are upright, lying down, or falling to the ground. The numeral 309 denotes the single-plate or double-plate refractive solar power devices. 314 may be transmitted or mounted with different methods, such as horizontally mounted, lying down, vertically mounted, inclined mounted and others. The double-plate refractive plate 314 may also be replaced with others with three-plate folded plates that can be opened and closed. The numeral 319A denotes a power generation device that generates power with the rotating force of the rotating door 319B. When habitants go in or out of the building, the door or window 319B will be rotated with the rotation force being used to generate power. It is a new type of power saving device, which generates power for appliances. It is another feature of the ecological buildings to have an electric door (or manually driven) with power generation devices. It can be applied not only to ecological buildings, but also to all other buildings, which may be a new type of power-saving mechanical power generation device. The rotating door that generates power itself can also be made as an independent product. The numeral 319C denotes underground devices, which may be or not contained in the combined ecological buildings. The numeral 320 denotes the space for habitants. The numeral 321 denotes the plants in the plant ecological space. The numeral 321A denotes the space for organisms. The space environments 320, 321, 321A can be combined mostly, as well as with water recycling systems to compose natural ecological systems, tropic forests, hills and water, fishes and other series of natural landscapes. The size of the habitant environments, organism environments is unlimited, which may mainly focus on habitant environments, or on organism environments, or the combination of both habitant environments and ecological system buildings. The numeral 322 denotes the underground water reservoir (It may also be a semi-underground water reservoir or an aboveground pool). The numeral 323 denotes a ladder form up-down ecological layer building for habitants. This type of structures can be used partly or totally on the ecological buildings. The numeral 324 denotes a convex door of the building. The numeral 325 denotes a channel awning type ecological building. The numeral 326 denotes an arch (or arc) frame structure. The numeral 327 denotes a sunlight channel frame that may be teardown, simple or luxury. The numeral 329-1 denotes the sunlight receiver points. The numeral 329-2 denotes the sunlight transmitting bodies. The sunlight received by the receiver points will be transmitted to all the desired sites in the buildings by the sunlight transmitting bodies 392-2, thus to be used for illumination, for plants and organisms. The sunlight receiver points 329 may be empty shells or real entities, inside which there are various kinds of optics accessories and structures mounted, such as sunlight transmitting devices, sunlight amplifiers, sunlight focusing devices, etc. The sunlight transmitting bodies 392-2 may use various kinds of materials and structures, such as optic fibers, micro millimeter sunlight transmitting materials, and optic cables. The numeral 330 denotes an upright single sunlight-transmitting device, inside which there are various kinds of sunlight transmitting devices and structures mounted. The numeral 331 denotes an empty sunlight-transmitting device. The numeral 331A denotes the shell, inside which there may be mounted with refractive and transmitting devices. The numeral 332 denotes the entity sunlight transmitting devices. The numeral 322 denotes the shell. This structure can also be independently used, with the structure body adding (or removing) some other type of sunlight transmitting devices. The numeral 333 denotes a self-controlled sunlight transmitting device support, which is another form of the refractive and transmitting device system. The numeral 333A denotes the cover that receives sunlight. The numeral 333B denotes the sunlight receivers and transmitting devices. The numeral 333C denotes the vertical supports (may also be horizontal supports or the combinations thereof). The self-controlled sunlight transmitting device support can be independently used, or connected with the structures 333D, 333E and the sunlight refractive and transmitting device systems 334, 335 and 333F to form a connected reciprocal system. Photosensitive switches, actuating devices, and other self-controlled sunlight pursuing appliances, structures and systems may also be mounted on the device to improve the efficiencies for receiving sunlight and for transmitting sunlight. The numeral 330D denotes the reciprocally connected devices. The numeral 333E denotes reciprocal structures. The numeral 334 denotes the reflecting sunlight sensor device that focuses sunlight. The numeral 335 denotes a rod type sunlight receiver device. The numeral 336 denotes wind power generation device. The numeral 336A denotes tail wind leaf. The numeral 336B denotes the vertical rod of the wind power generation device. The wind power generation device 336 may be in the form of a single one, or several connected power generation devices. The device may be underground, on the buildings, and may also be integrated with other functional devices (such as sunlight transmitting devices, solar power generation devices) for use. It is another feature of the ecological buildings to comprise solar refractive and transmitting plates, solar power generation devices, wind power generation devices, and others, with the functions and device numbers variable. The numeral 337 denotes a device that contains conveniently the dischargeable lying sunlight transmission and reflective device. The numeral 337A denotes the support for the sunlight reflective plate, on which there may be glass mirrors and other reflective materials. The numeral 337B denotes an actuating device that adjusts the degree of the direct sunlight on 337A. The numeral 337C denotes a light-sensitive self-actuating device, the accessories of which goes with the reflective plate support, thus goes with the direct sunlight. The numeral 337D denotes a mounting structure. The numeral 337H denotes the pivot structure for the reflective sunlight. The numeral 337R denotes the sunlight transmission body. The numeral 337E denotes an amplifying focusing mirror. The numeral 337F denotes the sunlight receiver cover. The numeral 337G denotes the upright rod that transmit sunlight. The various components of the lying sunlight transmission and reflective device 337 may be with different structures, which may be vertical, lying, or the combinations. It can be aboveground everywhere, and can also underground or on the ground. The numeral 338 denotes the front view effect of a reciprocally connected sunlight-transmitting device. The numeral 338A denotes the front view of a long sunlight-receiving plate. The numeral 338B denotes the solar power photoelectric plate mounted on the long sunlight-receiving plate. The numeral 338C denotes a structure that receives and transmits sunlight. The numeral 338D denotes a sunlight receiver and condenser that is mounted on the 38C in the current century. The numeral 339 denotes the sunlight condenser effect of the side view of the 338D. The numeral 339A denotes a sunlight plate. The numeral 339B denotes a sunlight reflective chassis. The numeral 340 denotes a sunlight condenser cover with two bodies, the sunlight transmit device of which may be with multiple sunlight condenser covers that transmit sunlight. The numeral 340A denotes another sunlight condenser and transmitter cover. The numeral 340B denotes a rod that transmits sunlight. The numeral 341 denotes a body that transmits sunlight (it may be optical cables or other materials and structures). The numeral 340C denotes the base frame. The numeral 338E denotes a self-controller that controls 38A to rotate with its direction changed. The numeral 338F denotes an axial rod wire. The numeral 338G denotes a base frame. The numeral 338W denotes the reciprocally connected rod that rotate 38A, 339, 340. The sunlight transmitting devices can be with different structures in a series of products. They can be applied not only to ecological buildings, but also to common buildings such as residential houses. The various combined buildings, various sunlight refractive and transmitting devices, various solar power generation devices, self-rotating doors and others of the turret frame combined ecological buildings can be with other structures or combined structures, can be with more or less numbers mounted on the buildings, can be used independently, reciprocally, partly, and can also be used separately in small buildings, such as residential houses.

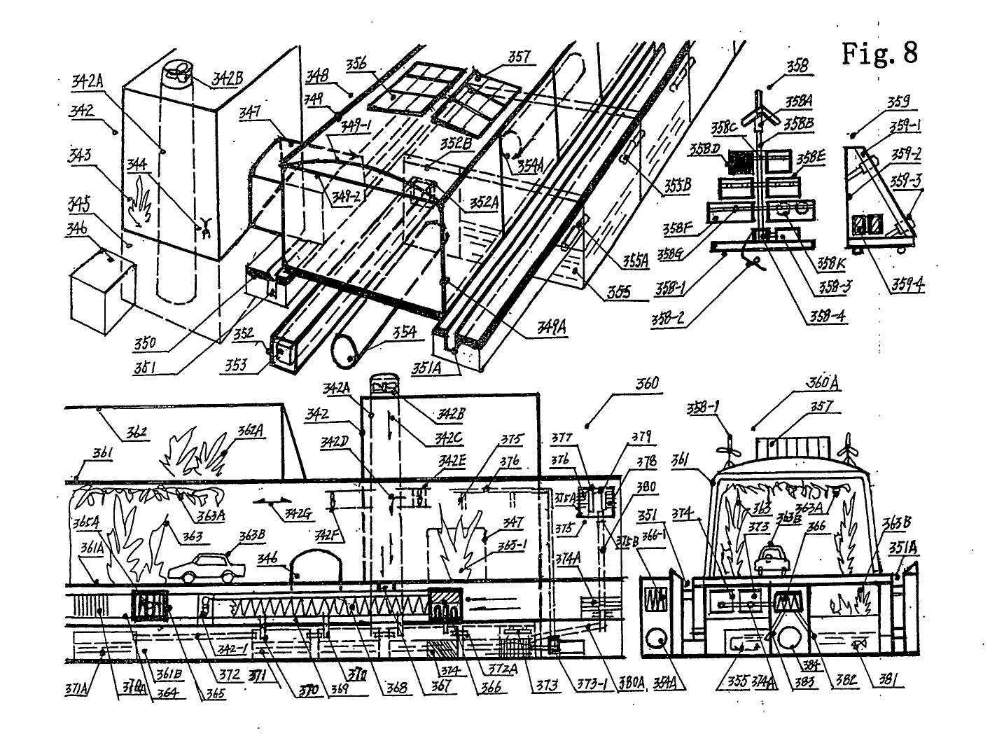

FIG. 8 is a schematic view showing combined passage type ecological buildings with air, water purifiers and supplier network systems. They comprise passage type ecological buildings 348, 347, 342 and the complemented accessories, such as passages for hot air, passages for cool water, passages (pipes, pools) for supplying water, passage 350, 351 for collecting rains, water reservoir 355, ecological buildings and complemented solar power generation devices. The numeral 342 denotes combined ecological buildings for organisms, comprising the tridimensional building 343 for cultivation of plants, the tridimensional building 344 for cultivation of animals, or the combinations of both 344, 343 in different layers. Feces from animals flow into the methane tank 346 via the downward water pipes, where many methane gases are produced for heating of the ecological buildings and passage type ecological buildings. The buildings may be heated by combustion of methane gases, or by combustion of methane gases on alleges. It is another feature of the present ecological buildings to use methane gases for heating. The numeral 342A denotes an air passage structure inside or outside of ecological buildings, which may be in the form of a vertical rod like a chimney, or other forms. The numeral 342B denotes the inlet/outlet air fans (or wind power generation devices) located in the ports of the air channels or inside the air channels. They are used to afford natural environments for plants and animals globally or partly in the ecological buildings. For the ecological buildings with tridimensional cultivations, circular buildings and other combined ecological buildings, they may be with long air passages, which may be made as metallic frames, frames, steel concrete frames and others structures. The numeral 350 denotes the ground, which may also be cement ground or waterproof ground made of bricks. The numeral 351 denotes the channel for discharging water. Rains on the ground 350 flows into the channel 351, 351A, then, after being purified by water purifiers, flow into the underground water reservoir for the plants incubated in the passage type ecological buildings. The numeral 352 denotes a heating passage. The numeral 353 denotes a cooling passage. Airs flows into the heating passage 352 via air passage, where the water in the air is heated to being vaporized, then the heated air flows into the cooling passage 353, where vaporized water in the heated air condenses into water in the cooling devices and flows into the water reservoir out of the passage for recycling usage, thus saving a lot of water. It is scientific to make water in case that water is extremely scarce with air passage 342A, where the humidity are absorbed into the heating and cooling passage where water is filtered. The heating/cooling passage for filtering water can be with different structures, such as passages, air rooms, frames, and the combinations. They can filter not only the underground water, aboveground water and water in the air, but also the humidity inside the ecological buildings. It is another feature for the ecological buildings to have heating/cooling devices for filtering water, which can be used in residential houses, villas so that they are water-saving (or self water-making) type ecological buildings. The numerals 354, 354A denote the passages for inlet water. The numeral 355 denotes the water reservoir. The numeral 355A denotes a water pipe. The numeral 355B denotes another water pipe that connects two water reservoirs that are adjacent or distant from each other. It is a special water reservoir and water supplier system that one or more water reservoirs connected with water pipes. Marine organisms can be incubated in the water reservoirs; one or more water purifiers can be added. This type of water suppliers can be applied to the districts where water resources are scarce, such as deserts. The heating/cooling passage the numeral 352A connects with the lying heating/cooling passage 352B. The numeral 356 denotes the tiled solar power generation device of the passage type ecological buildings. The numeral 357 denotes the inclined solar power generation device. It is another feature for the passage type ecological buildings to have solar power generation devices. The generated power sources can be stored and used for illumination and appliances. The solar power generation devices may be lying, upright, or rotating and other structures. The numeral 358 denotes upright solar power generation devices with multiple functions. The numeral 358A denotes a wind power generation device. The numeral 368B denotes an upright rod frame. 258C denotes a horizontal rod frame. The numerals 358D and 358E denote the solar power photoelectric plates mounted on the horizontal rod 358C. The numeral 358E denotes a solar power photoelectric plate that can be adjusted with its inclined degree. The numeral 358-1 denotes the base frame. The numeral 358-2 denotes the transmission lines. The numeral 358-4 denotes the device that rotates the upright rod 358B. The numeral 358-3 denotes an electric device. The numeral 358K denotes the sunlight transmitting cover device that is mounted on the solar power generation device. Besides solar power generation, the upright solar power generation devices 358 with multiple functions can also be provided with the multiple functions of the wind power generation 358A and solar power sunlight transmitting device 358K, with functions added or deleted, structures varied, thus forming a series of products. The numeral 359 denotes a desktop type solar power generation and sunlight-transmitting device. The numeral 359-1 denotes the solar power photoelectric plate structures. The numeral 359-2 denotes the inclined frame. The numeral 359-3 denotes sunlight transmitting cover (Others are omitted). The numeral 359-4 denotes the solar power storage batteries, where electric power can be converted by transformers and distributors and transmitted to the appliances. The numeral 360 denotes the side view effect of the combined passage ecological buildings. The numeral 360A denotes the front view effect of the combined passage ecological buildings. The numeral 361 denotes the passage type ecological buildings. The numeral 362 denotes that more layers can be added globally or partly above the passage type ecological buildings 361. The numeral 362A denotes the plant ecological system environment in the layer, and habitant environment can also be added. The numeral 363 denotes the plant ecological system environment inside the passage type ecological buildings. The numeral 363A denotes a suspended plant environment, such as grape frame. The numeral 363B denotes the non-contaminated electric car inside the passage, which can be used for transferring habitants. The numeral 364 denotes the underground (aboveground) heating/cooling air passage for filtering water. The numeral 365 denotes the passage cooling system that uses water-cooling, wind cooling, ground cooling (ice layers), etc. The numeral 366 denotes the heating system for cooling/heating passages, which may be long, frame, duct channel and other structures. The heating sources may be methane gases, electric power, ground heating, wind heating, water heating, solar heating and others. The numeral 376 denotes the outlet of the air passage. Airs 342 flow into the cooling/heating air passage for filtering water via the passages outlets 342B, 342F, 342E, etc, where humidity of the air are filtered and left in the cooling/heating air passage as water and flows into the water reservoir. And the air with less humidity is discharged into other rooms in the buildings or out of the buildings. The numerals 342F, 342E, 342-1 denote the ventilating fans that are located inside the air passages and the cooling/heating air passage for filtering water, and the fans can rotate co rotational or reversals. Wind power generation device 342-1 can also be mounted inside the passages, where the wind in the passage drives the power generation device to generate power. The numeral 368 denotes the accessories of the heating devices in the air passage, which may be a windpipe for heat radiation, an air channel wall and other structures. The numeral 369 denotes passage walls. The numeral 370 denotes water-recycling system. The water from the cooling/heating air passages for filtering water flows into the water reservoir via the water recycling system. 371 and 371A indicate the water reservoir, which may be made of various materials, such as stainless steels, steel concretes, etc, with various structures, such as pool, box, underground river and other structures. The numeral 372 denotes the pipes for discharging water, which are the reciprocally connected network system of the water in the water reservoirs. The numeral 361 denotes the underground devices. The numeral 364 denotes the underground (or aboveground) cooling/heating air passages for filtering water, which may be in different forms. The numeral 370A denotes the cooling devices in the cooling/heating air passages, which may be hollow cooling air (water) pipes. The humidity in the hot water can be condensed on the cooling water pipes or the similar structures, and then flows into the water receivers. The air passage can be cooled with water, wind, ice or ground (freezing soil, ice layer, etc.). The cooling air passages can be integrated with the heating air passages, or located with the heating structures one after another in several segments. The cooling air passages may be with different structures and different materials. The numeral 365 denotes a frame type air passages cooling devices, which may be in the form of the refrigerators in residential houses for ecological buildings and normal buildings. The numeral 371 denotes water reservoirs. The numeral 361A denotes the ground. The numeral 365A denotes the cooling structures of the refrigerating device for filtering water, which may be with different forms. The numeral 346 denotes the complemented methane gases system of the combined passage type ecological buildings 342 and 360. It is one of the key features for the ecological buildings and organisms awning type ecological buildings to have methane gases made from habitants' and organisms' feces for water heating, hot gas heating and others in the ecological buildings (including the agriculture ecological awnings for organisms). The numeral 374 denotes the purifier device for water and air system, which is the sanitation system for the water resources of the underground water and the purifier for the air in the air passages. The numeral 373 denotes the ultraviolet light sanitizer and purifier device for polluted water (air), which is a component of the sanitation system of the ecological buildings. The device can be used multiple times in the ecological building with different structures. Sanitization can be implemented by ultraviolet light, or by an oxygen atom generator where water and other objects are electrolyzed from molecules to ions, thus the bacteria and wastes are oxidized and decomposed, killing bacteria strongly and sanitizing greatly, or by sunlight, by electric heating, by chemists and medicines or the combinations. It is one other feature for the ecological buildings to have sanitation systems inside the air passages and water systems of the ecological buildings. The sanitation devices can be located in or out of the ecological buildings, such as in or out of the wall, windows, rooms, public roads, pipes and other structures, with different structures and unlimited numbers. The numeral 373-1 denotes a water supplier device. The numeral 376 denotes the water pipes. The numeral 375 denotes the water outlets. The water supplier system comprises also other devices, such as water spout device, thus form the desired water supplier system according to the requirements. The numeral 375 denotes a desiccation device for filtering water from cooling/heating water, which is another combination of the cooling/heating desiccation device of the cooling/heating air passages 352, 353, 366, 365, 370A, 368, 367, etc for filtering water, which may be like a refrigerator, a washing machine, an air conditioner that can be widely used in residential houses. The desiccation device comprise the frame body 375, the air inlet 376, air heating device 377, air cooling desiccation device 379 for filtering water, the air outlet 378, the water outlet 375B, water pipes and water reservoirs 380, 380A. Water flows into the water reservoir via the horizontal pipes, vertical pipes, and inclined pipes, saving a lot of water resources. The devices need to be widely used in the ecological buildings in tropic forest and in the ecological buildings for cultivation of plants with more humidity in the air, so that water can be reused, saving a lot of water resources. It is another obvious feature for the ecological buildings to use such a device. The numeral 360A denotes the front view effect of the combined passage ecological buildings. The numeral 358-1 denotes the wind power generation devices that may be located upper/lower inside/outside the ecological buildings. The numeral 357 denotes the solar power generation device. The numeral 361 denotes the passage type ecological buildings. The numeral 363 denotes the incubated plant environment. The numeral 363A denotes a frame type plant environment. The numeral 363B denotes the habitant environment. The numeral 373 denotes the ultraviolet light sanitizer and purifier device for polluted water (air). The numeral 374 denotes the purifier device for water and air system. The numeral 374A denotes the water networks. The numeral 355 denotes the water reservoirs. The numeral 351 denotes the water pipes. The numeral 366-1 denotes the cooling/heating water-filtering device that is mounted out of the passage type ecological buildings. The numeral 354A denotes the inlet water passages mounted out of the ecological buildings. The numeral 366 denotes the cooling/heating water-filtering device that is mounted in the buildings. The numerals 382 and 383 denote the water pipes. The numeral 384 denotes the water pipes from water resources. The numeral 363B denotes the underground ecological plants. The numeral 381 denotes the underground ecological buildings fro-aquatic organisms. The structures of the combined passage type ecological buildings 342, 348, 346, 360a and the cooperating accessories can be with different structures and more or less devices. The passage type ecological buildings 348 can be connected with more tridimensional ecological buildings 342, 374 to form combined ecological buildings with long distances and more areas, which is good for habitants in sterile areas, such as deserts. Ecological system environment can be established effectively, which is prominent to recover the local ecological system environment. The combined passage type ecological buildings can also be applied to cities, affording habitants with natural ecological environments for activities, recreations, meetings and others, which are necessarily needed, and which improves our life qualities.

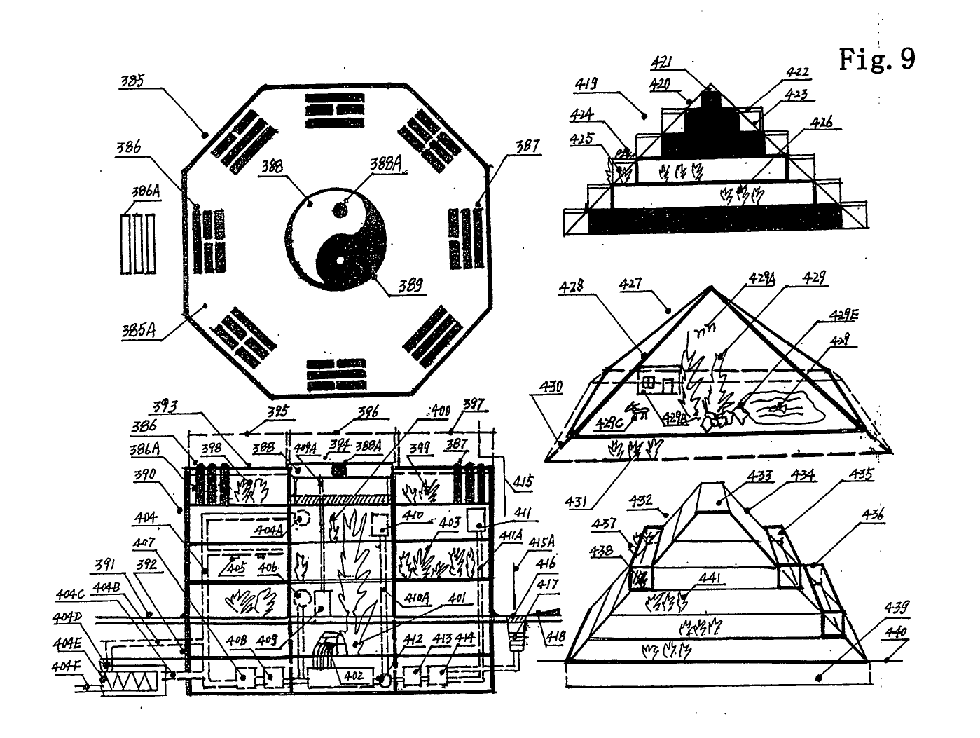

FIG. 9 is a schematic view showing combined functional ecological buildings and Taiji type ecological buildings. A YiXue type ecological building is established by using Taiji and medicine principles. Yixue is a systematic theory, which is specified by ancient people with cosmic view as a philosophy that sky, ground, and habitants are a large system that comprises everything. This type of the ecological building not only expands Chinese's philosophy, but also influences the development of the science. Tridimensional ecological buildings are the new mechanism for habitants to develop continuously, thus to establish the desired the scientific system that harmonizes heaven, ground and people. Yixue principles are incorporated into the ecological buildings to make Yixue ecological buildings, which are more helpful to people's continuous development. Yixue principles are not used for augury, but for the research of the rules in the Yixue's system, which will be helpful for the continuous development of people. Thus, Yixue's ecological buildings are helpful for habitants to protect natural environment and to get more material resources. The numeral 385 denotes the top view of the ecological buildings according to Taiji theory. The numerals 386 and 387 denote two of the eight Guaxiangs, which derive from Yaoxiang. In microcosmic, 386 and 387 are Guaxiang, yet they have special functions according to Yixue theory, that is, in microcosmic, The numerals 386 and 387 denote the warm house awning type ecological buildings or other ecological buildings (For example, solar power light transmitting device or solar power generation device). The numerals 388 and 389 denote the yin yang fish-like images. The eye 388A of the yang fish and the eye of the yin fish can be made with light transmitting bodies or light transmitting devices. 388 and 389 can be made with different color and different materials, which may be a rotating disc or a fixed building. The numeral 385A denotes the top surface of the buildings, which may be transparent or opaque. The Taiji ecological buildings 385 may occupy much more spaces, and the awning type ecological buildings Guaxiang 386 and 387 may occupy more areas accordingly, which will show vitality, especially in moor areas and deserts. Guaxiang 386 and other of the 64 Guangxiang may form rectangles or other different forms in 385. Guaxiang 386 may also form out of the top surface of the buildings different tridimensional ecological building Gua, such as 386A, which may be circular, rectangular and other forms. Those ecological building Gua may form beautiful ecological buildings around the Taiji. Different organism may be incubated in different areas according to the type and Xiang of the Gua, and biologic chains can be formed with the interior rules of the eight or sixty-four Gua of the ecological buildings, forming a characteristic mechanism for cultivation of organisms. Similar to other ecological buildings, this cultivation mechanism can be used for productions. Even more, local climate can be influenced that may be helpful to natural environment and the recovery of the deserts. It is one of the characteristics for the combined ecological buildings to be in the form of Yixue's ecological buildings according to Yixue's principles, such as Eight Gua, Taiji, Guaxiang and GuaZheng. The numeral 390 denotes the front view of the Eight Gua and Taiji type ecological buildings. The numeral 391 denotes the ground. The numeral 392 denotes the underground buildings. The numeral 393 (385) denotes the platforms on the top of buildings. The numeral 384 (388, 389) are Taiji images. The numeral 395 denotes the top layer surface of the buildings, indicating that the Eight Gua and Taiji type ecological buildings 390 can be with one more layers. The top layer may be the top layer surface 395, a tridimensional combined surface 396 (omitted in the figure), or a variant tridimensional layer structure 397. The top surfaces of the building, combined by 395, 396 and 397, may be flat surfaces, or cragged combined structures. The Eight Gua images may not be applied to the top layers of high Yixue's ecological buildings, while may be applied to other layers of the buildings. It is another form of the combined ecological buildings to have the flat surfaces 385A located vertically in the top layer, internal layers and side surfaces, thus to be a Yixue's ecological buildings. 386, 388, 389 and other Yixue's contents may be removed from the Eight Gua and Taiji type ecological buildings 390 to change it from special ecological buildings to common ecological buildings. The ecological buildings can be applied with steel frame structures, steel concrete structures, combined structures and other structures. The numeral 386A denotes the tridimensional status of the Guaxiang 386, indicating that the Guaxiang of the eight or sixty-four Gua can be flat surfaces or tridimensional structures. Warm house awnings may be one of the tridimensional structures. The numeral 389 denotes the plants in the top layer warm house. The numeral 393 denotes the platforms on the top of buildings. The numeral 388 denotes the Taiji yang image. The numeral 388A denotes the Taiji yin image. The numeral 399 denotes the top layer warm house for plants. The numeral 400 denotes the space for plants inside the buildings. The numeral 401 denotes the space for cultivation of plants in the high layers of the buildings, with the layers and structures unlimited, which may be one or more layers. Natural landscapes, such as scare plants, hills and waters, waterfalls, fishes and other organisms may be incubated in the cultivation places in the ecological buildings, with unlimited kinds. Besides the natural landscapes, the spaces may also be in the form of ecological rooms special for the productions of plants and organisms, or other forms. The numeral 402 denotes the natural hills and waters environment (natural waterfalls, etc). The numeral 403 denotes the middle layer ecological house for plants, which may be closed, opened, or out of the buildings, or horizontally, vertically or irregularly arranged on the ecological buildings. The numeral 404 denotes the transmitting networks for air (oxygen). The numeral 404A denotes the ventilating fans 9 (or air pumps). The numeral 405 denotes the oxygen inlet for a single room (layer). The numeral 406 denotes the ventilating devices. The numeral 407 denotes the air purifiers and temperature controller. The numeral 408 denotes the air purifier and sanitation devices. The numeral 409 denotes the electric lifting devices (elevators). The numeral 409A denotes the ropes for the lifting devices. The numeral 401 denotes the water reservoirs (or pool and other water storage devices). The numeral 410A denotes upper water pipes. The numeral 411 denotes cooling/heating air desiccators for filtering water. The numeral 411A denotes the water pipes, through which water may be discharged to the underground water reservoir, or discharged to the ecological houses for every layer. The numeral 412 denotes the upper water pumps. The numeral 413 denotes the backwater sanitizing rooms (sanitizers). The numeral 414 denotes the backwater purifier devices. The numeral 415 denotes the arrows for rains, indicating that rains and snows on the buildings and building grounds 418 (with slopes) may flows into the discharge ditches along arrows 415A, and then flows into the underground water reservoir. The numeral 416 denotes the filtering devices in the discharge ditches to filter the garbage in the rain and prevent them from flowing to the discharge ditch. One or more filtering devices may also be provided in the discharge ditch to purify the rain and other water thoroughly step by step before they flow into the water reservoirs. It is another characteristic for the ecological buildings to have rains and snows stored in the underground water reservoirs and the purified water systems. The water reservoirs for rains and snows may be underground, aboveground, above the buildings, semi underground or in the form of pools open to the air. Not only rains, snows can be stored in the underground water reservoirs, but also other water resources can be stored. The used water and polluted water in the ecological buildings can be purified by the purifying systems of the ecological buildings to clean water and stored in the underground water reservoirs. Polluted water purifier devices may be integrated with the ecological buildings, or provided independently, to supply water for the plants, organisms in the ecological buildings, and for cleaning vehicles and others. It is another characteristic of the ecological buildings according to the present invention to supply water for plants and organisms in the ecological buildings and others with rains, snows, and used water. The numerals 404B, 404C denote the recycling air passages. The numeral 404D denotes the inlets of the cooling/heating air devices for filtering water. The numeral 404F denotes the water outlets. The numeral 419 denotes the tridimensional Guaxiang's ladder type ecological buildings, which are formed by DanGua and ZhongGua. Geomantic omen and six-layer buildings are widely used in the history and in the present, indicating their value. The Yixue's ecological buildings in the present invention use the sixteen Gua for animals and sixteen Gua for plants of the sixty four Gua for the cultivation of plants and animals in the ecological buildings, which will be more helpful for the cultivation of the plants and animals according to Yixue, and more helpful for the continuous development of people. The numeral 419 denotes a ladder (turret) type ecological building with combined Gua. The numeral 420 denotes the slope surface. The numeral 421 denotes the top flat surfaces. The numeral 422 denotes the ladder type ecological frames. The numeral 423 denotes the spaces inside the ecological spaces. The ecological frames 422 may be open to the air, opened and closed and transparent, or other structures. Plants, organisms may be incubated on the frame structures or inside the spaces. The numeral 424 denotes the plants on the ecological frames. The numeral 425 denotes the plants and organisms inside/outside the ecological frames. The numeral 426 denotes the plant environment in the spaces inside/outside the Yixue's ecological buildings. The tridimensional Guaxiang's ladder type ecological buildings 419 may be tridimensional garden type buildings, may be buildings with habitants environments inside/outside of the buildings, such as offices, residential houses, business rooms, may be buildings for recreations, may be buildings for cultivation of plants and organisms. The numeral 427 denotes a spire type tridimensional ecological building, which is similar to pyramids. The numeral 428 denotes the slope surface of the building, which may be transparent glass frames and the combinations with other structures. The numeral 429 denotes the spaces inside the ecological buildings for plants. The numeral 429A denotes the spaces for fowls. The numeral 429B denotes the various tridimensional buildings in the ecological spaces. The numeral 429C denotes the ecological spaces for animals. The numeral 429E denotes the ecological spaces for hills and waters. The numeral 429 denotes fishes and other organisms incubated in the ecological water system (pools, lakes, rivers, waterfalls) spaces. The numeral 431 denotes the plants and other organism productions that can be incubated in the underground spaces. (Other devices are omitted). The spire type tridimensional ecological building 427 may be with different forms and structures, with more or less ecological systems and structures. The numeral 432 denotes a large ecological building. The numeral 433 denotes the top flat surface. The numeral 434 denotes the slope surface. The numeral 435 denotes the ecological frame spaces. The numeral 436 denotes ecological frame structures that are open to the air, which may be with several series that are locates everywhere in all the tridimensional ecological buildings. The numeral 437 denotes the structures out of the frame. The numeral 438 denotes the plants located inside the frame ecological buildings. The numeral 439 denotes the underground structures, which may be one or more layers. The numeral 440 denotes the grounds. The numeral 441 denotes the ecological plants and organisms layers tat are outside the ecological buildings. The building structures and device structures of the Yixue's ecological buildings 385, 390, 419, 427 and 432 may be combined partly or completely to form other structures.

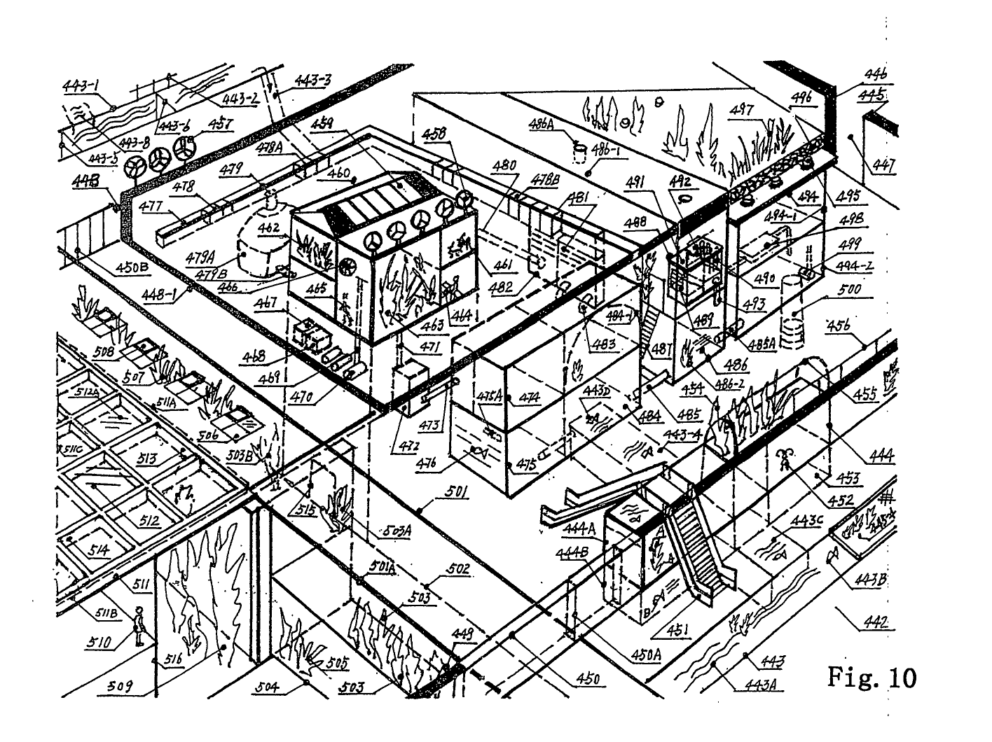

FIG. 10 is a schematic view showing combined village-house type functional ecological buildings. One or more tridimensional ecological buildings and structures, and the cooperating devices compose scaled ecological buildings and the integrated or separated devices, which are in the form of village-houses, villages, castes, sub zones, etc. The various types of tridimensional ecological buildings comprise, the combined functional tridimensional ecological buildings, the tridimensional building structures for cultivation of plants and organisms, the hood type ecological buildings, aboveground/underground ecological buildings for cultivation of organisms, the tridimensional land type ecological buildings for cultivation of organisms, the tree frame type ecological buildings for cultivation of organisms in the air, the turret type ecological buildings, aboveground/underground combined passage type ecological buildings, multifunctional ecological buildings, Taiji (Yixue) type ecological buildings for cultivation of organisms and the cooperating devices and systems. Part, or complete combinations of the various types of tridimensional ecological buildings may form the functions of the combined village-house type functional ecological buildings. The functions of the combined village-house type functional ecological buildings comprise, the functions that can independently exist, the solar power and other power generation devices, the water recycling systems, the aboveground/underground ecological devices, tridimensional ecological lands, tridimensional ecological roads, tridimensional ecological bridges, tridimensional ecological walls, tridimensional ecological rivers, aboveground/underground water reservoirs and the various incubated plants and organisms (including the aquatics) complemented to the various systems, and the building structures and habitants spaces for life, work, and recreations in the FIG. 1 to FIG. 10. The combined village-house type functional ecological buildings 442 comprise the ecological river buildings water system 443, tridimensional ecological walls 444, aboveground/underground ecological buildings 460, 484, 516, tridimensional ecological bridges 501A, tridimensional ecological roads type buildings 486, tridimensional ecological lands type buildings 494, the underground water reservoirs system 477, 474, 482 for rains and snows, and tridimensional garden or hill type ecological buildings. The ecological river buildings water system 443 of the combined village-house type functional ecological buildings 442 comprises the tridimensional ecological river 443-1 for cultivation of aquatics, river guard bars 443-2, water supplier passages 443-3, water supplier passages 443-4 for cultivation of organisms, interception type ecological river sections 443-5 and 443-6 for cultivation of organisms, sub branch river sections 443-8 for cultivation of organisms (omitted) that may be lakes, pools, awning type river sections and other tridimensional ecological rivers, exposed river 443A, hidden river 445-4, sub branch ecological river buildings 443C, 443-4, inside ecological river 443D and other tridimensional ecological rivers. The numeral 443-1 denotes a tridimensional ecological river that stores the purified water and that incubates aquatics, and that has complement tridimensional ecological buildings. The numeral 443-2 denotes a type of river guard bar that may be with different structures. The numeral 443-3 denotes the water supplier passages through which the river water is transmitted to the water reservoir of the ecological buildings. The numeral 443-4 denotes the water supplier passages for cultivation of organisms in the ecological buildings. The numerals 443-5 and 443-6 denote the river sections that are intercepted, in which water flows that can be used for cultivation of organisms. The numeral 443-8 denotes the sub branch of the river, which connects with all the ecological rivers. The numeral 443A denotes the exposed river (lake, pool) that is open to the air. The numeral 445-4 denotes the hidden river that is covered by transparent cover nets, glass awnings, or steel concrete plates. It connects with the exposed river, may be in the form of different rivers and different channels. It may store pure water, and organisms may also be incubated there. Water in the passage of the river sub branch 443 may be transmitted to 443-4 and 443D via the ecological wall buildings. The river section inside the ecological wall buildings is a ecological river, which may be an awning type-fishing river. The numeral 443D denotes also an internal river in which aquatics can be incubated and water can be purified and transmitted. It is one of the main characteristics for the ecological towns to have tridimensional ecological rivers. It is also one of the main characteristics for the ecological towns to have the ecological walls 444. Ecological spaces for cultivation of plants and organisms may be located under the walls, which may surround the buildings completely or partly, which may also be located inside or outside the buildings together with the inside natural ecological plants and the ecological structures shown in FIG. 3. The multifunctional tridimensional ecological walls can be located inside or outside the buildings with unlimited occupied areas, volumes, size and different functions. The numerals 445, 446 denote the front doors of the ecological walls surrounding the ecological towns, which may be in different door structures, including waterproof door structures. The numeral 448 denotes the upper left door of the ecological walls of the ecological town. The numeral 449 denotes the front door of the ecological walls. The numeral 450 denotes the movable door of the ecological walls, which may be an iron gate or other structures. The ecological walls may be with flood control structures, strobe type ecological walls, etc. The door of the flood control walls may be a slidable waterproof door. The numeral 450A denotes a folio door of the ecological walls. The numeral 444A denotes the aboveground ecological wall (space) structures. The numeral 444B denotes the underground ecological wall (space) structures. The aboveground/underground ecological walls and the ecological spaces may be used for cultivation of plants A and aquatics B. The numeral 451 denotes the bridge structures above the ecological walls, which may be in different forms with the ecological walls and the ecological spaces. The numeral 452 denotes the ecological spaces for cultivation of animals on the ecological walls. The numeral 453 denotes the underground ecological spaces of the ecological walls. The numeral 454 denotes the inside/outside structures for cultivation of plants on the ecological walls, which may be big or small. The numeral 455 denotes the warm house awning structures on the ecological walls. The numeral 456 denotes banisters on the ecological walls. The tridimensional ecological warm house on the ecological walls may be with different layers and unlimited height. The ecological walls may be with different structures, and the structures for cultivation of plants can be added. The ecological walls may be partly located inside/outside the ecological spaces, forming the main body of the ecological walls, and banisters, doors and other structures may also be added. The ecological walls may be provided partly or completely in the ecological towns. It is one of the main characteristics for the ecological towns to have ecological walls. The ecological towns can be divided into several areas by ecological rivers and ecological walls or one of them. And the ecological towns may also be divided into several areas by roads. Normal buildings and ecological buildings may be combined together in the ecological towns with unlimited numbers. The numeral 457 denotes the wind power generation devices (may also be solar power generation devices and other power generation devices) on the ecological walls, the positions and structures of which are not limited. The numeral 458 denotes the combined wind power generation devices on the high buildings, which may be used as necessary power resources where wind power is sufficient. The numeral 459 denotes the solar power generation devices, which may be fixed or movable, such as folded, window blind and other structures, and which may be mounted everywhere in the buildings, such as doors, windows, sleeping porches, and in the underground buildings. The electric power generated may be supplied to the entire buildings, or to the part of the buildings, such as one or more houses. Various types of ecological buildings may be combined together in the ecological towns with unlimited numbers, which may be used in large scale, or only with one or more buildings combined. The numeral 460 denotes villa ecological buildings with unlimited numbers, which are suitable for residential houses and tour areas. The numeral 461 denotes tridimensional ecological spaces for cultivation of organisms. The numeral 462 denotes tridimensional ecological structures for cultivation of plants. The numeral 463 denotes natural ecological spaces for large plants, in which hills, water, flowers, grasses, animals, habitants can be provided. The numeral 464 denotes the cultural places for habitants. The numeral 465 denotes the ecological buildings for habitants where habitants can live comfortably. The numeral 466 denotes the ventilating devices, where transmitting system for oxygen can also be provided with figures omitted. The numeral 467 denotes the heating devices. The numeral 468 denotes the cooling devices. The numeral 469 denotes the water supplier devices. The numeral 470 denotes the water pumps. The numeral 471 denotes the backwater devices. The numeral 472 denotes the water purifier devices. The numeral 473 denotes the water pipes, through which backwater flows into the water reservoirs systems after being purified. The numeral 474 denotes the first layer underground ecological spaces. The numeral 475 denotes the underground ecological spaces. The numeral 476 denotes the underground aquatics incubated in the underground ecological spaces. The numeral 475 denotes the ultraviolet sterilizers that are located in the underground ecological spaces, which may be widely used in the ecological spaces for cultivation of organisms in the ecological buildings, wand that are important to sanitations. The numeral 477 denotes the discharge, storage and purifier systems for rains and snows, which are part of the water systems. Rains, snows and other polluted water are discharged into the discharge ditches 477, where they are purified by the purifier structures 478 and then flows into the water reservoirs 479A for further use, while water are pumped out. The water newly in the water reservoirs 479A may be connected with other underground water reservoirs. The numeral 479B denotes the water pipes for wastes. In the figure, the water reservoirs 479A may also be changed to energy equipments, such as methane tanks (omitted in the figure). The polluted water from the ecological spaces 461 of the ecological buildings 460 for habitants may be transmitted to the energy equipment methane tanks 479A (The methane tanks may be inside or outside of the town), and the methane may be used to supply the required thermal energies for the ecological buildings. It is one other main characteristic for the present ecological buildings to use solar power, wind power, methane power, waterpower, mechanical power and other natural energies. The numeral 478A denotes the complement water purifier devices, which may be used for times in the water systems. The numeral 478B denotes another set of the water purifier devices for polluted water. The numeral 480 denotes the purified water passages, via which clean water may connect with the clean water systems. The numeral 481 denotes the filtering layers for further purifying water, which may be yarn layers, biochemical films, bio-electro-analysis, sanitizer, etc. The numeral 482 denotes another set of the water purifier and filter devices. The numeral 483 denotes the transmitting devices for the purified and filtered water. The purified water may flows into the water reservoirs from 483 and 480. The numeral 484 denotes the underground ecological buildings. The water resources for the ecological spaces 443D may be supplied from the water transmitting devices 438, and the water in the ecological rivers may be discharged into the water purifying devices via 443-3, where it is purified several times by 478B, 481 and 482, and flows back to the ecological river 443D through the water transmitting devices. And also the recycling and purifying systems cooperate with the ecological buildings in the ecological towns, thus the ecological water in the ecological towns forms a recycled and purified clean water systems, which may be the solution for the continuous development issues. The devices for purifying water are substantially underground without occupying aboveground spaces, thus have no bad effects to the environment, while they are good to protect the natural environment. It is one other feature for the present ecological buildings and the ecological towns to have such water purifying systems. The numeral 484-1 denotes arc type top covers for the aboveground ecological buildings, which are resistant to pressures. The top covers may also use other structures, and habitant environments can be provided in their underground spaces. The numeral 485 denotes the water connecting devices, which connect the underground water reservoirs 475, 443 and 486 together. The numeral 486 denotes tridimensional road type ecological buildings, which comprise road surfaces (or soil roads and quarry stones structures) 486-1, underground ecological buildings 486-2 and other plants environments and organism environments. The numeral 487 denotes the ladders in the underground ecological buildings and other ecological spaces, which may be in different forms. The underground ecological buildings 486-2, 486 and others may be with one or more layers, and may also be connected with other building structures. The numeral 486A denotes one type of sunlight transmitting devices of the ground 486-1 on the road grounds, which may be used to transmit sunlight to the underground ecological buildings for illuminations and organisms. It is obvious features of the tridimensional road type ecological buildings that sunlight transmitting devices are mounted on the grounds to transmit sunlight to the underground ecological structures and underground ecological spaces which can be provided for habitants, plants, organisms and other environmental structures. The ecological buildings 496, 486-1, 486-2 may be provided independently, or provided on and beside the long distance roads, and may also be complemented with other devices, thus may add new functions of the original roads without bad influences on the ground environments. They have special functions for the ecological environments. Sunlight may be transmitted to the underground spaces by the sunlight transmitting devices on the roads, or be refracted to the underground spaces by the sunlight refractive devices on the sides of the ecological structures. Two methods may be used in combination, or independently used from each other. Neither of the methods may be used, while electric power from outside may be used instead, yet in such a case, the light generated is insufficient for the organisms environment in the underground ecological spaces. The roads surfaces of the tridimensional road type ecological buildings may be parallel to the ground, and may be one or more layers higher than the ground. The roads layers can be provided in all the layers of the tridimensional road type ecological buildings and combined with ecological spaces. The numeral 494 denotes tridimensional land type ecological buildings, which comprise land layers 496, sunlight transmitting devices 495, underground ecological spaces 494-1, 494-2. It is a good method to use the land layers 496 to protect plants on the ground, which may be helpful to protect natural environment, to incubate water resources and adjust climates The ecological plants 497 above may be grass lawns, meadows, forests, gardens, deserts and other environments. The rains and snows on the land type ecological buildings may be collected by the collecting ditches (omitted), and transmitted to the underground water reservoirs (omitted) for further use. The used water may flows back to the above of the land layers 496 where it is purified by the land layers and plants layers before it is discharged back to the devices. Thus the ecological plants on the lands are nourished as well as that water is purified. So the water is recycled to be used and the water quality and the ecological environments are protected. The tridimensional land type ecological buildings may be with different structures, the inside of which may be natural ecological systems, may be ecological spaces for cultivation of organisms or for habitants, conference rooms, offices, residential houses, roads and stations, ad the combinations thereof. They can also be equipped with elevators, cooling/heating devices, ventilating devices, oxygen supplier devices, water reservoirs and suppliers, water purifier devices and other required devices. Sunlight transmitting devices may be added, and the transparent portions of the buildings are directly open to the air, so that sunlight may be transmitted to the underground buildings from the transparent structures of the buildings. The land type ecological buildings may be widely used in meadows, hills and forests where natural environments are to be protected, and widely used in tourism sites, in frontier sentries and other places. They may be provided especially beside the bank of rivers, such as the Yellow River and the Yangtze River. And in such areas near the rivers where there are so many floods, the land type ecological buildings may effectively prevent floods and be beneficial to the country. Many organisms may be incubated at the same time, which may be great helpful to solve the lack of money that are needed for maintaining the rivers. Most of all, it is a scientific method to avoid floods, which will be really good to the habitants and the country. And the water in the rivers, lakes and seas may also be purified by the water purifier systems of the ecological buildings, and then flows back, which is good to protect the rivers, lakes from being polluted. Thus, it is a scientific method to provide tridimensional ecological buildings along the banks of the rivers, lakes and seas for maintain of natural environments and maintain of the rivers and lakes. The lands may also be used mostly by cultivation of plants. While the natural environments of the land layers 496, 497 are kept unchanged, one or more land layers or layers without soils may be added with frames above the land layers of the tridimensional land type ecological buildings, thus the tridimensional land type ecological buildings may combine the functions of other type of ecological buildings, which is a combinational ecological buildings. It is the main features of the tridimensional combined ecological buildings that land layers, ecological spaces, natural environments for organisms, environments for habitants and other structures may be combined to the airs. Since they are composed of several types of ecological buildings, it is one of the main features that only a single ecological structure or the combinational ecological structures by several ecological buildings may be formed. The numeral 495 denotes the sunlight transmitting devices of the tridimensional land type ecological buildings 494. The numeral 494-1 denotes the upper ecological spaces. The numeral 494-2 denotes the lower ecological spaces. The numeral 498 denotes the water reservoirs or other storage devices. The numeral 499 denotes water supplier devices. The numeral 500 denotes deep wells that may be used both for supplying water and for discharging water. The wells can be widely used in the ecological buildings and the cooperating devices, which may supply water for the buildings from underground, and which may discharge the purified water back to the underground water systems. Here only the purified water by purifier devices may be discharged back to the underground water systems, while the polluted water from the ecological buildings may be sprayed to the land layers 496 and the plants 497, where the polluted water may be purified by the land layers and the filtering layers before it can be discharged to the underground. The land layers may also be used to incubate angleworms to improve the quality of the soils, especially for those sandy soils. It is one of the main features for continuous development that deep wells are afforded in the ecological buildings as complement water suppliers, and the used water may flows back to the underground by penetration and recharging. Thus the lack of water may be solved. It is also one the main characteristics for the ecological buildings to maintain and recover natural environments that the land layers and the plant layers are with sufficient water that more plants may be incubated, which encourages the recycling of clouds and rains, thus improves the climates. The numeral 488 denotes the air exsiccating and water producing devices mounted in the ecological buildings, comprising air inlets 489, air heating cultivation devices 491, air-cooling and water-filtering devices 492, air outlets 493 and the corresponding complements, which may be used in agriculture awning type ecological buildings, town ecological buildings, residential houses in humid areas and in arid areas, other buildings and passages (may also be used directly open to the air). The humidity in the air may be filtered by cooling/heating water, where temperatures are regulated so that the humidity in the air is condensed to ices. This is a traditional method while a scientific one with high-tech devices, which may be the solution for the lack of water resources. It is one other characteristic of the ecological buildings that air-cooling and water-filtering devices and similar passage structures and other structures are used. Air-cooling and water-filtering devices may be independent products that are used in the ecological buildings, and other structures in/out of the ecological buildings, which are not to be described in detail since they have been explained before. The numeral 450B denotes combinational structures of ecological walls, which may, or may not, mounted with unlimited occupied areas. The numeral 448-1 denotes the ground layers, which may be cements, bricks, soils, plants, and the combinations. Hard layers may be used near the water storage ditches, so that rains can flow into the water storage ditches completely. Water storage ditches and the water discharge ditches form the rain storage systems. The stored water in this system may be united with the discharged rains on the roads, the discharged system for playgrounds, and other large-scale water gathering devices, forming their own water reservoirs and purifying systems, which may be used to supply water for the ecological buildings and the plants inside. Those special large-scale rain storage systems (pools, reservoirs, lakes and rivers) may be used in tridimensional ecological villages, tridimensional ecological towns and other large-scale ecological buildings. With the complement organisms and devices for purifying polluted water, the lack of water resources may be solved effectively, saving as many natural water resources as possible. The numeral 501 denotes a tridimensional ecological bridge. The numeral 501A denotes the surface of the tridimensional ecological bridge. The dashed line 502 denotes the second layer surface of the tridimensional bridge, on which plants and organisms may be incubated. The numerals 503, 504 denote the third layer surfaces, where plant environment 505 may be provided. Water reservoirs, river channels and other space structures may be provided at the bottom of the bridge surface 504. The numerals 503A, 503B denote the plant environment and organism environment provided on the bridge surface 502, which may be gardens, circular forms, rectangle forms and other ecological structures on all the layers of the bridge. The numeral 515 denote the door that connects the tridimensional ecological bridge. The tridimensional ecological bridge may be underground, semi-underground, aboveground, or combinational structures, and connect other ecological buildings or normal buildings through different forms of passages and doors in all the layers of the bridge, forming the ecological environments and transportation networks that are abundant. The numeral 506 denotes the sunlight transmitting skylight window on the ground of the surface 501A of the tridimensional ecological bridge 501, which may be formed by transparent structures, transparent glasses and other materials and other structures. The numeral 507 denotes the plant environment or garden environment provided on the tridimensional ecological bridge. The numeral 508 denotes the sunlight transmitting and refractive devices. 506, 507 and 508 may be combinedly or independently provided in the middle, sides and other portions of the surface of the tridimensional ecological bridge, with different structures and unlimited occupied areas, thus sunlight may be transmitted to the lower layer bridge surfaces. The numeral 509 denotes an underground (may also be aboveground or semi-underground) transparent ecological space with top frames that are transparent glass structures 511, which may be divided into one or more layers ecological spaces 516. 516 may be with transparent glass walls, in which large-scale precious plants 509, fruit trees and other organism products may be incubated. 516 may keep temperatures stable efficiently, which is the ideal ecological structures for the tropical rain forest that are to be incubated in cold zones and warm zones. The numeral 510 denotes the various types of habitant environments in the structures. Water reservoirs, aquatics cultivation environments, and other cooperating devices and structures may also be provided in the structures. The top layer frame transparent structures 511 may be with different structures and forms. The numerals 511 and 512 denote the double-layer glasses (middle hollow glasses), which keep the temperature very stable. The numeral 512A denotes the single-layer glasses. The numeral 513 denotes the mirror surface refractive plate devices mounted on the right of the glass frames. The numeral 514 denotes the mirror surface refractive plate devices mounted on the left of the glass frames. The numerals 513 and 514 denote that there are refractive plate devices mounted on the surface of the transparent frames of the top layers. The devices are used to transmit the sunlight from different directions to the inside of the underground ecological structures for the cultivation of organisms. With the additional sunlight from the glass layer surfaces 512, 512A, the sunlight is sufficient. The sunlight refractive devices may be fixed or movable, and may also be made upright frames, which are located above 511 and beside 511 for gathering sunlight for the ecological structures. It is another characteristic of the tridimensional ecological buildings that frame type transparent roofs are provided in the ecological structures, and sunlight refractive plate devices are mounted on the roof structures. The devices may be used out of the ecological buildings for other building structures. The transparent glass frames of the underground ecological structures may be opened, fixed, or the combinations. Awning covers comprising 511A, 511B and 511C may be mounted on the roof frames to improve the ability to resist sands and to improve security. The awning covers may be opened, closed, which may be operated electrically or manually. The awning covers may be used on the transparent roof of the ecological buildings, and may also be used in the ecological buildings and the independently provided organism awnings, agriculture awnings, passage type ecological buildings and other structural ecological buildings. The awning covers may be made of colorful clothes, nylon textures, waterproof clothes, radiation-proof materials, ultraviolet-proof materials and other materials. It is another characteristic of the ecological buildings that the awning covers can prevent sands, dusts and water, can keep temperature and security. The village-house type ecological buildings in FIG. 10 are composed of various forms of ecological buildings and the cooperating devices in the tridimensional combined ecological buildings and various devices systems. The villa ecological buildings 460 may be the ecological residential houses for peasants, high ecological buildings, residential houses and other ecological buildings. Various types of natural ecological environments, environments for cultivation of plants, environments for cultivation of organisms, habitant environments, and combined ecological structures, as well as culture buildings, researching buildings, factories, business buildings, other high-tech buildings for habitants and various ecological buildings, with additional networks for cultivation of organisms and the corresponding scientific systems, compose a scientific ecological towns with excellent ecological environment networks, which may be the strong base for constructing a high-tech and modern city, which will encourage habitants to further development in science.

### DETAILED DESCRIPTION OF THE PREFERRED EMBODIMENTS

In tridimensional combined ecological buildings, different ecological buildings nay be combined to form tridimensional ecological villages, tridimensional ecological towns, tridimensional ecological districts and other ecological buildings with different scales. Different forms of tridimensional ecological buildings with different size may be contained, which may form new type of ecological buildings, and those new ecological buildings may be composed of the combined ecological buildings with their forms, functions, structures and other variable items, which is a part of the combined ecological buildings. The tridimensional combined ecological buildings may be mainly the ecological buildings for habitants, the tridimensional ecological buildings for cultivation of organisms, the tridimensional ecological buildings for sightseeing and research, the combined ecological buildings. They not only have the features of architectures, but also can protect ecological environment, harness deserts, prevent floods, improve land resources and tridimensional ecological spaces, which are great beneficial to habitants with fortunes. Most of all, they change habitants from improper life manners to the proper tridimensional green (ecological) life manner, thus a new manner of life is afforded, which basically solve the problems in continuous development that improve the development of science.

1. A multifunctional tridimensional combined ecological architecture which is an ecological buildings system that combines habitants, plants, organisms and other natural environments inside or outside the combined ecological buildings, which may be closed, opened, opened and closed, combined, and other forms, the ecological building expanding spaces upward and downward, including natural ecological structures for plants, cultural places for habitants, ecological oxygen suppliers, air water filtering purifiers, air temperature conditioning systems, organisms cultivation and flow water cultivation devices, ultraviolet sanitation systems, used water purifying and storage systems, rain storages and water purifying systems, water cultivation systems, as well as cooperating facilities and equipments such as solar power generation systems, wind power generation systems, water power generation systems, mechanical power generation systems, sunlight refractive and transmitting devices, methane tanks and methane utilizing facilities, and the like etc.; the combined ecological buildings being composed of the main body of the ecological buildings, cooperating awning ecological buildings, cooperating garden ecological buildings, transparent ecological buildings, frame awning passage ecological buildings, as well as with additionally cooperating ecological building structures, such as hood type ecological buildings, rotating ecological frames for cultivation of organisms, oxygen rooms, methane devices, water resources and the cooperating recycling systems of energy conservation, the underground and semi-underground ecological buildings with cooperating systems, tridimensional land type ecological buildings for cultivation of organisms, tree type tridimensional ecological buildings, turret type ecological buildings and the accessory photoelectric devices and energy devices, combined passage type ecological buildings with air, water purifiers and supplier network systems, combined functional ecological buildings and Taiji type ecological buildings, combined village-house type functional ecological buildings; the combined ecological buildings and the cooperating ecological buildings may be integrated, independently provided or singly used, and may also form combined village-house type functional ecological buildings and the large-scale ecological buildings in ecological scientific towns; village-house type ecological buildings and ecological scientific towns comprise various types of ecological buildings, tridimensional ecological lands, tridimensional ecological roads, tridimensional ecological walls, tridimensional ecological rivers, storages and purifiers for rains and used water, methane tank systems, power generation systems, water recycling systems, cultivation systems for plants, organisms and aquatics, air sanitation and purifying systems for filtering water, cultivation structures for plants and organisms, cultural places for habitants, public utilities and other cooperating systems; the combined ecological buildings, cooperating buildings, cooperating devices, cooperating equipments, cooperating systems can be used integraly, partly or separately, the tridimensional ecological walls, tridimensional ecological rivers, tridimensional ecological roads, tridimensional ecological bridges and the cultivation structures for plants and organisms can be used integraly, partly, separately or combinedly; tridimensional ecological lands are formed by providing tridimensional ecological building facilities in the spaces above or under the original lands, cultivated lands or vegetation simultaneously or separately, where tridimensional ecological buildings can be provided with plants and biotic environments, top cover green vegetation and human cultural places of various storeys; tridimensional ecological roads are formed by providing the ecological spaces for plants surrounding the original roads, which can be arranged by layers, by sections, by compartments, and upper and lower layers gardens for cultivation of plants and organisms, ecological houses for plants and cultural places for habitants can be provided surrounding the roads partly or completely, the surface of the roads may be higher than, lower than or equal to the ground; tridimensional ecological bridges can be formed by providing upper and lower layer gardens for cultivation of plants and organisms, ecological houses for plants and cultural places for habitants, by layers, by sections, and by compartments around the bridges, on or under the bridges higher than or lower than the ground; tridimensional ecological walls can cooperate partly or entirely with building facilities like village-house type ecological buildings, ecological scientific towns, and the cultivation places for plants and organisms, and the tropic forests ecological systems can be arranged surrounding the walls, which may be used locally or completely, and which may be disposed inside or outside the buildings, the ecological walls may be combined with inside ecological systems for plants to form fixed or movable multifunctional tridimensional walls, on which there may be illumination systems, audio systems, alarming and monitoring systems, solar power generation systems, wind power generation systems, pools, watch towers, cultivation systems for plants and organisms, methane tanks and others with unlimited volumes, which may be hills and water type, plants, hills and water walls type, plants type, platform type, composite type, ladder type, turret type, patios type and the combinations, the ecological wall can have different functions and structures and can be provided inside or outside the buildings, the ecological rivers are river systems which entirely or partly surrounds the village-house type functional ecological buildings and ecological scientific towns, which comprise tridimensional ecological rivers buildings, awning type river sections, exposed rivers, hidden rivers, water purifying and recycling systems, sub branches for cultivation of organisms, purified ponds, river water systems based on plants and organisms, ecological houses for cultivation of aquatics, water reservoirs systems, water collecting and purifying systems for rains, snows and used water, and recycled water systems; the ecological rivers may be composed of the ecological functional buildings, cultivations structures for organisms, or cultural places for habitants, with small or large occupied areas, which may be inside or outside the building and may be connected between inside and outside with each other; the tridimensional ecological buildings, the tridimensional ecological lands, the tridimensional ecological roads, the tridimensional ecological bridges, the tridimensional ecological walls and the tridimensional ecological rivers can be connected with one another and combined and can be used partly or separately, and can cooperate with other ecological buildings, cooperating accessories, cooperating systems, cooperating devices, ordinary buildings and building complex can be provided in the village-house type functional ecological buildings and ecological scientific towns; the multifunctional tridimensional combined ecological architectures comprise several tridimensional ecological buildings, which combine tridimensional ecological environments and building structures together, which can be provided inside the buildings, outside the buildings, complementary, opened and closed, mechanically transmitted, overlapped, consistent to Yixue, underground, aboveground and semi-underground, they can be super-high, middle, or low tridimensional ecological buildings or single-storey buildings or subterreanean, and they can also be awnings for cultivations, movable long corridors, tridimensional lands, ecological bridges, tridimensional ecological walls, tridimensional combined frames, tridimensional ecological rivers, ecological residential houses in rural areas, ecological villas, ecological factories, public utilities, ecological researches and other forms, most of all, they can form or partly form tridimensional ecological villages and tridimensional ecological towns for habitants, lounges, or public places, which can be arranged independently or together with production type ecological environment structures; the space rotating cultivation frames for organisms comprise building structures, electric rotating devices, rotating pivot points, cultivation plates (boxes) for plants and organisms; frame type tridimensional cultivation devices for organisms comprise frame structures, rotating controllers, rotating transmitters, organisms cultivation ecological boxes, underground pool for storing and purifying water, methane tanks and others, and may be arranged singly, or in combinations, and can be located aboveground and underground and in any portions of the buildings the solar power, wind power, water power, mechanical power generation systems are mounted on the buildings; the solar power generation systems comprise solar power receiving sheets (plates, coats), power storages, electric transmitters, and can be separate, fixed, movable, door window, lying types, and can be placed on the ground, inside or outside the buildings, and can be provided in the whole or part of the building; the wind power generation systems comprise wind power generation devices (wind leaf type, interior type, wind power channel type) that can be connected with the storage and transmitter of the solar power generation devices and can be arranged separately. Which includes energy-saving systems that save energy, water and electric power, oxygen chambers and oxygen generating and transmitting systems, air conditioning and blowing and recycling systems, purifying systems for air and water, rain and snow water collecting, storing, purifying and supplying systems, clear water supply systems, systems for recycling, sorting, purifying and utilizing used water, methane storing and utilizing systems, cultivation systems for aquatics, cultivation and irrigating systems for plants, illumination systems, artificial intelligence automatic control systems, ecological covers systems, movable ecological spaces with equipments, ecological systems for habitants and plants, ecological buildings structures, tridimensional forms of ecological buildings, sunlight refractive and transmitting systems, new functional type constructing materials and equipments supplying systems, heating/cooling air devices (passages) systems for filtering water, water transmitting, storing, supplying systems, combined ecological buildings network systems, organisms systems for sightseeing, systems for organisms production, processing and storage, mechanical frame transmitting systems for cultivation of organisms, those auxiliary and cooperating devices and equipments systems may generally cooperate with the ecological buildings to form high quality large-scale or luxury ecological buildings for habitants' continuous development, or to form middle or small-scale ecological buildings with fewer equipments or single type building; combined multifunctional tridimensional ecological architectures may be in different forms, including tridimensional ecological buildings mainly for habitants and secondly for ecological green environments for organisms, such as office buildings, residential houses or business buildings, tridimensional ecological buildings mainly for ecological green environments for organisms and secondly for habitants, tridimensional ecological buildings mixedly for habitants and ecological organisms environments together, tridimensional ecological buildings for sightseeing, tridimensional ecological buildings for cultivation of plants, tridimensional ecological buildings for cultivation of animals, tridimensional ecological buildings for cultivation of plants, animals and organisms together, multifunctional tridimensional combined ecological architectures for habitants, for cultivation of plants and organisms, and for natural ecological environments, mechanical frame type ecological buildings for cultivation of organisms, ecological buildings that can be opened and closed, opened, closed, and the combinations; the building systems comprise a type of air water recycling system that includes ecological buildings, inlets and outlets devices for air, air passages, air water filtering, purifying and storing devices, the system extracts the water from ecological buildings and other humid airs via temperature differences, and stores the filtered water for organisms. The air cooling/heating filtering devices (passages) systems extract water from air based on the temperature difference between cool air and hot air. The large, middle, small electric air water filtering devices and the cooling/heating air water filtering passage devices can be assembled together, which can be mounted in different spaces in the ecological buildings, and can also be mounted in oxygen transmitting, air passages, air purifying and recycling systems, and can also be made products for sale, with much water saved, the water transmitting, storing and supplying systems comprise the internal water transmitting, storing, and supplying systems inside the ecological buildings and structures, as well as the external water transmitting, storing, and supplying systems from outside, the external water transmitting, storing, and supplying systems from outside comprise water transmitting passages (rivers, underground rivers, passages, water pipes) and water reservoirs (including water transmitting passages, one or more sub branch water reservoirs, reservoirs type water passages, water reservoirs for cultivation of aquatics, air cooling/heating water filtering passage devices, water purifying and sanitation systems, purifying systems for polluted water, various types of ecological organisms and plants gardens, passage type ecological warm house network and other ecological buildings that form the ecological network systems), the internal and external water transmitting, storing, supplying systems can be integrated together or separated; the combined type ecological buildings network systems comprise various types of tridimensional ecological buildings (including the buildings for habitants, for organisms, for transportations, for agricultures, other agriculture buildings for habitants, and awnings) that combine with natural environments, which connect with one another to form network systems, the network systems may be large or small, with more or less number of ecological buildings; the organisms processing and storage systems refer to the storage (including the cool reservoirs) of the organism productions and the deep processing of the organism productions, comprising in detail the network systems from the storage of the seeds, cultivations, research, production, processing and sales; mechanical frame transmitting systems for cultivation of organisms refer to the structures for cultivation of organisms using transmitting methods, comprising various transmitting devices and various types of flow lines, as well as the formed ecological building structures and complement structures characterized in the structures with frames, steel frames, concrete frames or combined frames, the transmitting devices can be operated manually or automatically, the concrete frames and the combined frames may be provided on the top, middle part or the bottom of the building structures, which may be fixed or assembled, and which may be provided inside or outside of the building structures and other portions, and which may be combined with warm houses that may be opened and closed, may be awnings, and may be plants frames, and which may be combined with structures for cultivation of organisms; the organisms systems for sightseeing are inside or outside the ecological buildings for habitants to contact natural environments, which may be provided partly in the yards of the buildings with different occupied areas, and which may be provided in one or more layers of the tridimensional spaces, and which may be provided in porches, corridors, parlors, public areas, stadiums, which may be combined with production type ecological environments or may be separate; the solar power, wind power, water power, mechanical power generation systems are mounted on the building structures, the solar power generation systems comprise solar power receiving sheets (devices), power storages, electric transmitters, which can be separate, fixed, movable, door window, lying, and which can be aboveground, inside or outside the buildings, and which can be constructed entirely or partly; the wind power generation systems comprise wind power generation devices (wind leafs, inside buildings, wind power channels) that can be connected with the storage and transmitter of the solar power generation devices and that can be separately used, those above mentioned are part of the technical systems of the tridimensional combined ecological buildings, which can be entirely, partly or separately used, with functions and structures being variable, the unit of the combined ecological environments (structures) may be arranged horizontally, vertically, inclined, in various regular and irregular arrangements, or in the combinations, the structures may be opened, closed, movable, opened and closed and the combinations, the structures may be opened and closed horizontally, vertically, inclined or the combinations, the ecological buildings may be high or low with one or more layers, the ecological (plants) spaces can be mounted at one place or more places in the buildings, the unit structures of which corresponds with the number of storeys of the buildings and can have one or more storeys and awning type spaces, the unit ecological spaces can be divided into several layers of ecological environments, in which cultivation environments for plants and natural ecological environments are provided, such as rockeries, pools, flowers and grasses, tropic forests, fish and birds, organisms in flow water, the occupied areas of which can be small or large in one of the spaces or in most of the spaces with large occupied areas, they can be combined with environments for habitants, such as tea houses, meeting rooms, recreation areas, business rooms, to form new type of building environments and cultures. The ecological environment spaces can be internally divided into several parts, seasonal cooling/heating climate adjusting systems, automatic monitoring systems, alarming systems, background music systems, fire prevention and fighting systems, air purifying water filtering systems, oxygen output systems, water supplying and recycling systems with cooperating devices, contamination prevention and ultraviolet sanitation systems, all of which may be independently provided or unitedly provided with the ecological buildings, with unlimited numbers. The various types of tridimensional ecological buildings comprise the combined multi-functional tridimensional ecological buildings, the tridimensional building structures for cultivation of plants and organisms, the hood type ecological buildings, aboveground/underground ecological buildings for cultivation of organisms, the tridimensional land type ecological buildings for cultivation of organisms, the tree shaped frame type ecological buildings for cultivation of organisms in the air, the turret type ecological buildings, aboveground/underground combined passage type ecological buildings, multifunctional ecological buildings, Taiji-figure (Yixue) type ecological buildings for cultivation of organisms and the cooperating devices and systems; The functions of the combined village-house type functional ecological buildings comprise the combined functions of the multifunctional ecological buildings so that they can independently exist under various types of natural environments, and have solar power and other power generation devices, water recycling systems, aboveground/underground ecological devices, tridimensional ecological lands, tridimensional ecological roads, tridimensional ecological bridges, tridimensional ecological walls, tridimensional ecological rivers, aboveground/underground water reservoirs and the various plants and organisms (including the aquatics) cultivation (incubation) systems complementing to the various systems. The functions of the combined village-house type functional ecological buildings, may combine with the functions of various types of tridimensional ecological buildings, the functions of combined type multifunctional tridimensional ecological buildings, the functions of tridimensional ecological buildings for cultivation of plants and organisms entirely, partly or separately, forming series of ecological buildings with unlimited architectural forms. The functions of tridimensional ecological lands, the functions of tridimensional ecological roads, the functions of tridimensional ecological bridges, the functions of tridimensional ecological walls, the functions of tridimensional ecological rivers, the functions of aboveground/underground water reservoirs and the various cooperating systems for cultivation of plants and organisms can be entirely, partly, or separately combined to form various types of ecological building structures, and to combine with other building structures with unlimited architectural forms; the functions of combined village-house type functional ecological buildings, the functions of various types of tridimensional ecological buildings, the functions of multifunctional tridimensional combined ecological architectures, and the functions of tridimensional ecological building structures for cultivation of plants and organisms can be entirely, partly, or separately combined to form series of ecological buildings with unlimited forms. The functions of tridimensional ecological lands, the functions of tridimensional ecological roads, the functions of tridimensional ecological bridges, the functions of tridimensional ecological walls, the functions of tridimensional ecological rivers, the functions of aboveground/underground water reservoirs and the various cooperating systems for cultivation of plants and organisms can be entirely, partly, or separately combined to form various types of ecological building structures, and to combine with other building structures with unlimited architectural forms.

2. The multifunctional ecological architecture according to claim 1, characterized in that the air water saving recycling systems comprise air water filtering devices, in which air is transmitted to the purifiers through the inlets by wind blowers, in which heating devices are provided to vaporize the water in the air, and the vaporized water is filtered out by the cooling filtering and suspending devices in the cooling devices and discharged out of the water filtering purifiers from the outlets, which can be used for ecological buildings, or can be stored in the water reservoirs, the air water filtering purifiers may be upright-type, caged-type, suspended-type or the type of air-conditioning, and may be used inside ecological buildings for cultivation of organisms, and which can be used in other applications as multifunctional air water filtering purifiers of small and large types.

3. The multifunctional ecological architecture according to claim 1, characterized in that the buildings are provided with intelligent control systems that can be controlled entirely, partly, or separately, the ecological buildings can be provided with theft and fire prevention and fighting alarming systems, image transportations, dialogue system for security in buildings, closed-circuit monitoring systems, and natural energy resource power generation network systems are provided which comprise wind power generation devices, solar power generation devices, water wheel power generation devices, elevator type power generation devices, mechanical power generation devices, and energy storing and distributing systems that include storage batteries, voltage transformers, power distribution plates, bolts and connecting wires, the power generation devices and energy storing systems may be combined together with integrated power storing and distribution, and can be combined or separately provided in the facilities, the ecological buildings are provided with water supply and drainage pipes systems and wind passages systems, the two systems can be integrated or separately arranged, the water supply and drainage pipes systems can be provided with pumps, water reservoirs, water purifying devices, and methane tanks. The wind passages systems can be provided with fans, wind power generation devices, air water purifying and filtering devices and oxygen suppliers and transmitters system.

4. The multifunctional ecological architecture according to claim 1, characterized in that the ecological buildings have roof type, inside building structure type, and outside building structure type ecological building structures for cultivation of organisms, roof plants and organisms structures and sunlight passages for plants. They can be provided on the building structures, on the single-storey buildings, on the semi-underground buildings and on the underground buildings, which can be houses for plants, garden square areas for plants, formations for plants productions, and which can be road type structures for cultivation of ecological plants and organisms, forming networks. They can be integrated with other buildings and cooperating devices, or can be independent. The ecological buildings may be village-houses, villages, and integrated or separated buildings, with the functions of plants and organisms provided entirely or partly in the ecological buildings. There are systems for storing rains and snows and for recycling, which comprise water reservoirs, air water filtering passages, water filtering and purifying devices, water purifying and storing devices for cultivation of organisms, clean water filtering devices, clean water storage devices, water recycling systems and water supplier and water saving devices. The devices and cooperating devices can be with more or less numbers, which may be used together, separately, or combined with other devices. The ecological buildings can be provided with transmitting devices for cultivation of organisms, which may be upper moving orbits, succeeding flow transmission belts, horizontally arranged transmitting orbits, vertically arranged ground orbits and other transmitting devices. The devices may be the boxes for cultivation of organisms, which may be suspended, laid, piled, tridimensional, etc. The cultivation boxes for organisms may be with soils, waters, soilless cultures, other artificial soils, or volcanic ashes that are substitutes for soils. Heating devices and irrigation devices may also be provided in the cultivation boxes for organisms, such as solar power heating and discharging devices, water spraying devices.

5. The multifunctional ecological architecture according to claim 1, characterized in that the buildings are provided with solar power generation and saving systems that comprise solar power receiving plates, electric storage devices, transformer devices, current meters, power distributing devices, electric supplier networks and other cooperating devices. The solar power systems may be integrated ones or separated ones. In the integrated solar power systems, the electric suppliers devices in the ecological buildings or the ecological building structures are integrated together for use in the entire buildings, while in the separated solar power systems, they are mounted in part areas of the buildings for use. The solar power generation and saving systems, as well as the various types of integrated or separated solar powers may be used for all or part of the appliances inside the buildings. The solar power systems may be laid, upright, fixed, folded, rotating, in the form of sleeping porches, door windows, curtains and walls, which can not only be applied to ecological buildings, but also be applied to other building structures. One or more same or different building roof awnings and building transparent walls may be used to enclose the buildings and the separated outside spaces, or the entire buildings. The inside spaces may be ground type natural environments or tridimensional layer type ecological environments for cultivation of plants. The newly added building roof awnings and the building transparent walls may be fixed, disengaged, opened and closed, and other structures with unlimited forms. The ecological buildings can be provided with underground spaces for organisms, for habitants, the top roof of which comprising single-layer or double-layer enclosed devices that are parallel, or not, to the ground. On the enclosed devices are fixed transparent glasses or other devices that can be opened and closed. The opened and closed devices may be windows with small-occupied areas, may be other large devices that can be opened and closed. The underground ecological buildings may be combined with the ecological buildings, or may be separate, inside which there are spaces for plants, for organisms, for habitants, for both organisms and habitants, and which may be with one or more layers. Passages type ecological buildings are provided in the buildings, which comprise walls, awnings made of glasses and other combinational materials. The frames may be disengaged, combined, with one layer or more tridimensional layers, inside which there are organisms incubated for sightseeing, passages devices and habitants environments, underground ecological spaces for cultivation of organisms, and additional cooperating devices, such as water suppliers, water storages, and water purifying devices.

6. The multifunctional ecological architecture according to claim 1, characterized in that the various types of ecological buildings may be combined entirely, partly or separately, which may be combined with other building structures. The buildings comprise main buildings, secondary buildings, cooperating buildings, cooperating devices, upper water devices, cooling/heating devices, solar power generation devices, wind power generation devices, building roof garden structure environments, building roof transparent sunlight warm houses, roof frame rain-proof type ecological spaces. The present buildings can be added with ecological warm houses, awning type ecological buildings, forming combined ecological buildings and roof gardens, with lifting devices, passages, ladders and other functional structures, and with building functions and shocking-proof functions. Solar power warm houses awning spaces and other agriculture productions can also be provided, which may be on the top roofs, on the grounds or underground. The solar power generation devices may be provided inside or outside the buildings, on the awnings, on the grounds, which may be connected with lines to supply electric power for warm houses, illuminations for awnings and other appliances. The solar power generation devices may be combined with other complement functional devices. The ecological buildings may be in the form of upright studs, turrets, triangles and other forms. Ecological environmental spaces composed of plants and waters can be provided inside the buildings and on the surfaces of the buildings. The plants may be provided internally, externally, or internally and externally. The internally provided spaces can be provided opened and closed, as well as with ventilation devices. The ecological spaces in the building structures for plants may be provided in different layers, which may be with one or more layers, and which may be arranged in high layers, or arranged as desired. Plants can be provided with unlimited numbers, which may be integrated together with hills and flowers, grasses, gardens and habitant environments. The plant environments may be also for habitants, recreations, works, sightseeing, productions and the combinations, and may also be designed large-scale ecological buildings with other non-ecological plants buildings. Oxygen passage systems, water purifying systems, water reservoirs, water recycling systems, ventilation systems, ecological systems for cultivation of organisms, cultivation systems for aquatic productions and other systems may all be provided with ultraviolet sanitation devices that may be houses, boxes, pipes and lamps that can be with different numbers and different structures.

7. The multifunctional ecological architecture according to claim 1, characterized in that solar power generation devices, wind power generation devices and solar power refractive and transmitting devices are provided. The solar power generation devices may be laid or upright, may be rotating or fixed, may be provided on the grounds, or the inside/outside spaces on the buildings. The wind power generation devices may be separated ones or combined ones, which may be on the grounds or buildings. The wind power generation devices may be driven by external natural winds or internal passage winds. The solar power refractive and transmitting devices may be divided into reflecting plate (walls) type refractive devices and transmitting devices. Refractive devices may be fixed or movable with lights that may be moved automatically or manually. The solar power generation devices, wind power generation devices, solar power refractive and transmitting device may be combined with their separate functions or entire functions, with different forms and structures. The several types of devices may be combined together or separately. The ecological buildings comprise passage type ecological warm houses in the form of long passages that are connected with one or more building structures, forming networks. Houses and other habitant environments can be provided inside the passages, where ecological environments for plants and organisms can be provided. The habitant environments may be for meetings, for recreations, for offices and residential houses, may be provided with single-passage or double-passage transportation roads, may be with one or more layers, may be underground, aboveground, underground and aboveground. On the above spaces of the buildings are provided with cooling/eating temperature control devices, ventilation devices, rains and polluted water discharging devices, polluted water purifying devices, solar power refractive and transmitting devices, inside cooling devices and other devices. The functions of ecological passage devices can be combined with the functions of the cooperating devices. The cooperating devices may be aboveground, underground with unlimited numbers and different structures. The ecological buildings are provided with oxygen supplier systems and ventilation systems, water supplier systems, water purifying and recycling systems, and sanitation devices are equipped inside the systems, which inside the sanitation spaces, pipes, hollow walls, passages kill the deleterious materials in oxygen, ventilation winds and water flows, converting them to in-noxious gases and water flows. Other sanitation methods may also be used, such as heating (insolation and dry). In a type of tridimensional roads type ecological buildings, roads and ecological buildings are provided underground or aboveground with different layers. The roads and ecological buildings may be arranged in different methods with different forms. The tridimensional road type ecological buildings may be connected with normal roads, or may be separate, with unlimited lengths, any forms and structures. They may be combined with large-scale buildings, and provided with ecological spaces, water reservoirs, solar powers, water purifiers, and cooling/heating devices.

8. The multifunctional ecological architecture according to claim 1, characterized in that a type of combined ecological towns may comprise, entirely or partly, various types of aboveground, underground ecological buildings, tridimensional ecological roads, tridimensional ecological bridges, ecological passages, tridimensional plants, land type ecological buildings, water collectors, water reservoirs, water purifying systems, cultivation systems for aquatics, obvious and hidden rivers network ecological environments for aquatics, tridimensional ecological walls and buildings, ecological town water systems. The ecological towns may be combined with normal buildings, with various types of irregular ecological garden environments that can be opened and closed, and various types of ecological cultural places for habitants. The ecological towns can be provided with various numbers of cooperating buildings and cooperating devices, complement structures. The structures may be variable with small or large occupied areas. The ecological buildings may be in the form of single house, single villa, which may be agriculture ecological villages, or the combined ecological structures both for habitants and for organisms. The ecological towns and the ecological buildings are equipped with various types of solar power generation devices, various types of wind power generation devices, methane tanks, dealing systems for polluted water, used water and feces, water reservoir ditches and rain storages, water purifying systems. All those cooperating devices may be with various numbers, functions, structures and positions. A type of tridimensional ecological land type buildings comprise plants, grasses and underground ecological buildings. A type of awning type agriculture ecological warm houses for production comprises aboveground warm houses, underground warm houses, and the combined warm houses that are partly aboveground and partly underground. The aboveground warm houses (awnings) may be with one or more layers. The underground warm houses may be with one or more layers. Both the aboveground warm houses and the underground warm houses can be used for cultivation of organisms. Water reservoirs (methane devices) can be provided inside/outside the ecological building layers. The buildings may be aboveground or underground, may be open to the air or enclosed, may be opened, fixed or movable. The water reservoirs may have passages for rains and snows, through which the rains and snows around the buildings may be stored for future use. Water filtering and purifying devices may also be provided. The water pipes may also be used for external water resources, such as the water from wells and the used water. The buildings may be provided with building cultural places for habitants, for rest, for processing, for recreations, for reservoirs and for sanitations. Solar power generation devices and wind power generation devices may also be provided for the buildings, which may be arranged vertically or laid with variable structures, and which may be integrated entirely, partly or separately for use. Water suppliers systems may also be provided. The buildings may be used for cultivation of plants and various types of organisms that plants are used to breed animals, and animals are used to culture plants, and the feces from animals may be used for plants and for methane tanks that afford heat to the buildings. The buildings may be with various occupied areas, structures, numbers, which may be combined with town buildings, complement area buildings for agricultures, forests, fisheries and other industries, and may also be combined with village buildings, villas and other cooperating buildings. Sanitation devices systems may be provided inside the ecological buildings that mainly use ultraviolet light, and secondly use medicines, temperatures, and the two methods may be combined or separated. The sanitation functions may be provided in the sanitation spaces, the outlets of the ecological cultural places for habitants flow, materials flow, water flow, devices flow and air flow, air flow systems, oxygen flow transmitting systems, water purifying and sanitation systems, upper and lower water systems, areas for cultivation of organisms and areas for habitants. A type of ecological buildings with Chinese traditional cultures eight Gua and Yixue principles; characterize with Gua and Taiji a graphics. The yin and yang graphics denote the cultivation of organisms, indicating that the organisms inside the ecological buildings may live permanently. The eight Gua in the graphics may be graphics, and may also be the ecological functions of the ecological buildings, such as the sunlight transmitting devices, air ventilation systems and water recycling systems, small building systems for cultivation of organisms (for examples, rooms and awnings). The yin and yang fish may be rotating or fixed. Other ecological buildings besides those in the graphics may also be added. The graphic combinations may be flat or rugged. The single or combinational parts of the eight Gua may be arcs or straight lines, which may form rectangles and circles with sixty-four Gua. The Gua may be with various numbers, which may be single Gua or combinational Gua, forming various forms of ecological buildings, such as of high layers turrets type, of pyramids cones types, of ladders types, of huge, circle or combinational buildings type. Environments spaces for cultivation of plants and for habitants may also be provided inside/outside the ecological buildings. Standard Taiji graphics as well as deformed Taiji graphics may be used. The forms and functions of Taiji graphics, the graphics and functions of eight Gua Taiji graphics, as well as the derived numbers of eight Gua may bi-dimensionally or tri-dimensionally combine to form large scale Taiji and eight Gua type huge ecological buildings structures matrix, with various numbers of eight Gua and Taiji ecological buildings, which may be ecological buildings for habitants, for cultivation of organisms, for cultivation and production of Chinese medical plants and organisms. It is one of the important features of the combined ecological buildings to have combined ecological buildings. Common ecological buildings may be used to replace the Taiji graphics on the eight Gua type ecological buildings, making them to be common ecological buildings, which may be for cultivation of organisms, for cultivation and production of organisms, for sightseeing, for research, for habitants and for the combinations.

9. The multifunctional ecological architecture according to claim 1, characterized in that a type of movable ecological buildings may be with one or more layers, under which are provided with wheels that comprise multiple sets of wheels. The wheels may be mounted directly under the buildings, which may be disengaged, and which may move on the laid orbits or in other forms. The type of ecological buildings may be applied to passage type ecological buildings, small warm house buildings, and may be aboveground, underground and inside the buildings with different structures, which may be frame transparent, may be mounted and disengaged, and in other forms. The buildings may also be provided with various types of ecological mechanical devices that can move, rotate, slide and roll. A type of village-house type ecological buildings comprise tridimensional ecological rivers (lakes), tridimensional ecological walls, underground and aboveground tridimensional ecological roads, underground ecological building structures, aboveground ecological building structures, water recycling, purifying, and storing systems, sunlight refractive and transmitting device systems, cultivation systems for organisms, air ventilating, purifying and exsiccating systems, air water sanitation systems with ultraviolet light, solar power, wind power and mechanical power generation devices systems, computer aided monitoring systems, artificial intelligence automation control systems, automatic alarming systems, ecology systems for habitants, factory processing systems, storing systems, light transmitting and refractive systems, electric supplier and water supplier systems. The tridimensional ecological rivers comprise rains, snows, and used water collecting, purifying and storing systems (water pools, reservoirs, lakes), where the external water receiving systems receive rains and transmit them directly to water reservoirs, artificial rivers (and natural rivers, lakes), segmented rivers by cover plates (nets), main recycling rivers, sub branch ecological river (lake) water suppliers pipes, water purifying systems, ecological water reservoirs, recycling and purifying devices systems, heating and cooling devices systems, purified water storing devices systems, ultraviolet light sanitation spaces (passages) systems and other systems. The tridimensional ecological walls comprise wall systems, for examples walls, barriers, wall bridges, ecological building internal walls, warm house, ecological spaces for plants and animals, turrets buildings, etc. The tridimensional ecological buildings systems comprise various layers ecological buildings, underground ecological environments, common buildings, special functional buildings, etc. Solar power, wind power generation devices can be provided entirely or partly in the buildings systems, which may be on the ground, and used for the entire buildings or part of the buildings. A type of tridimensional combined ecological towns comprise aboveground ecological buildings, underground ecological buildings, combined ecological buildings that are partly underground and partly aboveground, aboveground and underground tridimensional road type ecological buildings, aboveground and underground tridimensional land type ecological buildings, aboveground and underground public utilities, tridimensional ecological walls, tridimensional ecological rivers, and ecological buildings for habitants. The ecological buildings comprising many, few or single ecological buildings have discharge ditches or other water collecting, discharging, purifying and storing systems, which may purify and store rains, snows and used water. The buildings may have solar power, wind power generation devices, air exsiccating and filtering devices, cooling, heating, temperature controlling, water storing and sanitation devices and other cooperating devices. The tridimensional ecological roads have light transmitting and refractive devices. Ecological spaces for organisms and habitants can be provided above, on, or under the tridimensional ecological road type, land type ecological buildings. The ecological towns have tridimensional ecological walls, tridimensional ecological rivers (lakes), which may be entirely or partly surrounding the ecological towns. Ecological walls may be flood-preventing type or secure type. Walls can be provided with aboveground and underground plants environments, ecological spaces, warm house, watch towers, gardens, hills and water, wall bridges, closed doors with various forms and structures, which may be combined with other ecological structures for organisms, and which may be inside or outside the buildings, may be integrated with simple barriers, buildings structures with high, middle and low qualities. Tridimensional ecological river systems may be the water systems comprising rivers, lakes, water reservoirs, ecological cultivation buildings, water purifying devices, polluted water dealing devices, various river sections for cultivation of organisms (aquatics), which may be aboveground, underground, opened to the air, closed, or opened and closed, and which may be connected with external water systems. Tridimensional ecological walls, tridimensional ecological rivers, cooperating building structures and cooperating devices may be with different structures and different numbers, which may be combined with tridimensional ecological towns, single house, or combined houses, or may be separate for use. Tridimensional ecological towns may be provided with none, either, or both tridimensional ecological walls and ecological towns, or only use common barriers, rivers, roads and buildings to divide the ecological towns to different areas. A type of air water exsiccating, purifying and filtering devices from air according to cooling/heating principles, comprise air inlets, air heating structures, air cooling and water filtering structures, water outlets, air outlets and other cooperating devices, in which air can be heated by heating winds, electrics, heating gases, heating water, methane, and cooled by electrics, cooling winds, cryogens, ice, cold grounds. They can be applied to ecological buildings, warm houses as cooperating devices, with a series of products that have different forms, structures, occupied volumes. They can be provided with sanitation devices using electric or ultraviolet lights, which may be boxes, pipes, passages and other forms. Cooling/heating pipes, suspended plates, suspended pipe networks can be used for heating and cooling, which can be integrated with exsiccating devices and other functional devices. They can be applied to humid areas as civil products, such as ecological buildings, warm house cooperating devices for plants and organisms.

10. A tridimensional ecological land-type ecological architecture, which comprises building structures with one or more storeys that are under the grounds, under the grounds of ecological plant covers and organisms that are aboveground. The ecological plant covers lands may be flat, may be in the form of tridimensional garden buildings, hills and water, lakes, building patios, agriculture buildings, or may be the combinations of multiple ecological plant covers and the building gardens. The tridimensional land type ecological buildings may also be added one or more layer of frame type ecological building structures above the ecological plant covers lands. A type of top roof frame type transparent ecological building structures (and hood type ecological covers), comprise aboveground or underground tridimensional ecological buildings and top roof frame type structures. The top roof frame type transparent structures comprise frames and transparent glasses. The frames may be metallic frames, concrete frames, or the combined frames, with their forms and structures being bi-dimensional or tridimensional, which may be opened to the air, or opened and closed. The frames can be provided with sunlight refractive and transmitting devices, solar power generation devices. Sand-proof cover devices that can prevent sands may also be provided on the frames, which may be opened and closed automatically or manually, which can be applied not only to top roof frame type transparent structures, but also to passage type ecological awning buildings, tridimensional agriculture awnings, transparent warm houses and other ecological buildings and devices. Various types of tridimensional ecological buildings comprise multifunctional tridimensional combined ecological architectures, hood type ecological buildings, aboveground and underground ecological buildings, tridimensional land type ecological buildings, tree type tridimensional ecological buildings for organisms, turret type ecological buildings, aboveground and underground combined passage type ecological buildings, multifunctional ecological buildings, Taiji graphics (Yixue) type ecological buildings for organisms and other ecological buildings with cooperating devices and systems. The functions of combined village-house type functional ecological buildings may be entirely, partly or separately combined with the functions of several tridimensional ecological buildings. The functions of the unit spaces in the several tridimensional ecological buildings may be separately, partly or entirely combined.
